(19) United States
(12) Patent Application Publication
(10) Pub. No.: US 2014/0218372 A1
(43) Pub. Date: Aug. 7, 2014

(54) INTELLIGENT DIGITAL ASSISTANT IN A DESKTOP ENVIRONMENT

(71) Applicant: Apple Inc., Cupertino, CA (US)

(72) Inventors: Julian K. MISSIG, Redwood City, CA (US); Jeffrey Traer BERNSTEIN, San Francisco, CA (US); Avi E. CIEPLINSKI, San Francisco, CA (US); May-Li KHOE, San Francisco, CA (US); David J. HART, San Francisco, CA (US); Bianca C. COSTANZO, Barcelona (ES); Nicholas ZAMBETTI, San Francisco, CA (US); Matthew I. BROWN, San Francisco, CA (US)

(73) Assignee: Apple Inc., Cupertino, CA (US)

(21) Appl. No.: 14/173,344

(22) Filed: Feb. 5, 2014

Related U.S. Application Data
(60) Provisional application No. 61/761,154, filed on Feb. 5, 2013.

(51) Int. Cl. G06F 3/01; G06F 3/044; G06T 13/80

(52) U.S. Cl. CPC G06F 3/017; G06T 13/80; G06F 3/044
USPC 345/473; 345/173

(57) ABSTRACT

Methods and systems related to interfaces for interacting with a digital assistant in a desktop environment are disclosed. In some embodiments, a digital assistant is invoked on a user device by a gesture following a predetermined motion pattern on a touch-sensitive surface of the user device. In some embodiments, a user device selectively invokes a dictation mode or a command mode to process a speech input depending on whether an input focus of the user device is within a text input area displayed on the user device. In some embodiments, a digital assistant performs various operations in response to one or more objects being dragged and dropped onto an iconic representation of the digital assistant displayed on a graphical user interface. In some embodiments, a digital assistant is invoked to cooperate with the user to complete a task that the user has already started on a user device.

### CROSS-REFERENCE TO RELATED APPLICATIONS

This application claims the benefit of U.S. Provisional Application No. 61/761,154, filed on Feb. 5, 2013, entitled INTELLIGENT DIGITAL ASSISTANT IN A DESKTOP ENVIRONMENT, which is hereby incorporated by reference in its entity for all purposes.

### TECHNICAL FIELD

The disclosed embodiments relate generally to digital assistants, and more specifically to digital assistants that interact with users through desktop or tablet computer interfaces.

### BACKGROUND

Just like human personal assistants, digital assistants or virtual assistants can perform requested tasks and provide requested advice, information, or services. An assistant's ability to fulfill a user's request is dependent on the assistant's correct comprehension of the request or instructions. Recent advances in natural language processing have enabled users to interact with digital assistants using natural language, in spoken or textual forms, rather than employing a conventional user interface (e.g., menus or programmed commands). Such digital assistants can interpret the user's input to infer the user's intent; translate the inferred intent into actionable tasks and parameters; execute operations or deploy services to perform the tasks; and produce outputs that are intelligible to the user. Ideally, the outputs produced by a digital assistant should fulfill the user's intent expressed during the natural language interaction between the user and the digital assistant.

The ability of a digital assistant system to produce satisfactory responses to user requests depends on the natural language processing, knowledge base, and artificial intelligence implemented by the system. A well-designed user interface and response procedure can improve a user's experience in interacting with the system and promote the user's confidence in the system's services and capabilities.

### SUMMARY

The embodiments disclosed herein provide methods, systems, computer readable storage medium and user interfaces for interacting with a digital assistant in a desktop environment. A desktop, laptop, or tablet computer often has a larger display, and more memory and processing power, compared to most small, more specialized mobile devices (e.g., smart phones, music players, and/or gaming devices). The bigger display allows user interface elements (e.g., application windows, document icons, etc.) for multiple applications to be presented and manipulated through the same user interface (e.g., the desktop). Most desktop, laptop, and tablet computer operating systems support user interface interactions across multiple windows and/or applications (e.g., copy and paste operations, drag and drop operations, etc.), and parallel processing of multiple tasks. Most desktop, laptop, and tablet computers are also equipped with peripheral devices (e.g., mouse, keyboard, printer, touchpad, etc.) and support more complex and sophisticated interactions and functionalities than many small mobile devices. The integration of an at least partially voice-controlled intelligent digital assistant into a desktop, laptop, and/or tablet computer environment provides additional capabilities to the digital assistant, and enhances the usability and capabilities of the desktop, laptop, and/or tablet computer.

In accordance with some embodiments, a method for invoking a digital assistant service is provided. At a user device comprising one or more processors and memory: the user device detects an input gesture from a user according to a predetermined motion pattern on a touch-sensitive surface of the user device; in response to detecting the input gesture, the user device activates a digital assistant on the user device.

In some embodiments, the input gesture is detected according to a circular movement of a contact on the touch-sensitive surface of the user device.

In some embodiments, activating the digital assistant on the user device further includes presenting an iconic representation of the digital assistant on a display of the user device.

In some embodiments, presenting the iconic representation of the digital assistant further includes presenting an animation showing a gradual formation of the iconic representation of the digital assistant on the display.

In some embodiments, the iconic representation of the digital assistant is displayed in proximity to a contact of the input gesture on the touch-sensitive surface of the user device.

In some embodiments, the predetermined motion pattern is selected based on a shape of an iconic representation of the digital assistant on the user device.

In some embodiments, activating the digital assistant on the user device further includes presenting a dialogue interface of the digital assistant on a display of the device, the dialogue interface configured to present one or more verbal exchanges between the user and the digital assistant.

In some embodiments, the method further includes: in response to detecting the input gesture: identifying a respective user interface object presented on a display of the user device based on a correlation between a respective location of the input gesture on the touch-sensitive surface of the device and a respective location of the user interface object on the display of the user device; and providing information associated with the user interface object to the digital assistant as context information for a subsequent input received by the digital assistant.

In accordance with some embodiments, a method for disambiguating between voice input for dictation and voice input for interacting with a digital assistant is provided. At a user device comprising one or more processors and memory: the user device receives a command to invoke the speech service; in response to receiving the command: the user device determines whether an input focus of the user device is in a text input area shown on a display of the user device; and upon determining that the that the input focus of the user device is in a text input area displayed on the user device, the user device, automatically without human intervention, invokes a dictation mode to convert a speech input to a text input for entry into the text input area; and upon determining that the current input focus of the user device is not in any text input area displayed on the user device, the user device, automatically without human intervention, invokes a command mode to determine a user intent expressed in the speech input.

In some embodiments, receiving the command further includes receiving the speech input from a user.

In some embodiments, the method further includes: while in the dictation mode, receiving a non-speech input requesting termination of the dictation mode; and in response to the non-speech input, exiting the dictation mode and starting the command mode to capture a subsequent speech input from the user and process the subsequent speech input to determine a subsequent user intent.

In some embodiments, the method further includes: while in the dictation mode, receiving a non-speech input requesting suspension of the dictation mode; and in response to the non-speech input, suspending the dictation mode and starting the command mode to capture a subsequent speech input from the user and process the subsequent speech input to determine a subsequent user intent.

In some embodiments, the method further includes: performing one or more actions based on the subsequent user intent; and returning to the dictation mode upon completion of the one or more actions.

In some embodiments, the non-speech input is a sustained input to maintain the command mode, and the method further includes: upon termination of the non-speech input, exiting the command mode and returning to the dictation mode.

In some embodiments, the method further includes: while in the command mode, receiving a non-speech input requesting start of the dictation mode; and in response to detecting the non-speech input: suspending the command mode and starting the dictation mode to capture a subsequent speech input from the user and convert the subsequent speech input into corresponding text input in a respective text input area displayed on the device.

In accordance with some embodiments, a method for providing input and/or command to a digital assistant by dragging and dropping one or more user interface objects onto an iconic representation of the digital assistant is provided. At a user device comprising one or more processors and memory: the user device presents an iconic representation of a digital assistant on a display of the user device; the user device detects a user input dragging and dropping one or more objects onto the iconic representation of the digital assistant; the user device receives a speech input requesting information or performance of a task; the user device determines a user intent based on the speech input and context information associated with the one or more objects; and the user device provides a response, including at least providing the requested information or performing the requested task in accordance with the determined user intent.

In some embodiments, the dragging and dropping of the one or more objects includes dragging and dropping two or more groups of objects onto the iconic representation at different times.

In some embodiments, the dragging and dropping of the one or more objects occurs prior to the receipt of the speech input.

In some embodiments, the dragging and dropping of the one or more objects occurs subsequent to the receipt of the speech input.

In some embodiments, the context information associated with the one or more objects includes an order by which the one or more objects have been dropped onto the iconic representation.

In some embodiments, the context information associated with the one or more objects includes respective identities of the one or more objects.

In some embodiments, the context information associated with the one or more objects includes respective sets of operations that are applicable to the one or more objects.

In some embodiments, the speech input does not refer to the one or more objects by respective unique identifiers thereof.

In some embodiments, the speech input specifies an action without specifying a corresponding subject for the action.

In some embodiments, the requested task is a sorting task, the speech input specifies one or more sorting criteria, and providing the response includes presenting the one or more objects in an order according to the one or more sorting criteria.

In some embodiments, the requested task is a merging task and providing the response includes generating a new object that combines the one or more objects.

In some embodiments, the requested task is a printing task and providing the response includes generating one or more printing jobs for the one or more objects.

In some embodiments, the requested task is a comparison task and providing the response includes generating a comparison document illustrating one or more differences between the one or more objects.

In some embodiments, the requested task is a search task and providing the response includes providing one or more search results that are identical or similar to the one or more objects.

In some embodiments, the method further include: determining a minimum number of objects required for performance of the requested task; determining that less than the minimum number of objects have been dropped onto the iconic representation of the digital assistant; and delaying performance of the requested task until at least the minimum number of objects have been dropped onto the iconic representation of the digital assistant.

In some embodiments, the method further includes: after at least the minimum number of objects have been dropped onto the iconic representation, generating a prompt to the user after a predetermined period time has elapsed since the last object drop, wherein the prompt requests user confirmation regarding whether the user has completed specifying all objects for the requested task; and upon confirmation by the user, performing the requested task with respect to the objects that have been dropped onto the iconic representation.

In some embodiments, the method further includes: prior to detecting the dragging and dropping of the one or more objects, maintaining the digital assistant in a dormant state; and upon detecting the dragging and dropping of a first object of the one or more objects, activating a command mode of the digital assistant.

In accordance with some embodiments, a method is provided, in which a digital assistant serves as a third hand to cooperate with a user to complete an ongoing task that has been started in response to direct input from the user. At a user device having one or more processors, memory and a display: a series of user inputs are received from a user through a first input device coupled to the user device, the series of user inputs causing ongoing performance of a first task on the user device; during the ongoing performance of the first task, a user request is received through a second input device coupled to the user device, the user request requesting assistance of a digital assistant operating on the user device, and the requested assistance including (1) maintaining the ongoing performance of the first task on behalf of the user, while the user performs a second task on the user device using the first input device, or (2) performing the second task on the user device, while the user maintains the ongoing performance of the first task; in response to the user request, the requested assistance is provided; and completing the first task on the user device by utilizing an outcome produced by the performance of the second task.

In some embodiments, providing the requested assistance includes: performing the second task on the user device through actions of the digital assistant, while continuing performance the first task in response to the series of user inputs received through the first input device.

In some embodiments, the method further includes: after performance of the second task, detecting a subsequent user input, the subsequent user input utilizes the outcome produced by the performance of the second task in the ongoing performance of the first task.

In some embodiments, the series of user inputs include a sustained user input that causes the ongoing performance of the first task on the user device; and providing the requested assistance comprises performing the second task on the user device through actions of the digital assistant, while maintaining the ongoing performance of the first task in response to the sustained user input.

In some embodiments, the method further includes: after performance of the second task, detecting a subsequent user input through the first input device, wherein the subsequent user input utilizes the outcome produced by the performance of the second task to complete the first task.

In some embodiments, the series of user inputs include a sustained user input that causes the ongoing performance of the first task on the user device; and providing the requested assistance includes: upon termination of the sustained user input, continuing to maintain the ongoing performance of the first task on behalf of the user through an action of a digital assistant; and while the digital assistant continues to maintain the ongoing performance of the first task, performing the second task in response to a first subsequent user input received on the first input device.

In some embodiments, the method further includes: after performance of the second task, detecting a second subsequent user input on the first input device; and in response to the second subsequent user input on the first input device, releasing control of the first task from the digital assistant to the first input device in accordance with the second subsequent user input, wherein the second subsequent user input utilizes the outcome produced by the performance of the second task to complete the first task.

In some embodiments, the method further includes: after performance of the second task, receiving a second user request directed to the digital assistant, wherein the digital assistant, in response to the second user request, utilizes the outcome produced by the performance of the second task to complete the first task.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram illustrating an environment in which a digital assistant operates in accordance with some embodiments.

FIG. 2A is a block diagram illustrating a digital assistant or a client portion thereof in accordance with some embodiments.

FIG. 2B is a block diagram illustrating a user device having a touch-sensitive screen display.

FIG. 2C is a block diagram illustrating a user device having a touch-sensitive surface separate from a display of the user device.

FIG. 3A is a block diagram illustrating a digital assistant system or a server portion thereof in accordance with some embodiments.

FIG. 3B is a block diagram illustrating functions of the digital assistant shown in FIG. 3A in accordance with some embodiments.

FIG. 3C is a diagram of a portion of an ontology in accordance with some embodiments.

FIGS. 4A-4G illustrate exemplary user interfaces for invoking a digital assistant using a touch-based gesture in accordance with some embodiments.

FIGS. 5A-5D illustrate exemplary user interfaces for disambiguating between voice input for dictation and a voice command for a digital assistant in accordance with some embodiments.

FIGS. 6A-6O illustrate exemplary user interfaces for providing an input and/or command to a digital assistant by dragging and dropping user interface objects to an iconic representation of the digital assistant in accordance with some embodiments.

FIGS. 7A-7V illustrate exemplary user interfaces for using a digital assistant to assist with the completion of an ongoing task that the user has started through a direct user input in accordance with some embodiments.

FIG. 8 is a flow chart illustrating a method for invoking a digital assistant using a touch-based input gesture in accordance with some embodiments.

FIGS. 9A-9B are flow charts illustrating a method for disambiguating between voice input for dictation and a voice command for a digital assistant in accordance with some embodiments.

FIGS. 10A-10C are flow charts illustrating a method for providing an input and/or command to a digital assistant by dragging and dropping user interface objects to an iconic representation of the digital assistant in accordance with some embodiments.

FIGS. 11A-11B are flow charts illustrating a method for using the digital assistant to assist with the completion of an ongoing task that the user has started through a direct user input in accordance with some embodiments.

Like reference numerals refer to corresponding parts throughout the drawings.

### DESCRIPTION OF EMBODIMENTS

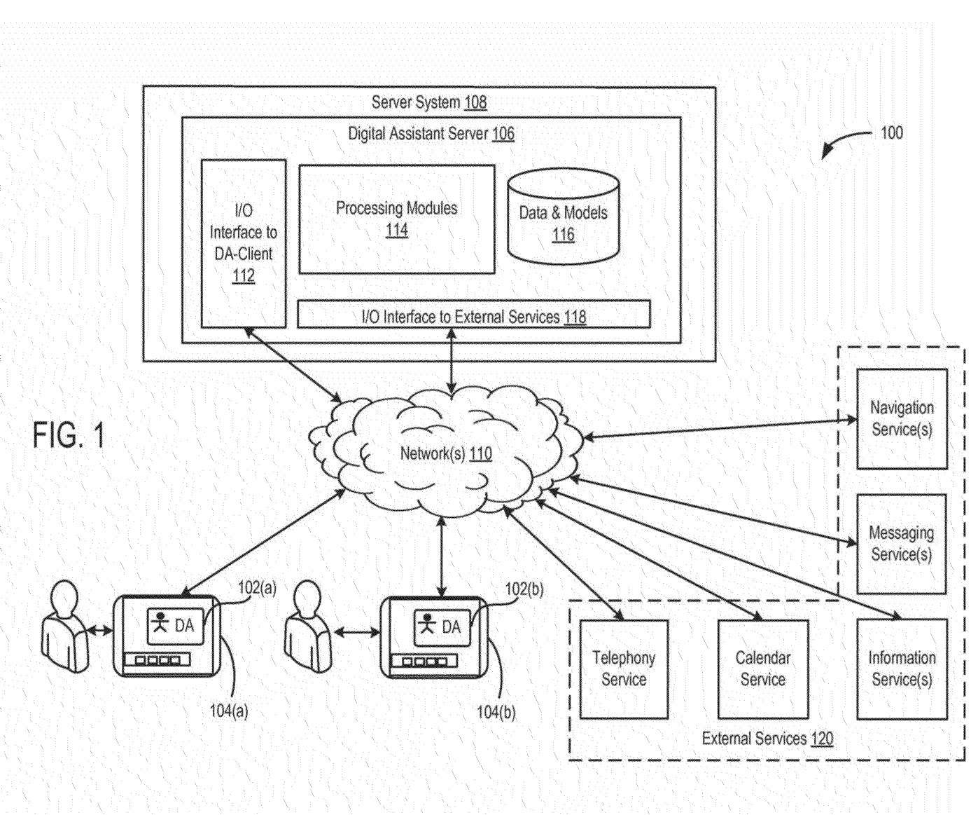

FIG. 1 is a block diagram of an operating environment 100 of a digital assistant according to some embodiments. The terms “digital assistant,” “virtual assistant,” “intelligent automated assistant,” or “automatic digital assistant,” refer to any information processing system that interprets natural language input in spoken and/or textual form to infer user intent, and performs actions based on the deduced user intent. For example, to act on a inferred user intent, the system, optionally, performs one or more of the following: identifying a task flow with steps and parameters designed to accomplish the inferred user intent, inputting specific requirements from the inferred user intent into the task flow; executing the task flow by invoking programs, methods, services, APIs, or the like; and generating output responses to the user in an audible (e.g. speech) and/or visual form.

Specifically, a digital assistant is capable of accepting a user request at least partially in the form of a natural language command, request, statement, narrative, and/or inquiry. Typically, the user request seeks either an informational answer or performance of a task by the digital assistant. A satisfactory response to the user request is either provision of the requested informational answer, performance of the requested task, or a combination of the two. For example, a user may ask the digital assistant a question, such as “Where am I right now?” Based on the user's current location, the digital assistant may answer, “You are in Central Park near the west gate.” The user may also request the performance of a task, for example, “Please invite my friends to my girlfriend's birthday party next week.” In response, the digital assistant may acknowledge the request by saying “Yes, right away,” and then send a suitable calendar invite on behalf of the user to each of the user' friends listed in the user's electronic address book. During performance of a requested task, the digital assistant sometimes interacts with the user in a continuous dialogue involving multiple exchanges of information over an extended period of time. There are numerous other ways of interacting with a digital assistant to request information or performance of various tasks. In addition to providing verbal responses and taking programmed actions, the digital assistant also provides responses in other visual or audio forms, e.g., as text, alerts, music, videos, animations, etc. In some embodiments, the digital assistant also receives some inputs and commands based on the past and present interactions between the user and the user interfaces provided on the user device, the underlying operating system, and/or other applications executing on the user device.

An example of a digital assistant is described in Applicant's U.S. Utility application Ser. No. 12/987,982 for “Intelligent Automated Assistant,” filed Jan. 10, 2011, the entire disclosure of which is incorporated herein by reference.

As shown in FIG. 1, in some embodiments, a digital assistant is implemented according to a client-server model. The digital assistant includes a client-side portion 102a, 102b (hereafter “DA client 102”) executed on a user device 104a, 104b, and a server-side portion 106 (hereafter “DA server 106”) executed on a server system 108. The DA client 102 communicates with the DA server 106 through one or more networks 110. The DA client 102 provides client-side functionalities such as user-facing input and output processing and communications with the DA-server 106. The DA server 106 provides server-side functionalities for any number of DA-clients 102 each residing on a respective user device 104.

In some embodiments, the DA server 106 includes a client-facing I/O interface 112, one or more processing modules 114, data and models 116, and an I/O interface to external services 118. The client-facing I/O interface facilitates the client-facing input and output processing for the digital assistant server 106. The one or more processing modules 114 utilize the data and models 116 to infer the user's intent based on natural language input and perform task execution based on the inferred user intent. In some embodiments, the DA-server 106 communicates with external services 120 through the network(s) 110 for task completion or information acquisition. The I/O interface to external services 118 facilitates such communications.

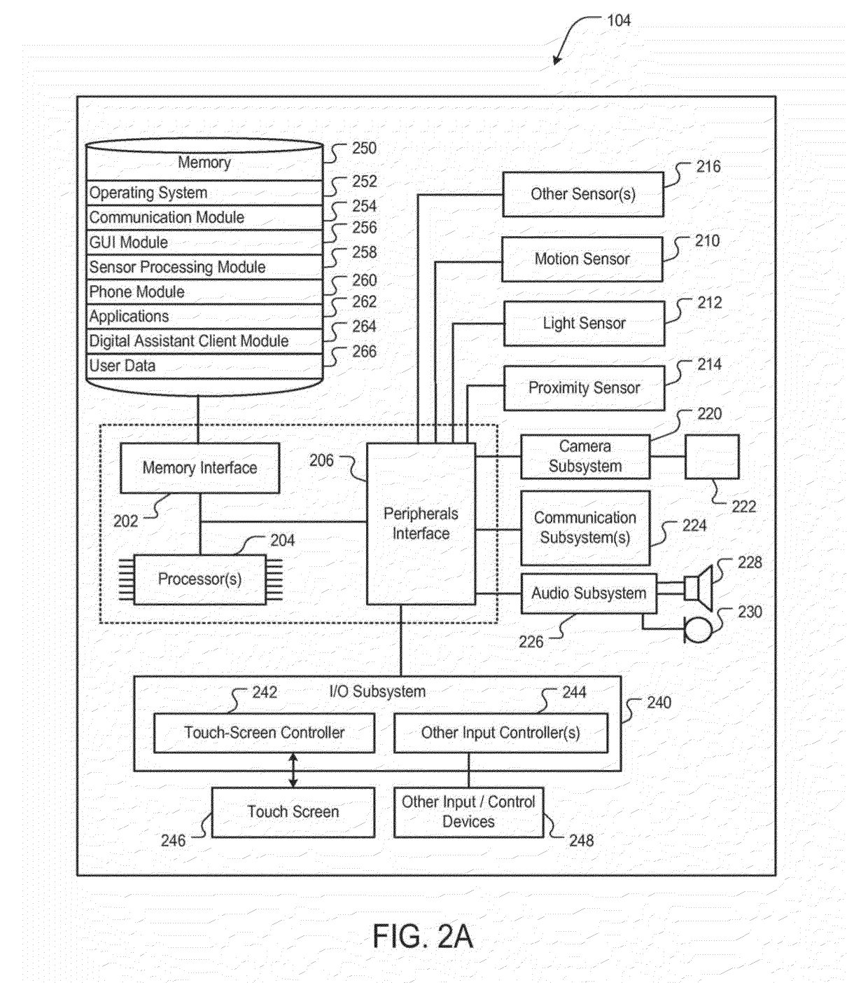

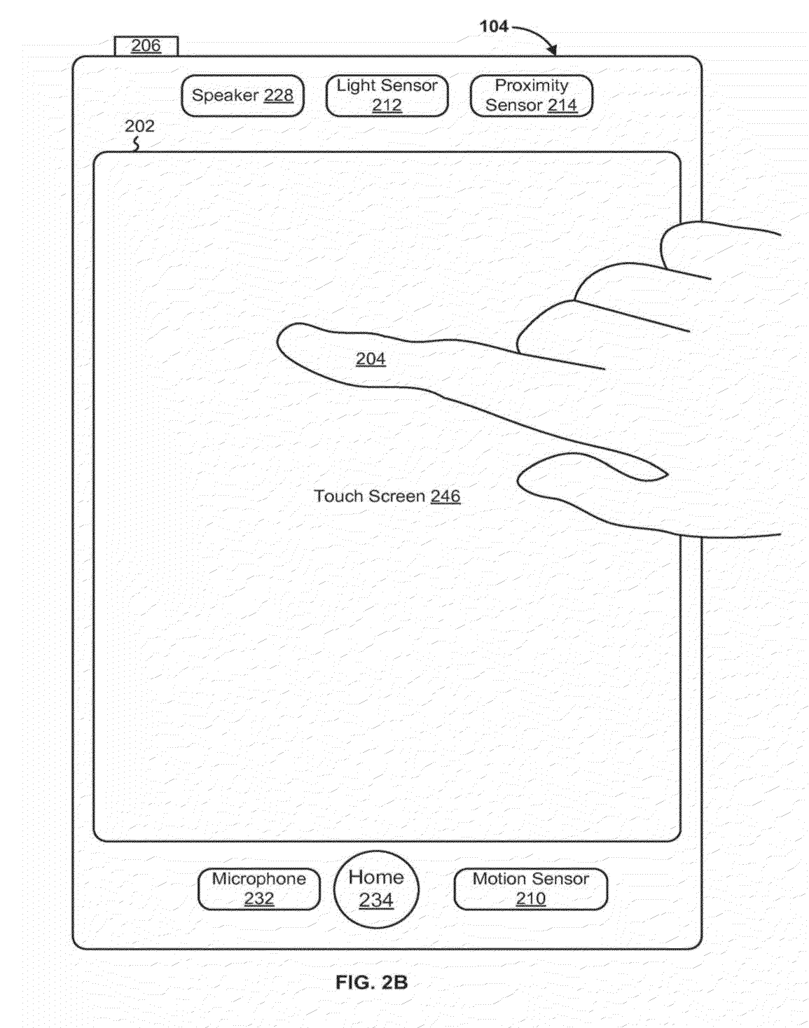

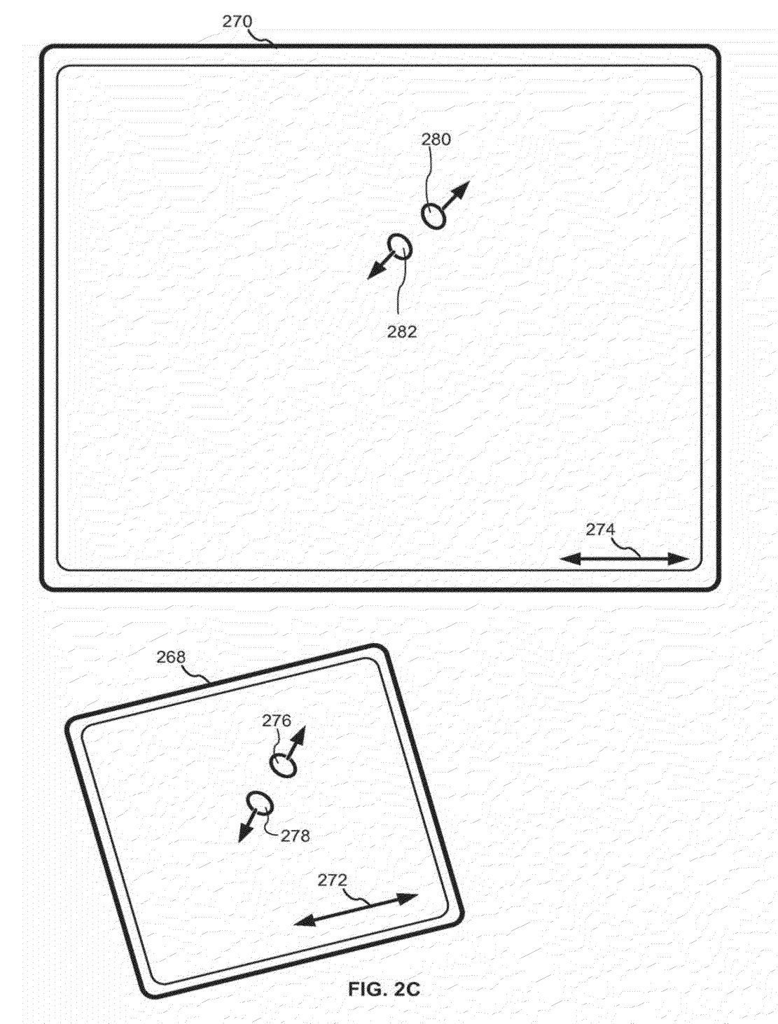

Examples of the user device 104 include, but are not limited to, a handheld computer, a personal digital assistant (PDA), a tablet computer, a laptop computer, a desktop computer, a cellular telephone, a smart phone, an enhanced general packet radio service (EGPRS) mobile phone, a media player, a navigation device, a game console, a television, a remote control, or a combination of any two or more of these data processing devices or other data processing devices. In this application, the digital assistant or the client portion thereof resides on a user device that is capable of executing multiple applications in parallel, and that allows the user to concurrently interact with both the digital assistant and one or more other applications using both voice input and other types of input. In addition, the user device supports interactions between the digital assistant and the one or more other applications with or without explicit instructions from the user. More details on the user device 104 are provided in reference to an exemplary user device 104 shown in FIGS. 2A-2C.

Examples of the communication network(s) 110 include local area networks (“LAN”) and wide area networks (“WAN”), e.g., the Internet. The communication network(s) 110 may be implemented using any known network protocol, including various wired or wireless protocols, such as e.g., Ethernet, Universal Serial Bus (USB), FIREWIRE, Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

The server system 108 is implemented on one or more standalone data processing apparatus or a distributed network of computers. In some embodiments, the server system 108 also employs various virtual devices and/or services of third party service providers (e.g., third-party cloud service providers) to provide the underlying computing resources and/or infrastructure resources of the server system 108.

Although the digital assistant shown in FIG. 1 includes both a client-side portion (e.g., the DA-client 102) and a server-side portion (e.g., the DA-server 106), in some embodiments, the functions of a digital assistant is implemented as a standalone application installed on a user device, such as a tablet, laptop, or desktop computer. In addition, the divisions of functionalities between the client and server portions of the digital assistant can vary in different embodiments.

FIG. 2A is a block diagram of a user-device 104 in accordance with some embodiments. The user device 104 includes a memory interface 202, one or more processors 204, and a peripherals interface 206. The various components in the user device 104 are coupled by one or more communication buses or signal lines. The user device 104 includes various sensors, subsystems, and peripheral devices that are coupled to the peripherals interface 206. The sensors, subsystems, and peripheral devices gather information and/or facilitate various functionalities of the user device 104.

For example, a motion sensor 210, a light sensor 212, and a proximity sensor 214 are coupled to the peripherals interface 206 to facilitate orientation, light, and proximity sensing functions. One or more other sensors 216, such as a positioning system (e.g., GPS receiver), a temperature sensor, a biometric sensor, a gyro, a compass, an accelerometer, and the like, are also connected to the peripherals interface 206, to facilitate related functionalities.

In some embodiments, a camera subsystem 220 and an optical sensor 222 are utilized to facilitate camera functions, such as taking photographs and recording video clips. Communication functions are facilitated through one or more wired and/or wireless communication subsystems 224, which can include various communication ports, radio frequency receivers and transmitters, and/or optical (e.g., infrared) receivers and transmitters. An audio subsystem 226 is coupled to speakers 228 and a microphone 230 to facilitate voice-enabled functions, such as voice recognition, voice replication, digital recording, and telephony functions.

In some embodiments, an I/O subsystem 240 is also coupled to the peripheral interface 206. The I/O subsystem 240 includes a touch screen controller 242 and/or other input controller(s) 244. The touch-screen controller 242 is coupled to a touch screen 246. The touch screen 246 and the touch screen controller 242 can, for example, detect contact and movement or break thereof using any of a plurality of touch sensitivity technologies, such as capacitive, resistive, infrared, surface acoustic wave technologies, proximity sensor arrays, and the like. The other input controller(s) 244 can be coupled to other input/control devices 248, such as one or more non-touch-sensitive display screen, buttons, rocker switches, thumb-wheel, infrared port, USB port, pointer devices such as a stylus and/or a mouse, touch-sensitive surfaces such as a touchpad (e.g., shown in FIG. 2B), and/or hardware keyboards.

In some embodiments, the memory interface 202 is coupled to memory 250. The memory 250 optionally includes high-speed random access memory and/or non-volatile memory, such as one or more magnetic disk storage devices, one or more optical storage devices, and/or flash memory (e.g., NAND, NOR).

In some embodiments, the memory 250 stores an operating system 252, a communication module 254, a user interface module 256, a sensor processing module 258, a phone module 260, and applications 262. The operating system 252 includes instructions for handling basic system services and for performing hardware dependent tasks. The communication module 254 facilitates communicating with one or more additional devices, one or more computers and/or one or more servers. The user interface module 256 facilitates graphic user interface processing and output processing using other output channels (e.g., speakers). The sensor processing module 258 facilitates sensor-related processing and functions. The phone module 260 facilitates phone-related processes and functions. The application module 262 facilitates various functionalities of user applications, such as electronic-messaging, web browsing, media processing, Navigation, imaging and/or other processes and functions. As described in this application, the operating system 252 is capable of providing access to multiple applications (e.g., a digital assistant application and one or more user applications) in parallel, and allowing the user to interact with both the digital assistant and the one or more user applications through the graphical user interfaces and various I/O devices of the user device, in accordance with some embodiments. In some embodiments, the operating system 252 is also capable of providing interaction between the digital assistant and one or more user applications with or without the user's explicit instructions.

As described in this specification, the memory 250 also stores client-side digital assistant instructions (e.g., in a digital assistant client module 264) and various user data 266 (e.g., user-specific vocabulary data, preference data, and/or other data such as the user's electronic address book, to-do lists, shopping lists, etc.) to provide the client-side functionalities of the digital assistant.

In various embodiments, the digital assistant client module 264 is capable of accepting voice input (e.g., speech input), text input, touch input, and/or gestural input through various user interfaces (e.g., the I/O subsystem 244) of the user device 104. The digital assistant client module 264 is also capable of providing output in audio (e.g., speech output), visual, and/or tactile forms. For example, output is, optionally, provided as voice, sound, alerts, text messages, menus, graphics, videos, animations, vibrations, and/or combinations of two or more of the above. During operation, the digital assistant client module 264 communicates with the digital assistant server using the communication subsystems 224. As described in this application, the digital assistant is also capable of interacting with other applications executing on the user device with or without the user's explicit instructions, and provide visual feedback to the user in a graphical user interface regarding these interactions.

In some embodiments, the digital assistant client module 264 utilizes the various sensors, subsystems and peripheral devices to gather additional information from the surrounding environment of the user device 104 to establish a context associated with a user, the current user interaction, and/or the current user input. In some embodiments, the digital assistant client module 264 provides the context information or a subset thereof with the user input to the digital assistant server to help deduce the user's intent. In some embodiments, the digital assistant also uses the context information to determine how to prepare and delivery outputs to the user.

In some embodiments, the context information that accompanies the user input includes sensor information, e.g., lighting, ambient noise, ambient temperature, images or videos of the surrounding environment, etc. In some embodiments, the context information also includes the physical state of the device, e.g., device orientation, device location, device temperature, power level, speed, acceleration, motion patterns, cellular signals strength, etc. In some embodiments, information related to the software state of the user device 106, e.g., running processes, installed programs, past and present network activities, background services, error logs, resources usage, etc., of the user device 104 are provided to the digital assistant server as context information associated with a user input.

In some embodiments, the DA client module 264 selectively provides information (e.g., user data 266) stored on the user device 104 in response to requests from the digital assistant server. In some embodiments, the digital assistant client module 264 also elicits additional input from the user via a natural language dialogue or other user interfaces upon request by the digital assistant server 106. The digital assistant client module 264 passes the additional input to the digital assistant server 106 to help the digital assistant server 106 in intent inference and/or fulfillment of the user's intent expressed in the user request.

In various embodiments, the memory 250 includes additional instructions or fewer instructions. Furthermore, various functions of the user device 104 may be implemented in hardware and/or in firmware, including in one or more signal processing and/or application specific integrated circuits.

FIG. 2B illustrates a user device 104 having a touch screen 246 in accordance with some embodiments. The touch screen optionally displays one or more graphical user interface elements (e.g., icons, windows, controls, buttons, images, etc.) within user interface (UI) 202. In this embodiment, as well as others described below, a user selects one or more of the graphical user interface elements by, optionally, making contact or touching the graphical user interface elements on the touch screen 246, for example, with one or more fingers 204 (not drawn to scale in the figure) or stylus. In some embodiments, selection of one or more graphical user interface elements occurs when the user breaks contact with the one or more graphical user interface elements. In some embodiments, the contact includes a gesture, such as one or more taps, one or more swipes (from left to right, right to left, upward and/or downward) and/or a rolling of a finger (from right to left, left to right, upward and/or downward) that has made contact with the touch screen 246. In some embodiments, inadvertent contact with a graphical user interface element may not select the graphic. For example, a swipe gesture that sweeps over an application icon may not select the corresponding application when the gesture corresponding to selection is a tap.

The device 104, optionally, also includes one or more physical buttons, such as “home” or menu button 234. In some embodiments, the one or more physical buttons are used to activate or return to one or more respective applications when pressed according to various criteria (e.g., duration-based criteria).

In some embodiments, the device 104 includes a microphone 232 for accepting verbal input. The verbal inputs are processed and used as input for one or more applications and/or command for a digital assistant.

In some embodiments, the device 104 also includes one or more ports 236 for connecting to one or more peripheral devices, such as a keyboard, a pointing device, external audio system, a track-pad, an external display, etc., using various wired or wireless communication protocols.

FIG. 2C illustrates another exemplary user device 104 that includes a touch-sensitive surface 268 (e.g., a touchpad) separate from a display 270, in accordance with some embodiments. In some embodiments, the touch sensitive surface 268 has a primary axis 272 that corresponds to a primary axis 274 on the display 270. In accordance with these embodiments, the device detects contacts (e.g., contacts 276 and 278) with the touch-sensitive surface 268 at locations that correspond to respective locations on the display 270 (e.g., in FIG. 2C, contact 276 corresponds to location 280, and contact 278 corresponds to location 282). In this way, user inputs (e.g., contacts 276 and 278 and movements thereof) detected on the touch-sensitive surface 268 are used by the device 104 to manipulate the graphical user interface shown on the display 270. In some embodiments, the pointer cursor is optionally displayed on the display 270 at a location corresponding to the location of a contact on the touchpad 268. In some embodiments, the movement of the pointer cursor is controlled by the movement of a pointing device (e.g., a mouse) coupled to the user device 104.

In this specification, some of the examples will be given with reference to a user device having a touch screen display 246 (where the touch sensitive surface and the display are combined), some examples are described with reference to a user device having a touch-sensitive surface (e.g., touchpad 268) that is separate from the display (e.g., display 270), and some examples are described with reference to a user device that has a pointing device (e.g., a mouse) for controlling a pointer cursor in a graphical user interface shown on a display. In addition, some examples also utilize other hardware input devices (e.g., buttons, switches, keyboards, keypads, etc.) and a voice input device in combination with the touch screen, touchpad, and/or mouse of the user device 104 to receive multi-modal instructions from the user. A person skilled in the art should recognize that the examples user interfaces and interactions provided in the examples are merely illustrative, and are optionally implemented on devices that utilize any of the various types of input interfaces and combinations thereof.

Additionally, while some examples are given with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 268 in FIG. 2C) while the cursor is over a particular user interface element (e.g., a button, window, slider or other user interface element), the particular user interface element is adjusted in accordance with the detected input. In some implementations that include a touch-screen display enabling direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

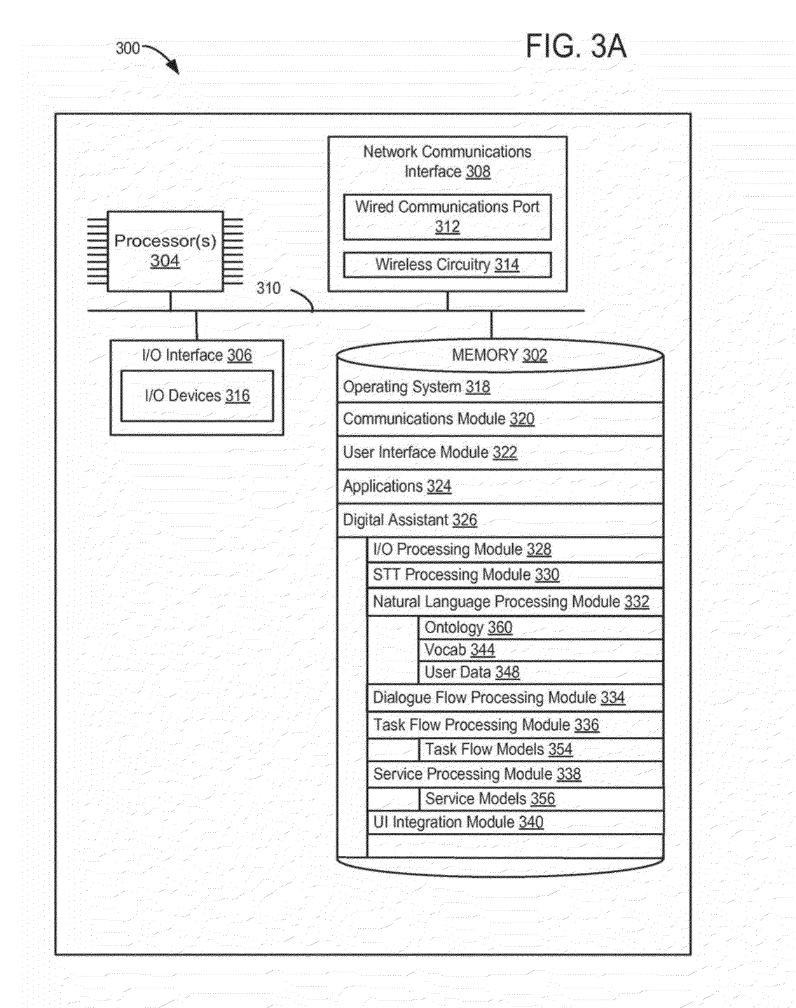

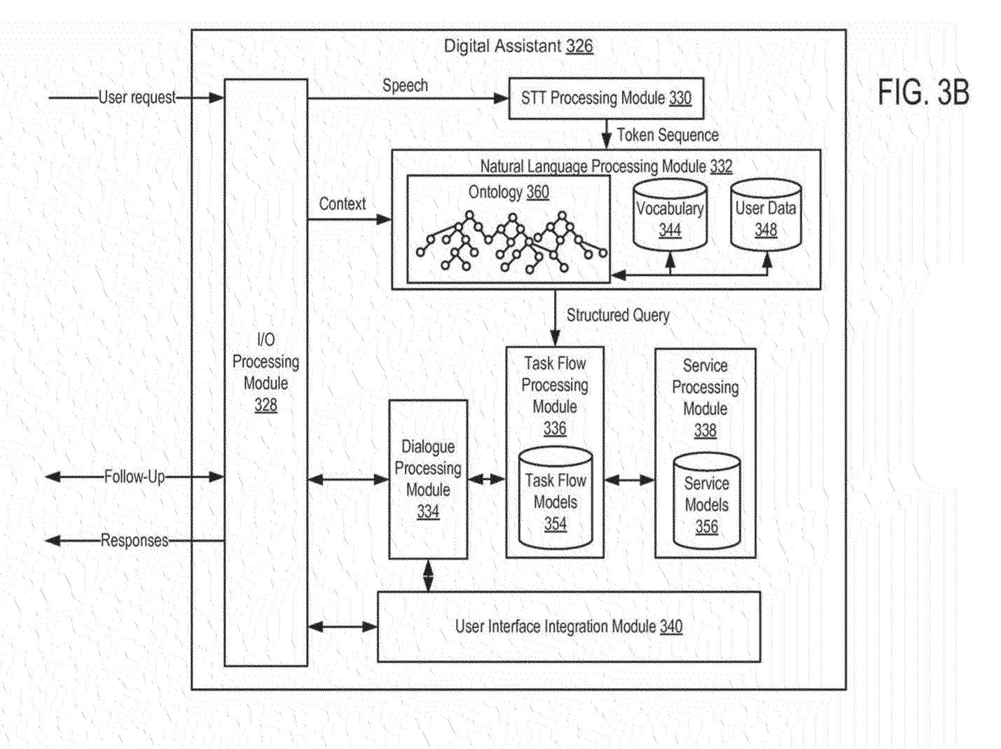

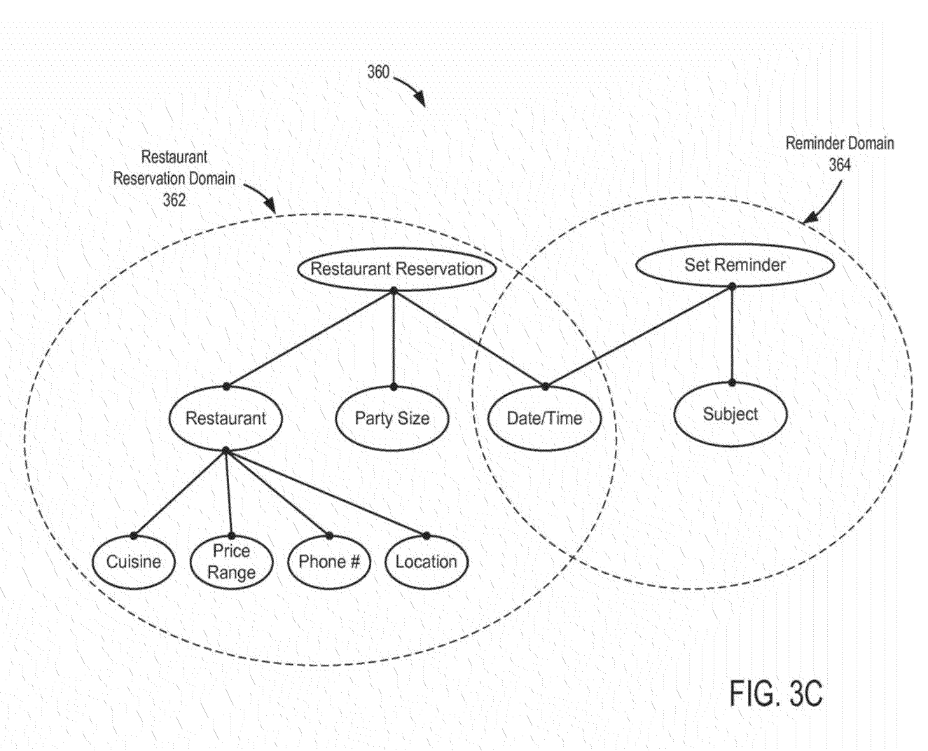

FIG. 3A is a block diagram of an example digital assistant system 300 in accordance with some embodiments. In some embodiments, the digital assistant system 300 is implemented on a standalone computer system, e.g., on a user device. In some embodiments, the digital assistant system 300 is distributed across multiple computers. In some embodiments, some of the modules and functions of the digital assistant are divided into a server portion and a client portion, where the client portion resides on a user device (e.g., the user device 104) and communicates with the server portion (e.g., the server system 108) through one or more networks, e.g., as shown in FIG. 1. In some embodiments, the digital assistant system 300 is an embodiment of the server system 108 (and/or the digital assistant server 106) shown in FIG. 1. It should be noted that the digital assistant system 300 is only one example of a digital assistant system, and that the digital assistant system 300 may have more or fewer components than shown, may combine two or more components, or may have a different configuration or arrangement of the components. The various components shown in FIG. 3A may be implemented in hardware, software instructions for execution by one or more processors, firmware, including one or more signal processing and/or application specific integrated circuits, or a combination of thereof.

The digital assistant system 300 includes memory 302, one or more processors 304, an input/output (I/O) interface 306, and a network communications interface 308. These components communicate with one another over one or more communication buses or signal lines 310.

In some embodiments, the memory 302 includes a non-transitory computer readable medium, such as high-speed random access memory and/or a non-volatile computer readable storage medium (e.g., one or more magnetic disk storage devices, flash memory devices, or other non-volatile solid-state memory devices).

In some embodiments, the I/O interface 306 couples input/output devices 316 of the digital assistant system 300, such as displays, a keyboards, touch screens, and microphones, to the user interface module 322. The I/O interface 306, in conjunction with the user interface module 322, receive user inputs (e.g., voice inputs, keyboard inputs, touch inputs, etc.) and process them accordingly. In some embodiments, e.g., when the digital assistant is implemented on a standalone user device, the digital assistant system 300 further includes any of the components and I/O and communication interfaces described with respect to the user device 104 in FIGS. 2A-2C. In some embodiments, the digital assistant system 300 represents the server portion of a digital assistant implementation, and interacts with the user through a client-side portion residing on a user device (e.g., the user device 104 shown in FIGS. 2A-2C).

In some embodiments, the network communications interface 308 includes wired communication port(s) 312 and/or wireless transmission and reception circuitry 314. The wired communication port(s) receive and send communication signals via one or more wired interfaces, e.g., Ethernet, Universal Serial Bus (USB), FIREWIRE, etc. The wireless circuitry 314 receives and sends RF signals and/or optical signals from/to communications networks and other communications devices. The wireless communications may use any of a plurality of communications standards, protocols and technologies, such as GSM, EDGE, CDMA, TDMA, Bluetooth, Wi-Fi, VoIP, Wi-MAX, or any other suitable communication protocol. The network communications interface 308 enables communication between the digital assistant system 300 with networks, such as the Internet, an intranet and/or a wireless network, such as a cellular telephone network, a wireless local area network (LAN) and/or a metropolitan area network (MAN), and other devices.

In some embodiments, memory 302, or the computer readable storage media of memory 302, stores programs, modules, instructions, and data structures including all or a subset of: an operating system 318, a communications module 320, a user interface module 322, one or more applications 324, and a digital assistant module 326. The one or more processors 304 execute these programs, modules, and instructions, and reads/writes from/to the data structures.

The operating system 318 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communications between various hardware, firmware, and software components.

The communications module 320 facilitates communications between the digital assistant system 300 with other devices over the network communications interface 308. For example, the communication module 320 may communicate with the communication interface 254 of the device 104 shown in FIG. 2. The communications module 320 also includes various components for handling data received by the wireless circuitry 314 and/or wired communications port 312.

The user interface module 322 receives commands and/or inputs from a user via the I/O interface 306 (e.g., from a keyboard, touch screen, pointing device, controller, touchpad, and/or microphone), and generates user interface objects on a display. The user interface module 322 also prepares and delivers outputs (e.g., speech, sound, animation, text, icons, vibrations, haptic feedback, and light, etc.) to the user via the I/O interface 306 (e.g., through displays, audio channels, speakers, and touchpads, etc.).

The applications 324 include programs and/or modules that are configured to be executed by the one or more processors 304. For example, if the digital assistant system is implemented on a standalone user device, the applications 324 may include user applications, such as games, a calendar application, a navigation application, or an email application. If the digital assistant system 300 is implemented on a server farm, the applications 324 may include resource management applications, diagnostic applications, or scheduling applications, for example. In this application, the digital assistant can be executed in parallel with one or more user applications, and the user is allowed to access the digital assistant and the one or more user application concurrently through the same set of user interfaces (e.g., a desktop interface providing and sustaining concurrent interactions with both the digital assistant and the user applications).

The memory 302 also stores the digital assistant module (or the server portion of a digital assistant) 326. In some embodiments, the digital assistant module 326 includes the following sub-modules, or a subset or superset thereof: an input/output processing module 328, a speech-to-text (STT) processing module 330, a natural language processing module 332, a dialogue flow processing module 334, a task flow processing module 336, a service processing module 338, and a user interface integration module 340. Each of these modules has access to one or more of the following data and models of the digital assistant 326, or a subset or superset thereof: ontology 360, vocabulary index 344, user data 348, task flow models 354, and service models 356.

In some embodiments, using the processing modules, data, and models implemented in the digital assistant module 326, the digital assistant performs at least some of the following: identifying a user's intent expressed in a natural language input received from the user; actively eliciting and obtaining information needed to fully infer the user's intent (e.g., by disambiguating words, names, intentions, etc.); determining the task flow for fulfilling the inferred intent; and executing the task flow to fulfill the inferred intent.

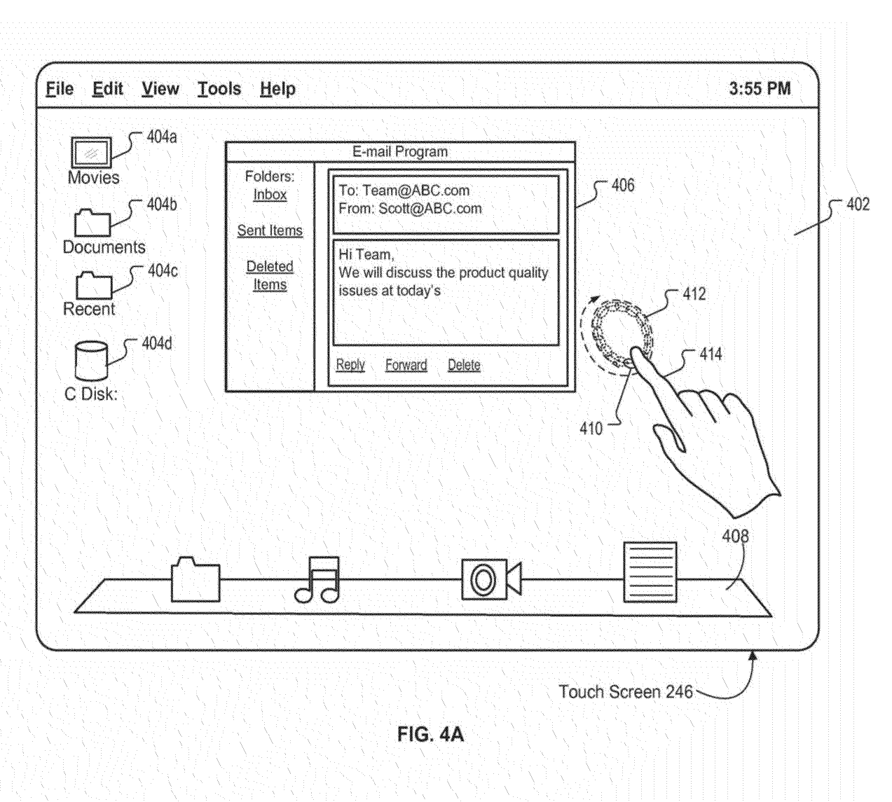

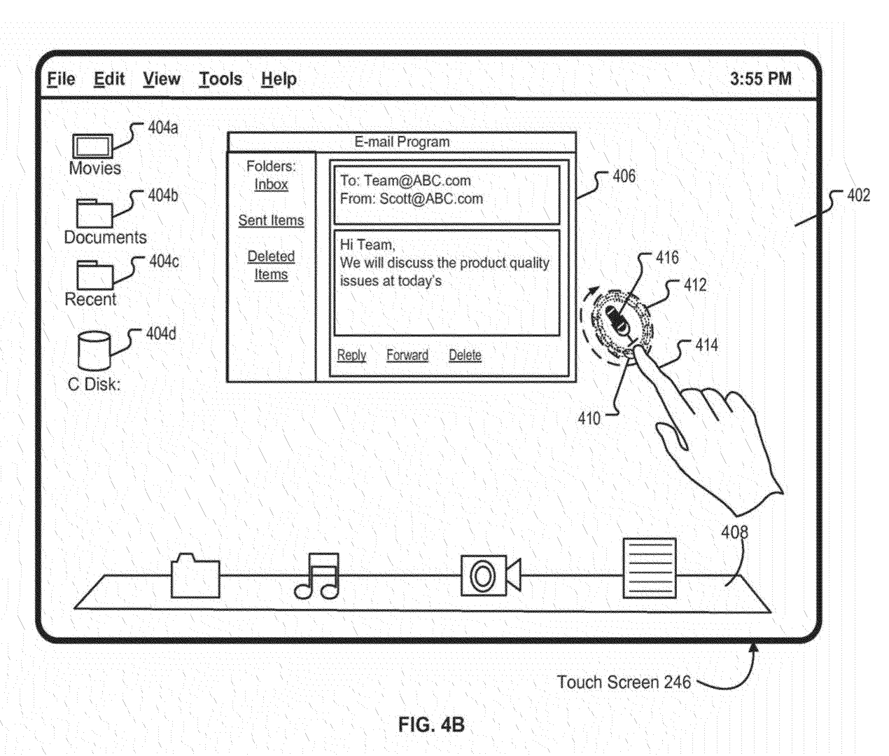

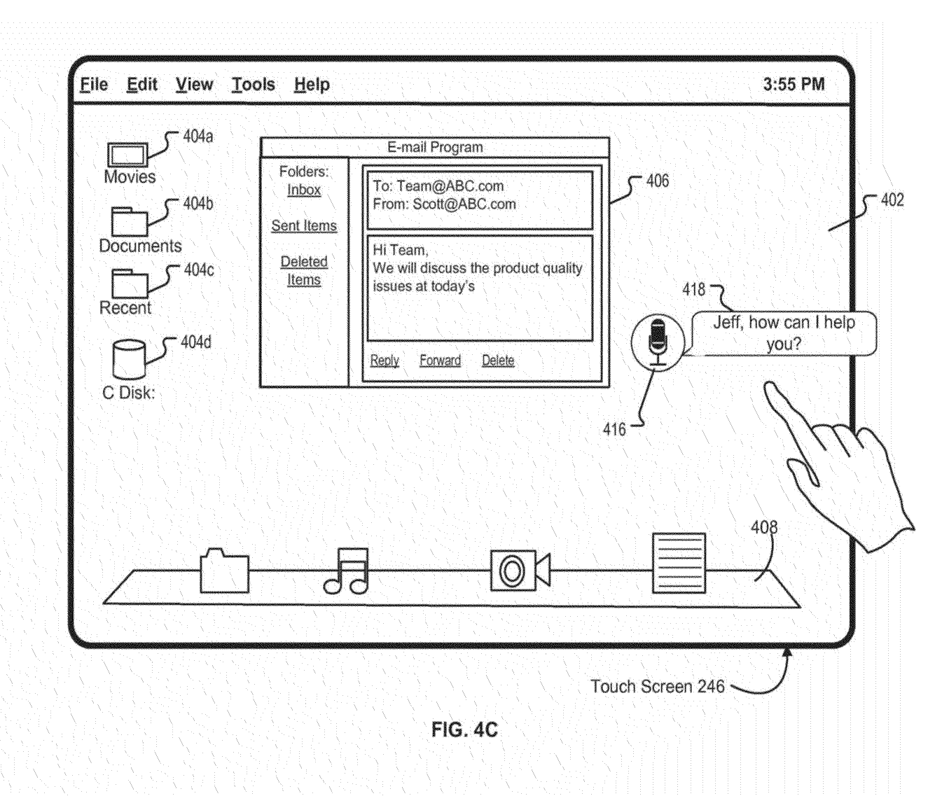

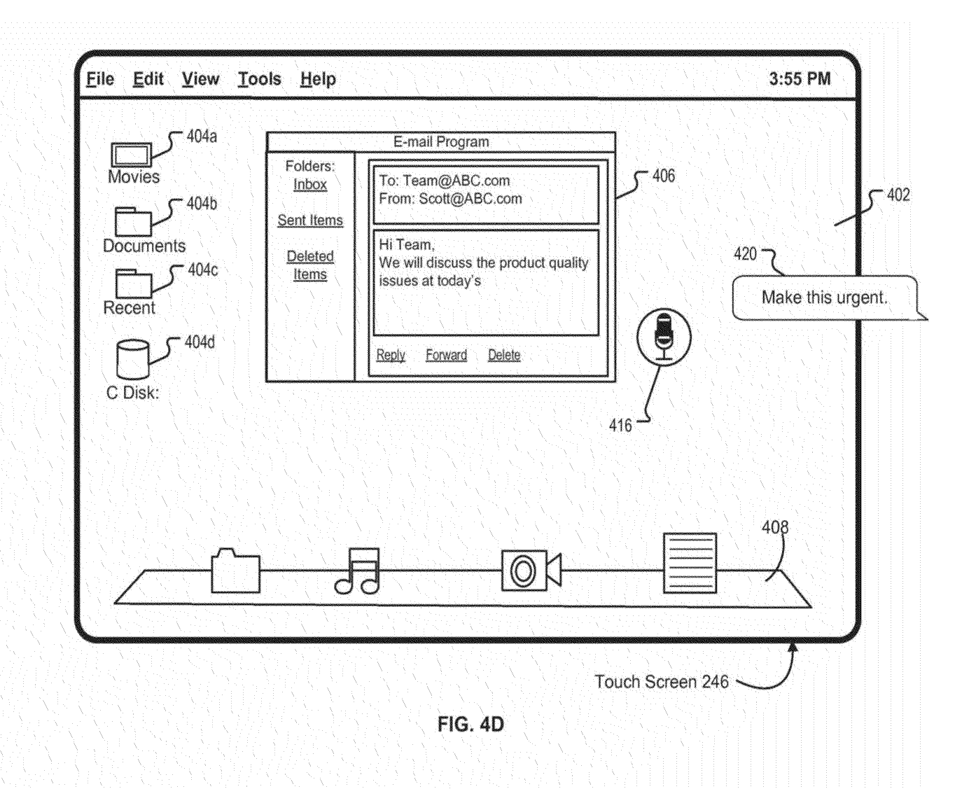

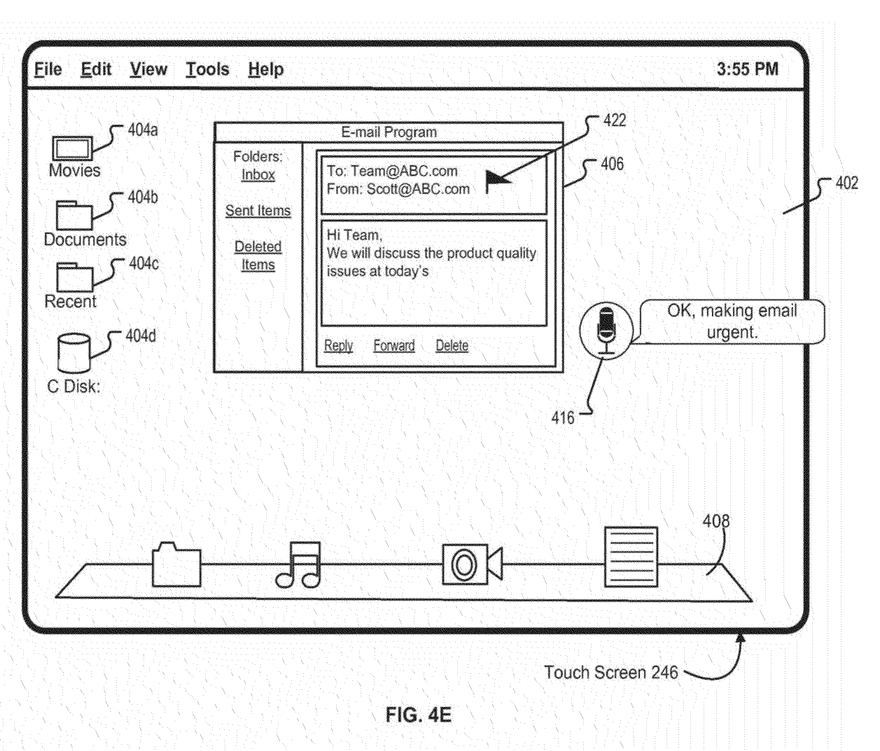

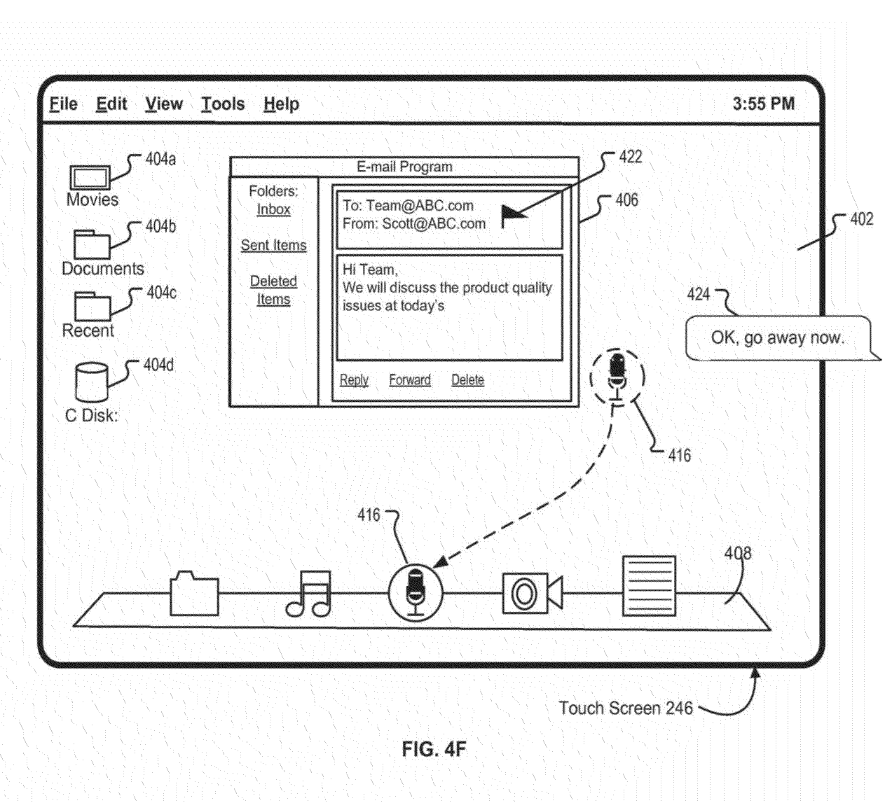

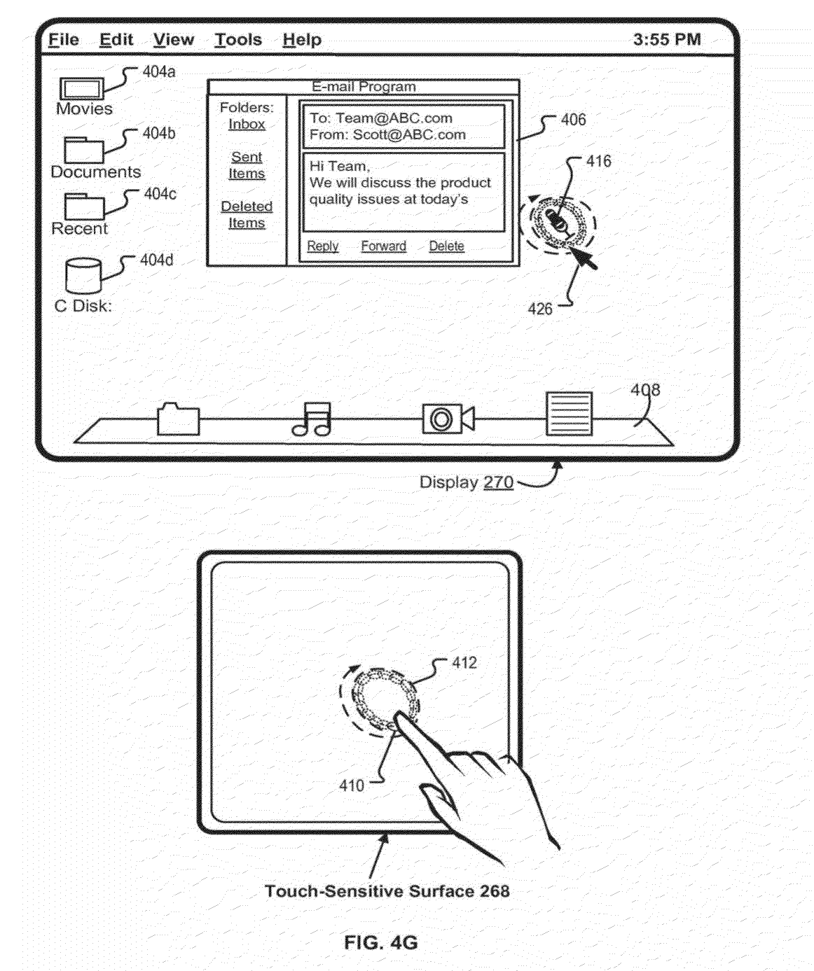

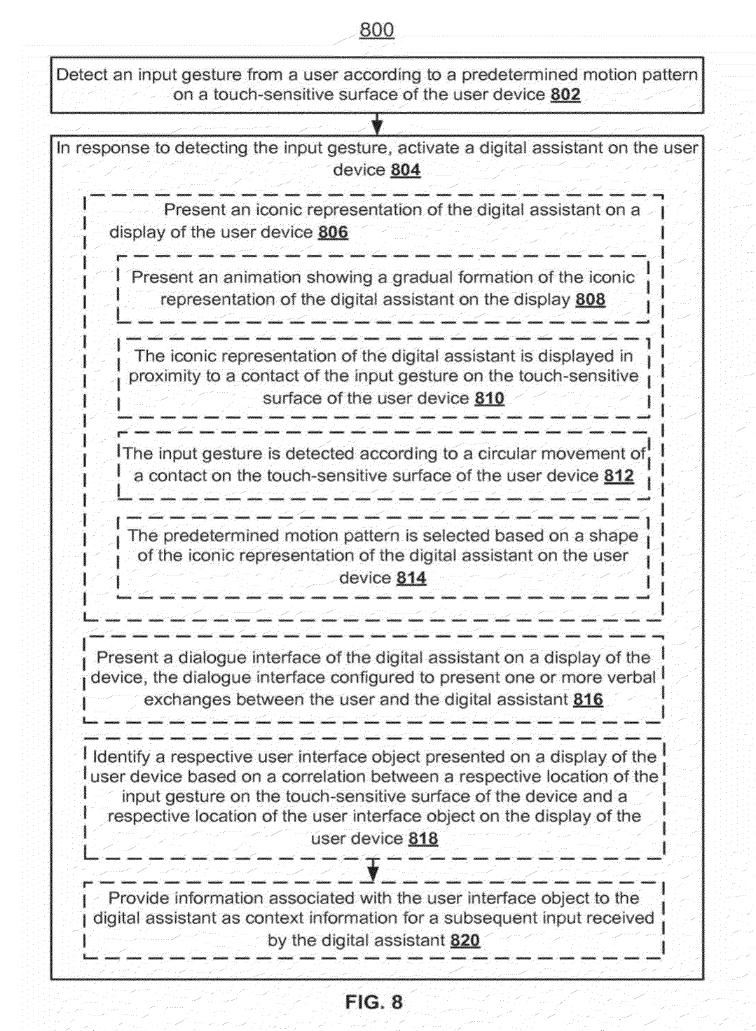

In some embodiments, the user interface integration module 340 communicates with the operating system 252 and/or the graphical user interface module 256 of the client device 104 to provide streamlined and integrated audio and visual feedback to the user regarding the states and actions of the digital assistant. In addition, in some embodiments, the user interface integration module 340 also provides input (e.g., input that emulates direct user input) to the operating system and various modules on behalf of the user to accomplish various tasks for the user. More details regarding the actions of the user interface integration module 340 are provided with respect to the exemplary user interfaces and interactions shown in FIGS. 4A-7V, and the processes described in FIGS. 8-11B.

In some embodiments, as shown in FIG. 3B, the I/O processing module 328 interacts with the user through the I/O devices 316 in FIG. 3A or with a user device (e.g., a user device 104 in FIG. 1) through the network communications interface 308 in FIG. 3A to obtain user input (e.g., a speech input) and to provide responses (e.g., as speech outputs) to the user input. The I/O processing module 328 optionally obtains context information associated with the user input from the user device, along with or shortly after the receipt of the user input. The context information includes user-specific data, vocabulary, and/or preferences relevant to the user input. In some embodiments, the context information also includes software and hardware states of the device (e.g., the user device 104 in FIG. 1) at the time the user request is received, and/or information related to the surrounding environment of the user at the time that the user request was received. In some embodiments, the context information also includes data provided by the user interface integration module 340. In some embodiments, the I/O processing module 328 also sends follow-up questions to, and receives answers from, the user regarding the user request. When a user request is received by the I/O processing module 328 and the user request contains a speech input, the I/O processing module 328 forwards the speech input to the speech-to-text (STT) processing module 330 for speech-to-text conversions.

The speech-to-text processing module 330 receives speech input (e.g., a user utterance captured in a voice recording) through the I/O processing module 328. In some embodiments, the speech-to-text processing module 330 uses various acoustic and language models to recognize the speech input as a sequence of phonemes, and ultimately, a sequence of words or tokens written in one or more languages. The speech-to-text processing module 330 can be implemented using any suitable speech recognition techniques, acoustic models, and language models, such as Hidden Markov Models, Dynamic Time Warping (DTW)-based speech recognition, and other statistical and/or analytical techniques. In some embodiments, the speech-to-text processing can be performed at least partially by a third party service or on the user's device. Once the speech-to-text processing module 330 obtains the result of the speech-to-text processing, e.g., a sequence of words or tokens, it passes the result to the natural language processing module 332 for intent inference.

More details on the speech-to-text processing are described in U.S. Utility application Ser. No. 13/236,942 for “Consolidating Speech Recognition Results,” filed on Sep. 20, 2011, the entire disclosure of which is incorporated herein by reference.

The natural language processing module 332 (“natural language processor”) of the digital assistant takes the sequence of words or tokens (“token sequence”) generated by the speech-to-text processing module 330, and attempts to associate the token sequence with one or more “actionable intents” recognized by the digital assistant. An “actionable intent” represents a task that can be performed by the digital assistant, and has an associated task flow implemented in the task flow models 354. The associated task flow is a series of programmed actions and steps that the digital assistant takes in order to perform the task. The scope of a digital assistant's capabilities is dependent on the number and variety of task flows that have been implemented and stored in the task flow models 354, or in other words, on the number and variety of “actionable intents” that the digital assistant recognizes. The effectiveness of the digital assistant, however, is also dependent on the assistant's ability to infer the correct “actionable intent(s)” from the user request expressed in natural language. In some embodiments, the device optionally provides a user interface that allows the user to type in a natural language text input for the digital assistant. In such embodiments, the natural language processing module 332 directly processes the natural language text input received from the user to determine one or more “actionable intents.”

In some embodiments, in addition to the sequence of words or tokens obtained from the speech-to-text processing module 330 (or directly from a text input interface of the digital assistant client), the natural language processor 332 also receives context information associated with the user request, e.g., from the I/O processing module 328. The natural language processor 332 optionally uses the context information to clarify, supplement, and/or further define the information contained in the token sequence received from the speech-to-text processing module 330. The context information includes, for example, user preferences, hardware and/or software states of the user device, sensor information collected before, during, or shortly after the user request, prior and/or concurrent interactions (e.g., dialogue) between the digital assistant and the user, prior and/or concurrent interactions (e.g., dialogue) between the user and other user applications executing on the user device, and the like. As described in this specification, context information is dynamic, and can change with time, location, content of the dialogue, and other factors.

In some embodiments, the natural language processing is based on ontology 360. The ontology 360 is a hierarchical structure containing many nodes, each node representing either an “actionable intent” or a “property” relevant to one or more of the “actionable intents” or other “properties”. As noted above, an “actionable intent” represents a task that the digital assistant is capable of performing, i.e., it is “actionable” or can be acted on. A “property” represents a parameter associated with an actionable intent or a sub-aspect of another property. A linkage between an actionable intent node and a property node in the ontology 360 defines how a parameter represented by the property node pertains to the task represented by the actionable intent node.

In some embodiments, the ontology 360 is made up of actionable intent nodes and property nodes. Within the ontology 360, each actionable intent node is linked to one or more property nodes either directly or through one or more intermediate property nodes. Similarly, each property node is linked to one or more actionable intent nodes either directly or through one or more intermediate property nodes. For example, as shown in FIG. 3C, the ontology 360 may include a “restaurant reservation” node (i.e., an actionable intent node). Property node “restaurant” (a domain entity represented by a property node) and property nodes “date/time” (for the reservation) and “party size” are each directly linked to the actionable intent node (i.e., the “restaurant reservation” node). In addition, property nodes “cuisine,” “price range,” “phone number,” and “location” are sub-nodes of the property node “restaurant,” and are each linked to the “restaurant reservation” node (i.e., the actionable intent node) through the intermediate property node “restaurant.” For another example, as shown in FIG. 3C, the ontology 360 may also include a “set reminder” node (i.e., another actionable intent node). Property nodes “date/time” (for the setting the reminder) and “subject” (for the reminder) are each linked to the “set reminder” node. Since the property “date/time” is relevant to both the task of making a restaurant reservation and the task of setting a reminder, the property node “date/time” is linked to both the “restaurant reservation” node and the “set reminder” node in the ontology 360.

An actionable intent node, along with its linked concept nodes, may be described as a “domain.” In the present discussion, each domain is associated with a respective actionable intent, and refers to the group of nodes (and the relationships therebetween) associated with the particular actionable intent. For example, the ontology 360 shown in FIG. 3C includes an example of a restaurant reservation domain 362 and an example of a reminder domain 364 within the ontology 360. The restaurant reservation domain includes the actionable intent node “restaurant reservation,” property nodes “restaurant,” “date/time,” and “party size,” and sub-property nodes “cuisine,” “price range,” “phone number,” and “location.” The reminder domain 364 includes the actionable intent node “set reminder,” and property nodes “subject” and “date/time.” In some embodiments, the ontology 360 is made up of many domains. Each domain may share one or more property nodes with one or more other domains. For example, the “date/time” property node may be associated with many different domains (e.g., a scheduling domain, a travel reservation domain, a movie ticket domain, etc.), in addition to the restaurant reservation domain 362 and the reminder domain 364.

While FIG. 3C illustrates two example domains within the ontology 360, other domains (or actionable intents) include, for example, “initiate a phone call,” “find directions,” “schedule a meeting,” “send a message,” and “provide an answer to a question,” “read a list”, “providing navigation instructions,” “provide instructions for a task” and so on. A “send a message” domain is associated with a “send a message” actionable intent node, and may further include property nodes such as “recipient(s)”, “message type”, and “message body.” The property node “recipient” may be further defined, for example, by the sub-property nodes such as “recipient name” and “message address.”

In some embodiments, the ontology 360 includes all the domains (and hence actionable intents) that the digital assistant is capable of understanding and acting upon. In some embodiments, the ontology 360 may be modified, such as by adding or removing entire domains or nodes, or by modifying relationships between the nodes within the ontology 360.

In some embodiments, nodes associated with multiple related actionable intents may be clustered under a “super domain” in the ontology 360. For example, a “travel” super-domain may include a cluster of property nodes and actionable intent nodes related to travel. The actionable intent nodes related to travel may include “airline reservation,” “hotel reservation,” “car rental,” “get directions,” “find points of interest,” and so on. The actionable intent nodes under the same super domain (e.g., the “travel” super domain) may have many property nodes in common. For example, the actionable intent nodes for “airline reservation,” “hotel reservation,” “car rental,” “get directions,” “find points of interest” may share one or more of the property nodes, such as “start location,” “destination,” “departure date/time,” “arrival date/time,” and “party size.”

In some embodiments, each node in the ontology 360 is associated with a set of words and/or phrases that are relevant to the property or actionable intent represented by the node. The respective set of words and/or phrases associated with each node is the so-called “vocabulary” associated with the node. The respective set of words and/or phrases associated with each node can be stored in the vocabulary index 344 in association with the property or actionable intent represented by the node. For example, returning to FIG. 3B, the vocabulary associated with the node for the property of “restaurant” may include words such as “food,” “drinks,” “cuisine,” “hungry,” “eat,” “pizza,” “fast food,” “meal,” and so on. For another example, the vocabulary associated with the node for the actionable intent of “initiate a phone call” may include words and phrases such as “call,” “phone,” “dial,” “ring,” “call this number,” “make a call to,” and so on. The vocabulary index 344 optionally includes words and phrases in different languages.

The natural language processor 332 receives the token sequence (e.g., a text string) from the speech-to-text processing module 330, and determines what nodes are implicated by the words in the token sequence. In some embodiments, if a word or phrase in the token sequence is found to be associated with one or more nodes in the ontology 360 (via the vocabulary index 344), the word or phrase will “trigger” or “activate” those nodes. Based on the quantity and/or relative importance of the activated nodes, the natural language processor 332 will select one of the actionable intents as the task that the user intended the digital assistant to perform. In some embodiments, the domain that has the most “triggered” nodes is selected. In some embodiments, the domain having the highest confidence value (e.g., based on the relative importance of its various triggered nodes) is selected. In some embodiments, the domain is selected based on a combination of the number and the importance of the triggered nodes. In some embodiments, additional factors are considered in selecting the node as well, such as whether the digital assistant has previously correctly interpreted a similar request from a user.

In some embodiments, the digital assistant also stores names of specific entities in the vocabulary index 344, so that when one of these names is detected in the user request, the natural language processor 332 will be able to recognize that the name refers to a specific instance of a property or sub-property in the ontology. In some embodiments, the names of specific entities are names of businesses, restaurants, people, movies, and the like. In some embodiments, the digital assistant searches and identifies specific entity names from other data sources, such as the user's address book, a movies database, a musicians database, and/or a restaurant database. In some embodiments, when the natural language processor 332 identifies that a word in the token sequence is a name of a specific entity (such as a name in the user's address book), that word is given additional significance in selecting the actionable intent within the ontology for the user request.

For example, when the words “Mr. Santo” are recognized from the user request and the last name “Santo” is found in the vocabulary index 344 as one of the contacts in the user's contact list, then it is likely that the user request corresponds to a “send a message” or “initiate a phone call” domain. For another example, when the words “ABC Café” are found in the user request, and the term “ABC Café” is found in the vocabulary index 344 as the name of a particular restaurant in the user's city, then it is likely that the user request corresponds to a “restaurant reservation” domain.

User data 348 includes user-specific information, such as user-specific vocabulary, user preferences, user address, user's default and secondary languages, user's contact list, and other short-term or long-term information for each user. In some embodiments, the natural language processor 332 uses the user-specific information to supplement the information contained in the user input to further define the user intent. For example, for a user request “invite my friends to my birthday party,” the natural language processor 332 is able to access user data 348 to determine who the “friends” are and when and where the “birthday party” would be held, rather than requiring the user to provide such information explicitly in his/her request.

Other details of searching an ontology based on a token string is described in U.S. Utility application Ser. No. 12/341,743 for “Method and Apparatus for Searching Using An Active Ontology,” filed Dec. 22, 2008, the entire disclosure of which is incorporated herein by reference.

In some embodiments, once the natural language processor 332 identifies an actionable intent (or domain) based on the user request, the natural language processor 332 generates a structured query to represent the identified actionable intent. In some embodiments, the structured query includes parameters for one or more nodes within the domain for the actionable intent, and at least some of the parameters are populated with the specific information and requirements specified in the user request. For example, the user may say “Make me a dinner reservation at a sushi place at 7.” In this case, the natural language processor 332 may be able to correctly identify the actionable intent to be “restaurant reservation” based on the user input. According to the ontology, a structured query for a “restaurant reservation” domain may include parameters such as {Cuisine}, {Time}, {Date}, {Party Size}, and the like. In some embodiments, based on the information contained in the user's utterance, the natural language processor 332 generates a partial structured query for the restaurant reservation domain, where the partial structured query includes the parameters {Cuisine=“Sushi”} and {Time=“7 pm”}. However, in this example, the user's utterance contains insufficient information to complete the structured query associated with the domain. Therefore, other necessary parameters such as {Party Size} and {Date} are not specified in the structured query based on the information currently available. In some embodiments, the natural language processor 332 populates some parameters of the structured query with received context information. For example, in some embodiments, if the user requested a sushi restaurant “near me,” the natural language processor 332 populates a {location} parameter in the structured query with GPS coordinates from the user device 104.

In some embodiments, the natural language processor 332 passes the structured query (including any completed parameters) to the task flow processing module 336 (“task flow processor”). The task flow processor 336 is configured to receive the structured query from the natural language processor 332, complete the structured query, if necessary, and perform the actions required to “complete” the user's ultimate request. In some embodiments, the various procedures necessary to complete these tasks are provided in task flow models 354. In some embodiments, the task flow models include procedures for obtaining additional information from the user, and task flows for performing actions associated with the actionable intent.

As described above, in order to complete a structured query, the task flow processor 336 may need to initiate additional dialogue with the user in order to obtain additional information, and/or disambiguate potentially ambiguous utterances. When such interactions are necessary, the task flow processor 336 invokes the dialogue processing module 334 (“dialogue processor 334”) to engage in a dialogue with the user. In some embodiments, the dialogue processor 334 determines how (and/or when) to ask the user for the additional information, and receives and processes the user responses. The questions are provided to and answers are received from the users through the I/O processing module 328. In some embodiments, the dialogue processor 334 presents dialogue output to the user via audio and/or visual output, and receives input from the user via spoken or physical (e.g., clicking) responses. Continuing with the example above, when the task flow processor 336 invokes the dialogue flow processor 334 to determine the “party size” and “date” information for the structured query associated with the domain “restaurant reservation,” the dialogue flow processor 335 generates questions such as “For how many people?” and “On which day?” to pass to the user. Once answers are received from the user, the dialogue flow processor 334 can then populate the structured query with the missing information, or pass the information to the task flow processor 336 to complete the missing information from the structured query.

In some cases, the task flow processor 336 may receive a structured query that has one or more ambiguous properties. For example, a structured query for the “send a message” domain may indicate that the intended recipient is “Bob,” and the user may have multiple contacts named “Bob.” The task flow processor 336 will request that the dialogue processor 334 disambiguate this property of the structured query. In turn, the dialogue processor 334 may ask the user “Which Bob?”, and display (or read) a list of contacts named “Bob” from which the user may choose.

Once the task flow processor 336 has completed the structured query for an actionable intent, the task flow processor 336 proceeds to perform the ultimate task associated with the actionable intent. Accordingly, the task flow processor 336 executes the steps and instructions in the task flow model according to the specific parameters contained in the structured query. For example, the task flow model for the actionable intent of “restaurant reservation” may include steps and instructions for contacting a restaurant and actually requesting a reservation for a particular party size at a particular time. For example, using a structured query such as: {restaurant reservation, restaurant=ABC Café, date=Mar. 12, 2012, time=7 pm, party size=5}, the task flow processor 336 may perform the steps of: (1) logging onto a server of the ABC Café or a restaurant reservation system such as OPENTABLE®, (2) entering the date, time, and party size information in a form on the website, (3) submitting the form, and (4) making a calendar entry for the reservation in the user's calendar.

In some embodiments, the task flow processor 336 employs the assistance of a service processing module 338 (“service processor”) to complete a task requested in the user input or to provide an informational answer requested in the user input. For example, the service processor 338 can act on behalf of the task flow processor 336 to make a phone call, set a calendar entry, invoke a map search, invoke or interact with other user applications installed on the user device, and invoke or interact with third party services (e.g. a restaurant reservation portal, a social networking website, a banking portal, etc.). In some embodiments, the protocols and application programming interfaces (API) required by each service can be specified by a respective service model among the services models 356. The service processor 338 accesses the appropriate service model for a service and generates requests for the service in accordance with the protocols and APIs required by the service according to the service model.

For example, if a restaurant has enabled an online reservation service, the restaurant can submit a service model specifying the necessary parameters for making a reservation and the APIs for communicating the values of the necessary parameter to the online reservation service. When requested by the task flow processor 336, the service processor 338 can establish a network connection with the online reservation service using the web address stored in the service model, and send the necessary parameters of the reservation (e.g., time, date, party size) to the online reservation interface in a format according to the API of the online reservation service.

In some embodiments, the natural language processor 332, dialogue processor 334, and task flow processor 336 are used collectively and iteratively to infer and define the user's intent, obtain information to further clarify and refine the user intent, and finally generate a response (i.e., an output to the user, or the completion of a task) to fulfill the user's intent.

In some embodiments, after all of the tasks needed to fulfill the user's request have been performed, the digital assistant 326 formulates a confirmation response, and sends the response back to the user through the I/O processing module 328. If the user request seeks an informational answer, the confirmation response presents the requested information to the user. In some embodiments, the digital assistant also requests the user to indicate whether the user is satisfied with the response produced by the digital assistant 326.

As described in this application, in some embodiments, the digital assistant is invoked on a user device, and executed in parallel with one or more other user applications on the user device. In some embodiments, the digital assistant and the one or more user applications share the same set of user interfaces and I/O devices when concurrently interacting with a user. The actions of the digital assistant and the applications are optionally coordinated to accomplish the same task, or independent of one another to accomplish separate tasks in parallel.

In some embodiments, the user provides at least some inputs to the digital assistant via direct interactions with the one or more other user applications. In some embodiments, the user provides at least some inputs to the one or more user applications through direct interactions with the digital assistant. In some embodiments, the same graphical user interface (e.g., the graphical user interfaces shown on a display screen) provides visual feedback for the interactions between the user and the digital assistant and between the user and the other user applications. In some embodiments, the user interface integration module 340 (shown in FIG. 3A) correlates and coordinates the user inputs directed to the digital assistant and the other user applications, and provides suitable outputs (e.g., visual and other sensory feedbacks) for the interactions among the user, the digital assistant, and the other user applications. Exemplary user interfaces and flow charts of associated methods are provided in FIGS. 4A-11B and accompanying descriptions.

More details on the digital assistant can be found in the U.S. Utility application Ser. No. 12/987,982, entitled “Intelligent Automated Assistant”, filed Jan. 18, 2010, U.S. Utility Application No. 61/493,201, entitled “Generating and Processing Data Items That Represent Tasks to Perform”, filed Jun. 3, 2011, the entire disclosures of which are incorporated herein by reference.

### Invoking a Digital Assistant:

Providing a digital assistant on a user device consumes computing resources (e.g., power, network bandwidth, memory, and processor cycles). Therefore, it is sometimes desirable to suspend or shut down the digital assistant while it is not required by the user. There are various methods for invoking the digital assistant from a suspended state or a completely dormant state when the digital assistant is needed by the user. For example, in some embodiments, a digital assistant is assigned a dedicated hardware control (e.g., the “home” button on the user device or a dedicated “assistant” key on a hardware keyboard coupled to the user device). When a dedicated hardware control is invoked (e.g., pressed) by a user, the user device activates (e.g., restarts from a suspended state or reinitializes from a completely dormant state) the digital assistant. In some embodiments, the digital assistant enters a suspended state after a period of inactivity, and is “woken up” into a normal operational state when the user provides a predetermined voice input (e.g., “Assistant, wake up!”). In some embodiments, as described with respect to FIGS. 4A-4G and FIG. 8, a predetermined touch-based gesture is used to activate the digital assistant either from a suspended state or from a completely dormant state, e.g., whenever the gesture is detected on a touch-sensitive surface (e.g., a touch-sensitive display screen 246 in FIG. 2B or a touchpad 268 in FIG. 2C) of the user device.

Sometimes, it is desirable to provide a touch-based method for invoking the digital assistant in addition to or in the alternative to a dedicated hardware key (e.g., a dedicated “assistant” key). For example, sometimes, a hardware keyboard may not be available, or the keys on the hardware keyboard or user device need to be reserved for other purposes. Therefore, in some embodiments, it is desirable to provide a way to invoke the digital assistant through a touch-based input in lieu of (or in addition to) a selection of a dedicated assistant key. Sometimes, it is desirable to provide a touch-based method for invoking the digital assistant in addition to or in the alternative to a predetermined voice-activation command (e.g., the command “Assistant, wake up!”). For example, a predetermined voice-activation for the digital assistant may require an open voice channel to be maintained by the user device, and, therefore, may consume power when the assistant is not required. In addition, voice-activation may be inappropriate for some locations for noise or privacy reasons. Therefore, it may be more desirable to provide means for invoking the digital assistant through a touch-based input in lieu of (or in addition to) the predetermined voice-activation command.

As will be shown below, in some embodiments, a touch-based input also provides additional information that is optionally used as context information for interpreting subsequent user requests to the digital assistant after the digital assistant is activated by the touch-based input. Thus, the touch-based activation may further improve the efficiency of the user interface and streamline the interaction between the user and the digital assistant.

In FIGS. 4A-4G, exemplary user interfaces for invoking a digital assistant through a touch-based gesture on a touch-sensitive surface of a computing device (e.g., device 104 in FIGS. 2A-2C) are described. In some embodiments, the touch-sensitive surface is a touch-sensitive display (e.g., touch screen 246 in FIG. 2B) of the device. In some embodiments, the touch-sensitive surface is a touch-sensitive surface (e.g., touchpad 268 in FIG. 2C) separate from the display (e.g., display 270) of the device. In some embodiments, the touch-sensitive surface is provided through other peripheral devices coupled to the user device, such as a touch-sensitive surface on the back of a touch-sensitive pointing device (e.g., a touch-sensitive mouse).

As shown in 4A, an exemplary graphical user interface (e.g., a desktop interface 402) is provided on a touch-sensitive display screen 246. On the desktop interface 402, various user interface objects are displayed. In some embodiments, the various user interface objects 406 include one or more of: icons (e.g., icons 404 for devices, resources, documents, and/or user applications), applications windows (e.g., email editor window 406), pop-up windows, menu bars, containers (e.g., a dock 408 for applications, or a container for widgets), and the like. The user manipulates the user interface objects, optionally, by providing various touch-based inputs (e.g., a tap gesture, a swipe gesture, and various other single-touch and/or multi-touch gestures) on the touch-sensitive display screen 246.

In FIG. 4A, the user has started to provide a touch-based input on the touch screen 246. The touch-based input includes a persistent contact 410 between the user's finger 414 and the touch screen 246. Persistent contact means that the user's finger remains in contact with the screen 246 during an input period. As the persistent contact 410 moves on the touch screen 246, the movement of the persistent contact 410 creates a motion path 412 on the surface of the touch screen 246. The user device compares the motion path 412 with a predetermined motion pattern (e.g., a repeated circular motion) associated with activating the digital assistant, and determines whether or not to activate the digital assistant on the user device. As shown in FIGS. 4A-4B, the user has provided a touch-input on the touch screen 246 according to the predetermined motion pattern (e.g., a repeated circular motion), and in response, in some embodiments, an iconic representation 416 of the digital assistant gradually forms (e.g., fades in) in the vicinity of the area occupied by the movement of the persistent contact 410. Note that, the user's hand is not part of the graphical user interface displayed on the touch screen 246. In addition, the persistent contact 408 and the motion path 412 traced out by the movement of the persistent contact 408 are shown in the figures for purposes of explaining the user interaction, and are not necessarily shown in actual embodiments of the user interfaces.

In this particular example, the movement of the persistent contact 410 on the surface of the touch screen 246 follows a path 412 that is roughly circular (or elliptical) in shape, and a circular (or elliptical) iconic representation 416 for the digital assistant gradually forms in the area occupied by the circular path 412. When the iconic representation 416 of the digital assistant is fully formed on the user interface 402, as shown in FIG. 4C, the digital assistant is fully activated and ready to accept inputs and requests (e.g., speech input or text input) from the user.

In some embodiments, as shown in FIG. 4B, as the user's finger 414 moves on the surface of the touch screen 246, the iconic representation 416 of the digital assistant (e.g., a circular icon containing a stylized microphone image) gradually fades into view in the user interface 402, and rotates along with the circular motion of the persistent contact 410 between the user's finger and the touch screen 246. Eventually, after one or more iterations (e.g., two iterations) of the circular motion of the persistent contact 410 on the surface of the touch screen 246, the iconic representation 416 is fully formed and presented in an upright orientation on the user interface 402, as shown in FIG. 4C.

In some embodiments, the digital assistant provides a voice prompt for user input immediately after it is activated. For example, in some embodiments, the digital assistant optionally utters a voice prompt 418 (e.g., “[user's name], how can I help you?”) after the user has finished providing the gesture input and the device detects a separation of the user's finger 414 from the touch screen 246. In some embodiments, the digital assistant is activated after the user has provided a required motion pattern (e.g., two full circles), and the voice prompt is provided regardless of whether the user continues with the motion pattern or not.

In some embodiments, the user device displays a dialogue panel on the user interface 402, and the digital assistant provides a text prompt in the dialogue panel instead of (or in addition to) an audible voice prompt. In some embodiments, the user, instead of (or in addition to) providing a speech input through a voice input channel of the digital assistant, optionally provides his or her request by typing text into the dialogue panel using a virtual or hardware keyboard.

In some embodiments, before the user has provided the entirety of the required motion pattern though the persistent contact 410, and while the iconic representation 416 of the digital assistant is still in the process of fading into view, the user is allowed to abort the activation process by terminating the gesture input. For example, in some embodiments, if the user terminates the gesture input by lifting his/her finger 414 off of the touch screen 246 or stopping the movement of the finger contact 410 for at least a predetermined amount of time, the activation of the digital assistant is canceled, and the partially-formed iconic representation of the digital assistant gradually fades away.

In some embodiments, if the user temporarily stops the motion of the contact 410 during the animation for forming the iconic representation 416 of the digital assistant on the user interface 402, the animation is suspended until the user resumes the circular motion of the persistent contact 410.

In some embodiments, while the iconic representation 416 of the digital assistant is in the process of fading into view on the user interface 402, if the user terminates the gesture input by moving the finger contact 410 away from a predicted path (e.g., the predetermined motion pattern for activating the digital assistant), the activation of the digital assistant is canceled, and the partially-formed iconic representation of the digital assistant gradually fades away.

By using a touch-based gesture that forms a predetermined motion pattern to invoke the digital assistant, and providing an animation showing the gradual formation of the iconic presentation of the digital assistant (e.g., as in the embodiments described above), the user is provided with time and opportunity to cancel or terminate the activation of the digital assistant if the user changes his or her mind while providing the required gesture. In some embodiments, a tactile feedback is provided to the user when the digital assistant is activated and the window for canceling the activation by terminating the gesture input is closed. In some embodiments, the iconic representation of the digital assistant is presented immediately when the required gesture is detected on the touch screen, i.e., no fade-in animation is presented.

In this example, the input gesture is provided at a location on the user interface 402 near an open application window 406 of an email editor. Within the application window 406 is a partially completed email message, as shown in FIG. 4A. In some embodiments, when the motion path of a touch-based gesture matches the predetermined motion pattern for invoking the digital assistant, the device presents the iconic representation 416 of the digital assistant in the vicinity of the motion path. In some embodiments, the device provides the location of the motion path to the digital assistant as part of the context information used to interpret and disambiguate a subsequent user request made to the digital assistant. For example, as shown in FIG. 4D, after having provided the required gesture to invoke the digital assistant, the user provided a voice input 420 (e.g., “Make this urgent.”) to the digital assistant. In response to the voice input, the digital assistant uses the location of the touch-based gesture (e.g., the location of the motion path or the location of the initial contact made on the touch screen 246) to identify a corresponding location of interest on the user interface 402 and one or more target user interface objects located in proximity to that location of interest. In this example, the digital assistant identifies the partially finished email message in the open window 406 as the target user interface object of the newly received user request. As shown in FIG. 4E, the digital assistant has inserted an “urgent” flag 422 in the draft email as requested by the user.

In some embodiments, the iconic representation 416 of the digital assistant remains in its initial location and prompts the user to provide additional requests regarding the current task. For example, after the digital assistant inserts the “urgent flag” into the partially completed email message, the user optionally provides an additional voice input “Start dictation.” After the digital assistant initiates a dictation mode, e.g., by putting a text input cursor at the end of the email message, the user optionally starts dictating the remainder of the message to the digital assistant, and the digital assistant responds by inputting the text according to the user's subsequent speech input.

In some embodiments, the user optionally puts the digital assistant back into a standby or suspended state by using a predetermined voice command (e.g., “Go away now.” “Standby.” or “Good bye.”). In some embodiments, the user optionally taps on the iconic representation 410 of the digital assistant to put the digital assistant back into the suspended or terminated state. In some embodiments, the user optionally uses another gesture (e.g., a swipe gesture across the iconic representation 416) to deactivates the digital assistant.

In some embodiments, the gesture for deactivating the digital assistant is two or more repeated swipes back and forth over the iconic representation 416 of the digital assistant. In some embodiments, the iconic representation 416 of the digital assistant gradually fades away with each additional swipe. In some embodiments, when the iconic representation 416 of the digital assistant completely disappears from the user interface in response to the user's voice command or swiping gestures, the digital assistant is returned back to a suspended or completely deactivated state.

In some embodiments, the user optionally sends the iconic representation 416 of the digital assistant to a predetermined home location (e.g., a dock 408 for applications, the desktop menu bar, or other predetermined location on the desktop) on the user interface 402 by providing a tap gesture on the iconic representation 416 of the digital assistant. When the digital assistant is presented at the home location, the digital assistant stops using its initial location as a context for subsequent user requests. As shown in FIG. 4F, the iconic representation 416 of the digital assistant is moved to the home location on the dock 408 in response to a predetermined voice input 424 (e.g., “Thank you, that'd be all.”). In some embodiments, an animation is shown to illustrate the movement of the iconic representation 416 from its initial location to the home location on the dock 408. In some embodiments, the iconic representation 416 of the digital assistant takes on a different appearance (e.g., different size, color, hue, etc.) when residing on the dock 408.

In some embodiments, the user optionally touches the iconic representation 416 of the digital assistant and drags the iconic representation 416 to a different location on the user interface 402, such that the new location of the iconic representation 416 is used to provide context information for a subsequently received user request to the digital assistant. For example, if the user drags the iconic representation 408 of the digital assistant to a “work” document folder icon on the dock 408, and provides a voice input “find lab report.” The digital assistant will identify the “work” document folder as the target object of the user request and confine the search for the requested “lab report” document within the “work” document folder.

Although the exemplary interfaces in FIGS. 4A-4F above are described with respect to a device having a touch screen 246, and the contact 410 of the gesture input is between the touch screen 246 and the user's finger, a person skilled in the art would recognize that the same interfaces and interactions are, optionally, provided through a non-touch-sensitive display screen and a gesture input on a touch-sensitive surface (e.g., a touchpad) separate from the display screen. The location of the contact between the user's finger and the touch-sensitive surface is correlated with the location shown on the display screen, e.g., as optionally indicated by a pointer cursor shown on the display screen. Movement of a contact on the touch-sensitive surface is mapped to movement of the pointer cursor on the display screen. For example, FIG. 4G shows gradual formation of the iconic representation 416 of the digital assistant on a display (e.g., display 270) and activation of the digital assistant on a user device in response to a touch-based input gesture detected on a touch-sensitive surface 268 (e.g., a touchpad) of the user device. The current location of a cursor pointer 426 on the display 270 indicates the current location of the contact 410 between the user's finger and the touch-sensitive surface 268.

FIGS. 4A-4G are merely illustrative of the user interfaces and interactions for activating a digital assistant using a touch-based gesture. More details regarding the process for activating a digital assistant in response to a touch-based gesture are provided in FIG. 8 and accompanying descriptions.

Disambiguating between Dictation and Command Inputs:

In some embodiments, a digital assistant is configured to receive a user's speech input, convert the speech input to text, infer user intent from the text (and context information), and perform an action according to the inferred user intent. Sometimes, a device that provides voice-driven digital assistant services also provides a dictation service. During dictation, the user's speech input is converted to text, and the text is entered in a text input area of the user interface. In many cases, the user does not require the digital assistant to analyze the text entered using dictation, or to perform any action with respect to any intent expressed in the text. Therefore, it is useful to have a mechanism for distinguishing speech input that is intended for dictation from speech input that is intended to be a command or request for the digital assistant. In other words, when the user wishes to use the dictation service only, corresponding text for the user's speech input is provided in a text input area of the user interface, and when the user wishes to provide a command or request to the digital assistant, the speech input is interpreted to infer a user intent and a requested task is performed for the user.

There are various ways that a user can invoke either a dictation mode or a command mode for the digital assistant on a user device. In some embodiments, the device provides the dictation function as part of the digital assistant service. In other words, while the digital assistant is active, the user explicitly provides a speech input (e.g., “start dictation” and “stop dictation”) to start and stop the dictation function. The drawback of this approach is that the digital assistant has to capture and interpret each speech input provided by the user (even those speech inputs intended for dictation) in order to determine when to start and/or stop the dictation functionality.

In some embodiments, the device starts in a command mode by default, and treats all speech input as input for the digital assistant by default. In such embodiments, the device includes a dedicated virtual or hardware key for starting and stopping the dictation functionality while the device is in the command mode. The dedicated virtual or hardware key serves to temporarily suspend the command mode, and takes over the speech input channel for dictation purpose only. In some embodiments, the device enters and remains in the dictation mode while the user presses and holds the dedicated virtual or hardware key. In some embodiments, the device enters the dictation mode when the user presses the dedicated hardware key once to start the dictation mode, and returns to the command mode when the user presses the dedicated virtual or hardware key for a second time to exit the dictation mode.

In some embodiments, the device includes different hardware keys or recognizes different gestures (or key combinations) for respectively invoking the dictation mode or the command mode for the digital assistant on the user device. The drawback of this approach is that the user has to remember the special keyboard combinations or gestures for both the dictation mode and the command mode, and take the extra step to enter those keyboard combinations or gestures each time the user wishes to use the dictation or the digital assistant functions.

In some embodiments, the user device includes a dedicated virtual or hardware key for opening a speech input channel of the device. When the device detects that the user has pressed the dedicated virtual or hardware key, the device opens the speech input channel to capture subsequent speech input from the user. In some embodiments, the device (or a server of the device) determines whether a captured speech input is intended for dictation or the digital assistant based on whether a current input focus of the graphical user interface displayed on the device is within or outside of a text input area.

In some embodiments, the device (or a server of the device) makes the determination regarding whether or not a current input focus of the graphical user interface is within or outside of a text input area when the speech input channel is opened in response to the user pressing the dedicated virtual or hardware key. For example, if the user presses the dedicated virtual or hardware key while the input focus of the graphical user interface is within a text input area, the device opens the speech input channel and enters the dictation mode; and a subsequent speech input is treated as an input intended for dictation. Alternatively, if the user presses the dedicated virtual or hardware key while the input focus of the graphical user interface is not within any text input area, the device opens the speech input channel and enters the command mode; and a subsequent speech input is treated as an input intended for the digital assistant.

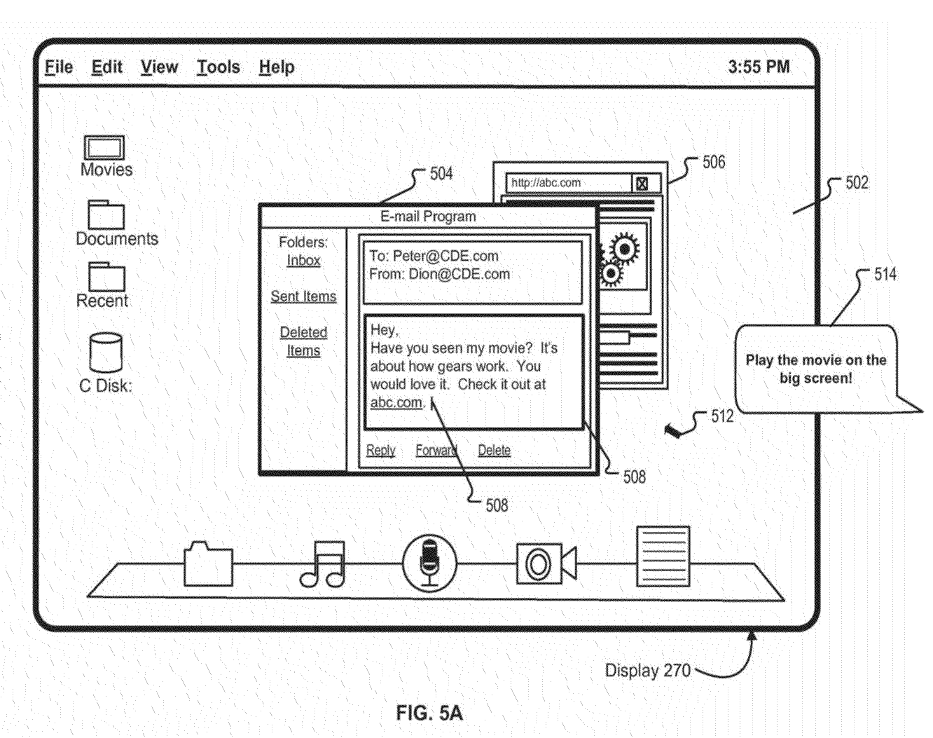

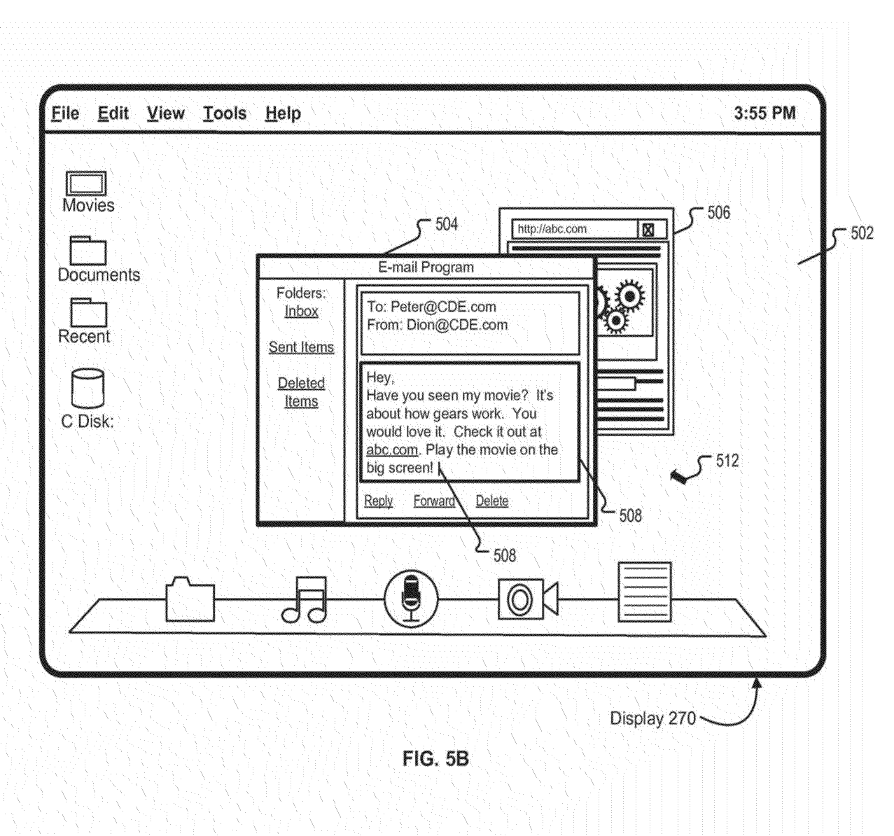

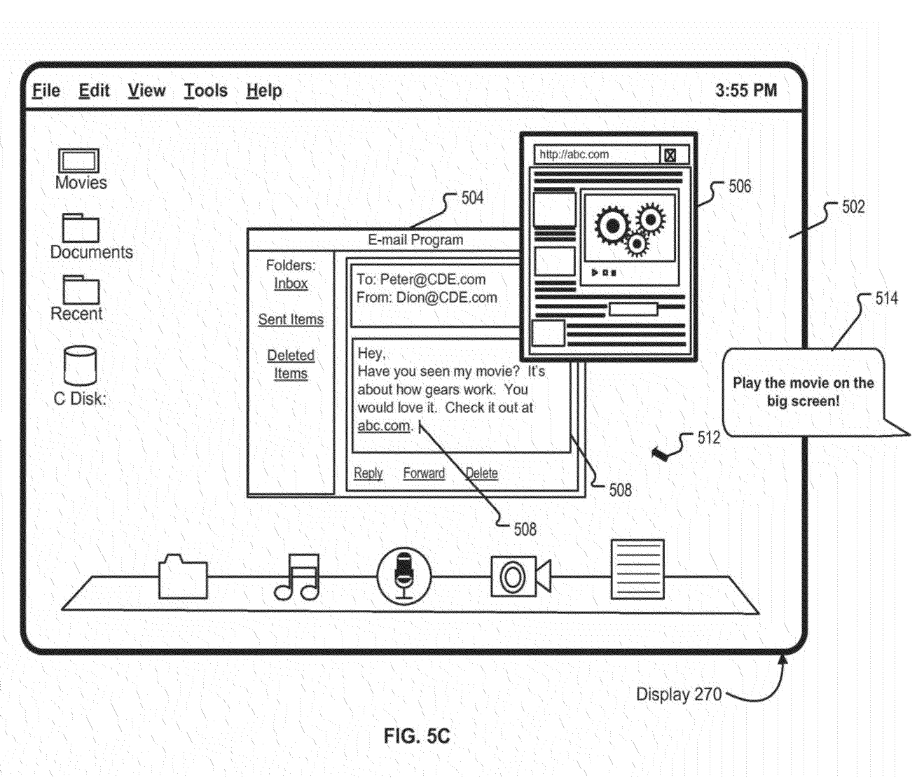

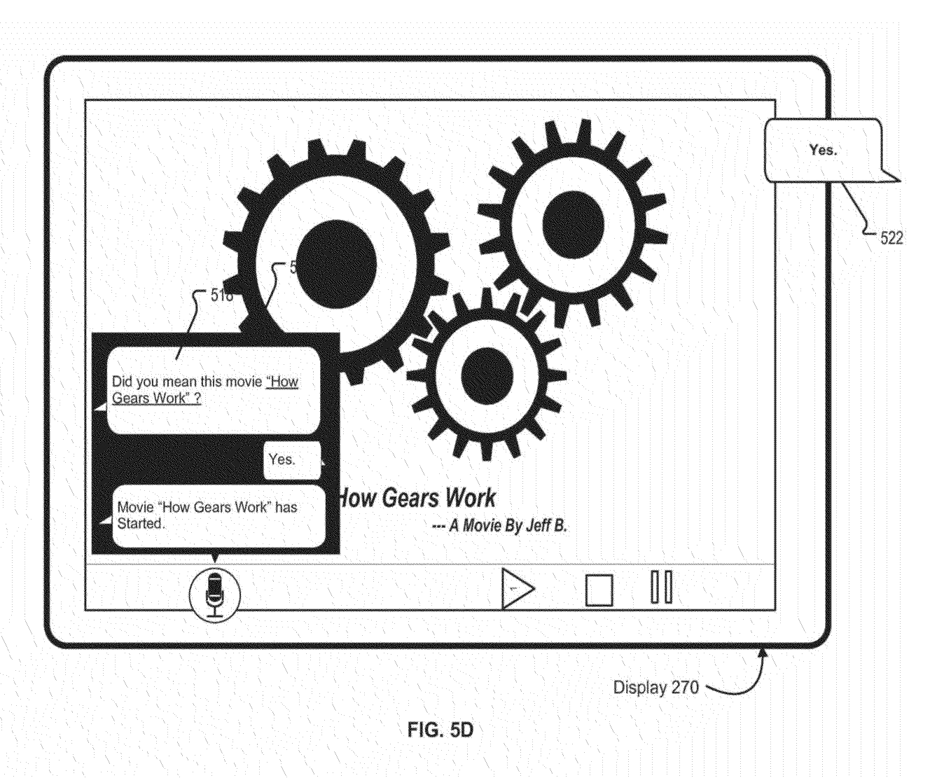

FIGS. 5A-5D illustrate that, the user device receives a command to invoke the speech service; in response to receiving the command: the user device determines whether an input focus of the user device is in a text input area shown on a display of the user device. Upon determining that the that the input focus of the user device is in a text input area displayed on the user device, the user device, automatically without human intervention, invokes a dictation mode to convert a speech input to a text input for entry into the text input area; and upon determining that the current input focus of the user device is not in any text input area displayed on the user device, the user device, automatically without human intervention, invokes a command mode to determine a user intent expressed in the speech input. In some embodiments, the device treats the received speech input as the command to invoke speech service without first processing the speech input to determine its meaning. In accordance with the embodiments that automatically disambiguates speech inputs for dictation and command, the user does not have to take the extra step to explicitly start the dictation mode each time the user wishes to enter the dictation mode.

As shown in FIG. 5A, an open window 504 for an email editor is shown on a desktop interface 502. Behind the email editor window 504 is a web browser window 506. The user has been typing a draft email message in the email editor window 504, and a blinking text cursor 508 indicating the current input focus of the user interface is located inside the text input panel 510 at the end of the partially completed body of the draft email message.

In some embodiments, a pointer cursor 512 is also shown in desktop interface 502. The pointer cursor 512 optionally moves with a mouse or a finger contact on a touchpad without moving the input focus of the graphical user interface from the text input area 510. Only when a context switching input (e.g., a mouse click or tap gesture detected outside of the text input area 510) is received does the input focus move. In some embodiments, when the user interface 502 is displayed on a touch-sensitive display screen (e.g., touch screen 246), no pointer cursor is shown, and the input focus is, optionally, taken away from the text input area 510 to another user interface object (e.g., another window, icon, or the desktop) in the user interface 502 when a touch input (e.g., a tap gesture) is received outside of the text input area 510 on the touch-sensitive display screen.

As shown in FIG. 5A, the device receives a speech input 514 (e.g., “Play the movie on the big screen!”) from a user while the current input focus of the user interface is within the text input area 510 of the email editor window 504. The device determines that the current input focus is in a text input area, and treats the received speech input 514 as an input for dictation.

In some embodiments, before the user provides the speech input 514, if the speech input channel of the device is not already open, the user optionally presses a dedicated virtual or hardware key to open the speech input channel before providing the speech input 514. In some embodiments, the device activates the dictation mode before any speech input is received. For example, in some embodiments, the device proceeds to activate the speech input channel for dictation mode in response to detecting invocation of the dedicated virtual or hardware key while the current input focus is in the text input area 510. When the speech input 514 is subsequently received through the speech input channel, the speech input is treated as an input for dictation.

Once the device has both activated the dictation mode and received the speech input 514, the device (or the server thereof) converts the speech input 514 to text through a speech-to-text module. The device then inserts the text into the text input area 510 at the insertion point indicated by the text input cursor 508, as shown in FIG. 5B. After the text is entered into the text input area 510, the text input cursor 508 remains within the text input area 510, and the input focus remains with the text input area 510. If additional speech input is received by the device, the additional speech input is converted to text and entered into the text input area 510 by default, until the input focus is explicitly taken out of the text input area 510 or if the dictation mode is suspended in response to other triggers (e.g., receipt of a escape input for toggling into the command mode).

In some embodiments, the default behavior for selecting either the dictation mode or the command mode is further implemented with an escape key to switch out of the currently selected mode. In some embodiments, when the device is in the dictation mode, the user can press and hold the escape key (without changing the current input focus from the text input area 510) to temporarily suspend the dictation mode and provide a speech input for the digital assistant. When the user releases the escape key, the dictation mode continues and the subsequent speech input is entered as text in the text input area. The escape key is a convenient way to access the digital assistant through a simple instruction during an extended dictation session. For example, while dictating a lengthy email message, the user optionally uses the escape key to ask the digital assistant to perform a secondary task (e.g., searching for address of a contact, or some other information) that would aid the primary task (e.g., drafting the email through dictation).

In some embodiments, the escape key is a toggle switch. In such embodiments, after the user presses the key to switch from a current mode (e.g., the dictation mode) to the other mode (e.g., the command mode), the user does not have to hold the escape key to remain in the second mode (e.g., the command mode). Pressing the key again returns the device back into the initial mode (e.g., the dictation mode).

FIGS. 5C-5D illustrate a scenario where a speech input is received while the input focus is not within any text input area in the user interface. As shown in FIG. 5C, the browser window 506 has replaced the email editor window 504 as the active window of the graphical user interface 502 and has gained the current input focus of the user interface. For example, by clicking or tapping on the browser window 506, the user can bring the browser window 506 into the foreground and move current input focus onto the browser window 506.

As shown in FIG. 5C, while the browser window 506 is the current active window, and the current input focus is not within any text input area of the user interface 502, the user provides a speech input 514 “Play the movie on the big screen.” When the device determines that the current input focus is not within any text input area of the user interface 502, the device treats the speech input as a command intended for the digital assistant.

In some embodiments, before providing the speech input 514, if the speech input channel of the device has not been opened already, the user optionally presses a dedicated virtual or hardware key to open the speech input channel before providing the speech input 514. In some embodiments, the device activates the command mode in response to the invocation of before any speech input is received. For example, in some embodiments, the device proceeds to activate the speech input channel for the command mode in response to detecting invocation of the dedicated virtual or hardware key while the current input focus is not within any text input area in the user interface 502. When the speech input 514 is subsequently received through the speech input channel, the speech input is treated as an input for the digital assistant.

In some embodiments, once the device has both started the command mode for the digital assistant and received the speech input 514, the device optionally forwards the speech input 514 to a server (e.g., server system 108) of the digital assistant for further processing (e.g., intent inference). For example, in some embodiments, based on the speech input 514, the server portion of the digital assistant infers that the user has requested a task for “playing a movie,” and that a parameter for the task is “full screen mode”. In some embodiments, the content of the current browser window 506 is provided to the server portion of the digital assistant as context information for the speech input 514. Based on the content of the browser window 506, the digital assistant is able to disambiguate that the phrase “the movie” in the speech input 516 refers to a movie available on the webpage currently presented in the browser window 506. In some embodiments, the device performs the intent inference from the speech input 514 without employing a remote server.

In some embodiments, when responding to the speech input 514 received from the user, the digital assistant invokes a dialogue module to provide a speech output to confirm which movie is to be played. As shown in FIG. 5D, the digital assistant provides a confirmation speech output 518 (e.g., “Did you mean this movie ‘How Gears Work?’”), where the name of the identified movie is provided in the confirmation speech output 518.

In some embodiments, a dialogue panel 520 is displayed in the user interface 502 to show the dialogue between the user and the digital assistant. As shown in FIG. 5D, the user has provided a confirmation speech input 522 (e.g., “Yes.”) in response to the confirmation request by the digital assistant. Upon receiving the user's confirmation, the digital assistant starts executing the requested task, namely, playing the video “How Gears Work” in full screen mode, as shown in FIG. 5D. In some embodiments, the digital assistant provides a confirmation that the movie is playing (e.g., in the dialogue panel 520 and/or as a speech output) before the movie is started in full screen mode. In some embodiments, the digital assistant remains active and continues to listen in the background for any subsequent speech input from the user while the movie is played in the full screen mode.

In some embodiments, the default behavior for selecting either the dictation mode or the command mode is further implemented with an escape key (e.g., the “Esc” key or any other designated key on a keyboard), such that when the device is in the command mode, the user can press and hold the escape key to temporarily suspend the command mode and provide a speech input for dictation. When the user releases the escape key, the command mode continues and the subsequent speech input is processed to infer its corresponding user intent. In some embodiments, while the device is in the temporary dictation mode, the speech input is entered into a text input field that was active immediately prior to the device entering the command mode.

In some embodiments, the escape key is a toggle switch. In such embodiments, after the user presses the key to switch from a current mode (e.g., the command mode) to the other mode (e.g., the dictation mode), the user does not have to hold the key to remain in the second mode (e.g., the dictation mode). Pressing the key again returns the device back into the initial mode (e.g., the command mode).

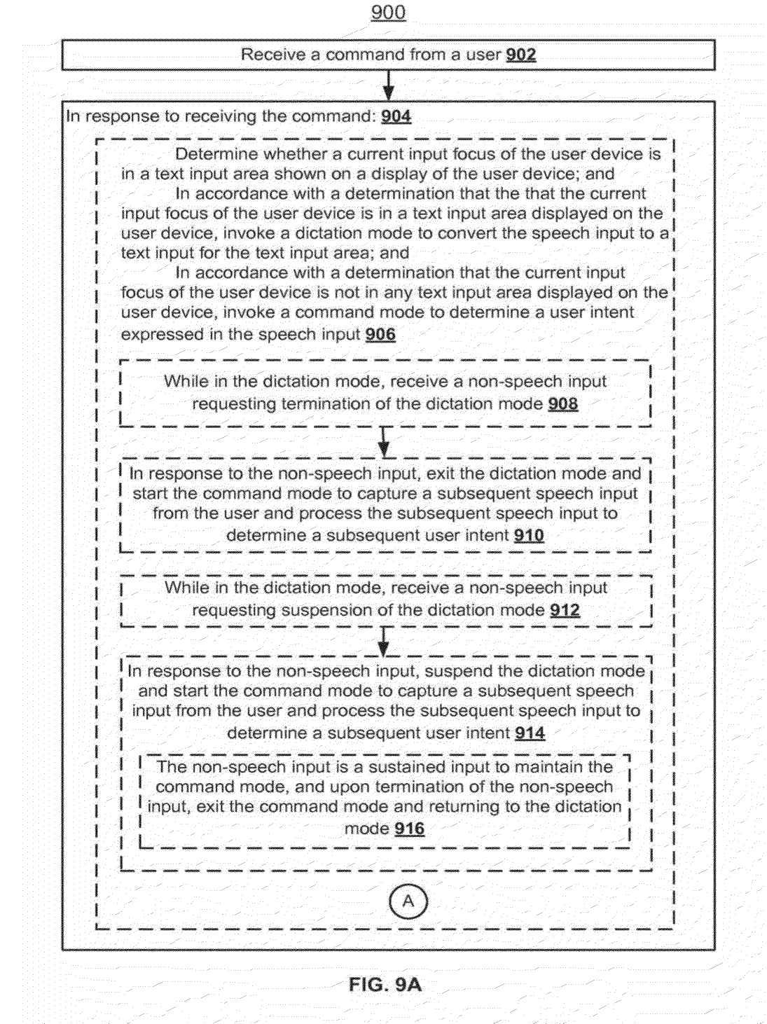

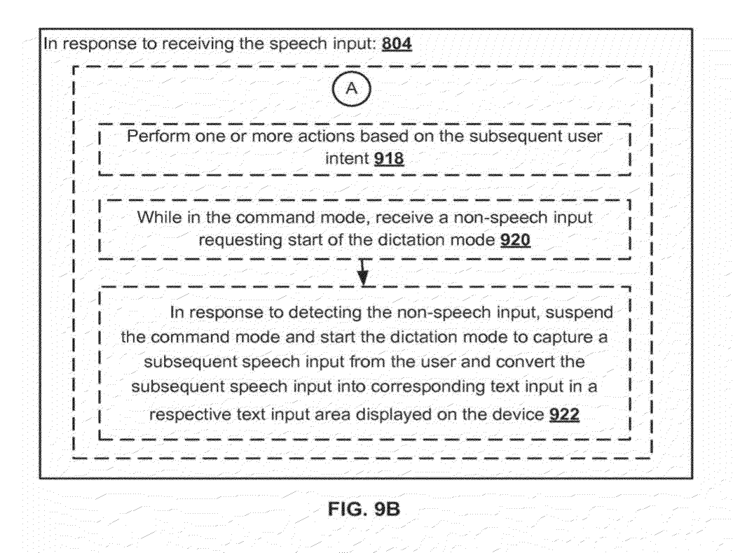

FIGS. 5A-5D are merely illustrative of the user interfaces and interactions for selective invoking either a dictation mode or a command mode for a digital assistant and/or disambiguating between inputs intended for dictation or the digital assistant, based on whether the current input focus of the graphical user interface is within a text input area. More details regarding the process for selectively invoking either a dictation mode or a command mode for a digital assistant and/or disambiguating between inputs intended for dictation or commands for the digital assistant are provided in FIGS. 9A-9B and accompanying descriptions.

Dragging and Dropping Objects onto the Digital Assistant Icon:

In some embodiments, the device presents an iconic representation of the digital assistant on the graphical user interface, e.g., in a dock for applications or in a designated area on the desktop. In some embodiments, the device allows the user to drag and drop one or more objects onto the iconic representation of the digital assistant to perform one or more user's specified tasks with respect to those objects. In some embodiments, the device allows the user to provide a natural language speech or text input to specify the task(s) to be performed with respect to the dropped objects. By allowing the user to drag and drop objects onto the iconic representation of the digital assistant, the device provides an easier and more efficient way for the user to specify his or her request. For example, some implementations allows the user to locate the target objects of the requested task over an extended period of time and/or in several batches, rather than having to identify all of them at the same time. In addition, some embodiments do not require the user to explicitly identify the target objects using their names or identifiers (e.g., filenames) in a speech input. Furthermore, some embodiments do not require the user to have specified all of the target objects of a requested action at the time of entering the task request (e.g., via a speech or text input). Thus, the interactions between the user and the digital assistant are more streamlined, less constrained, and intuitive.

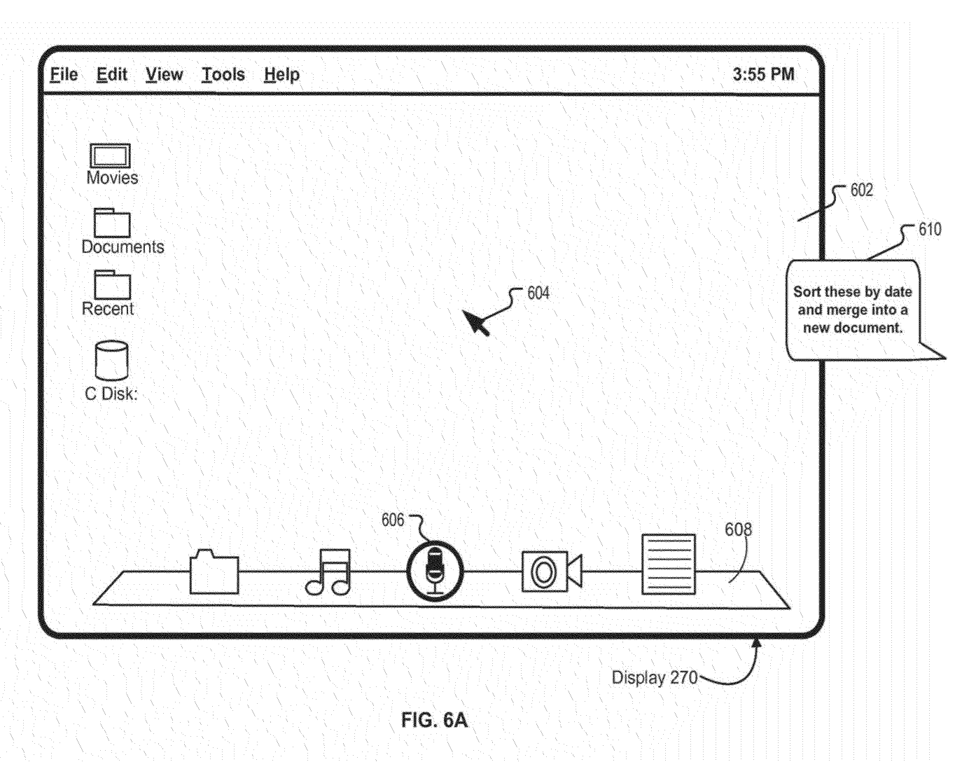

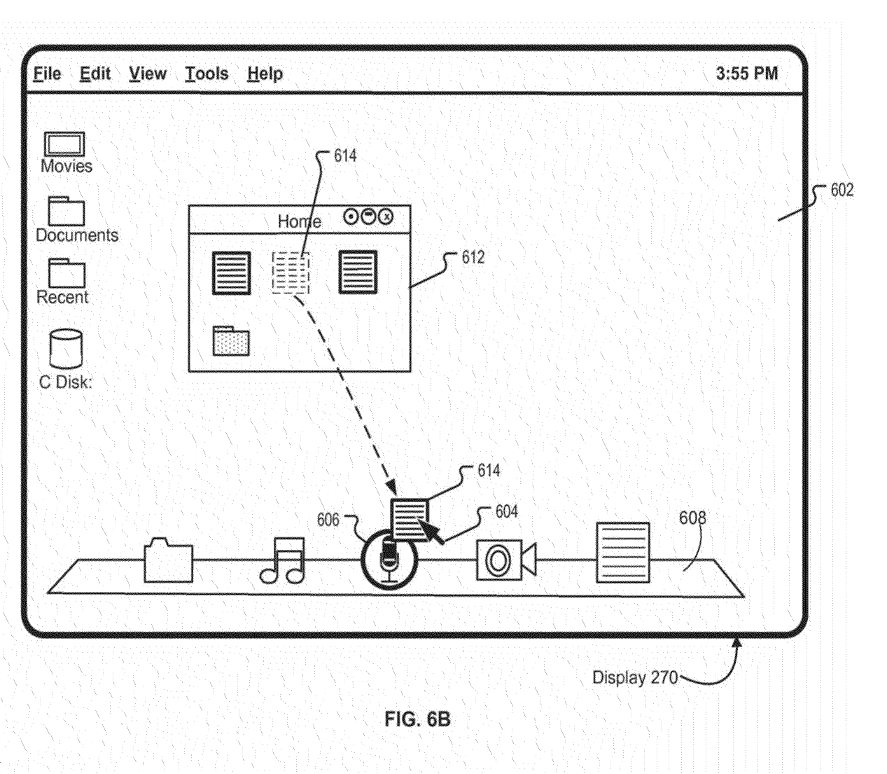

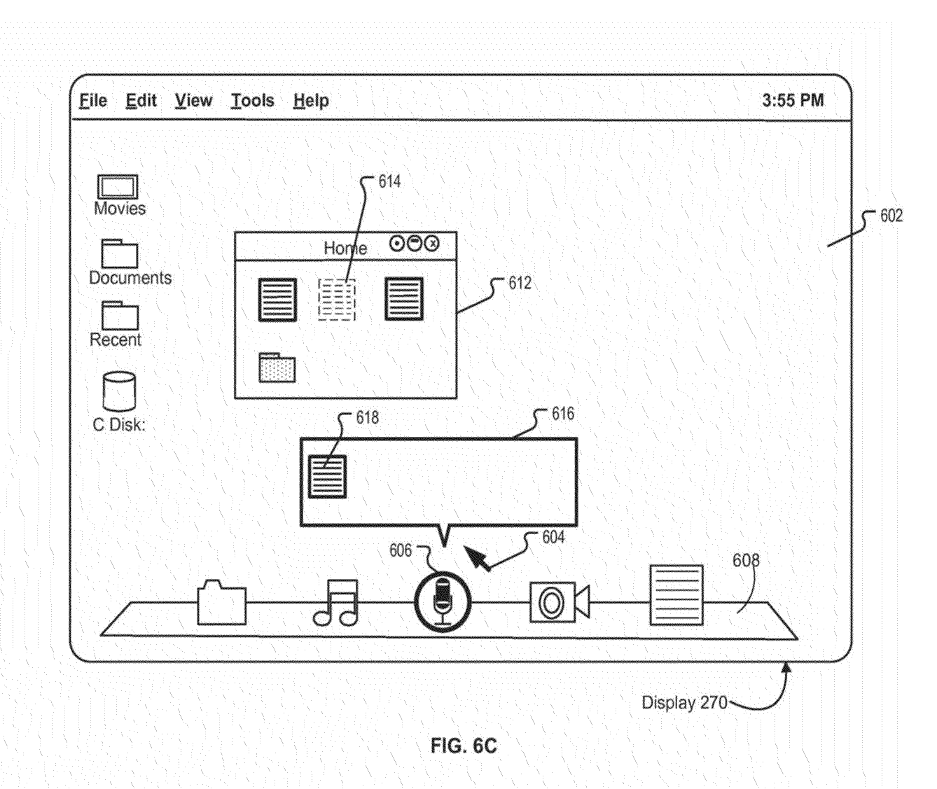

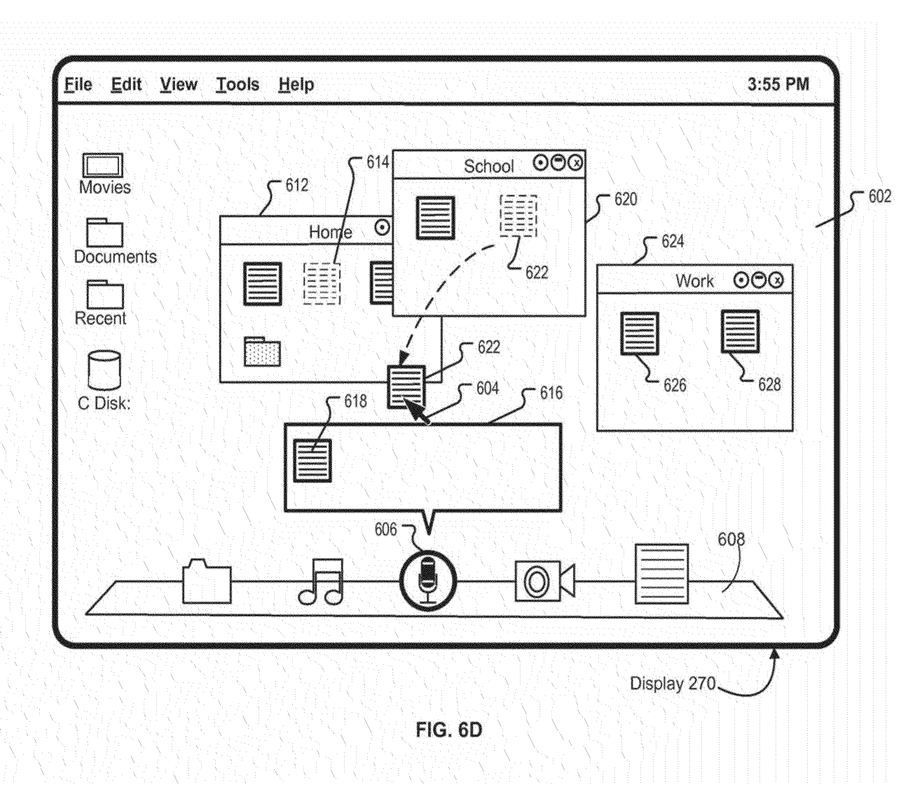

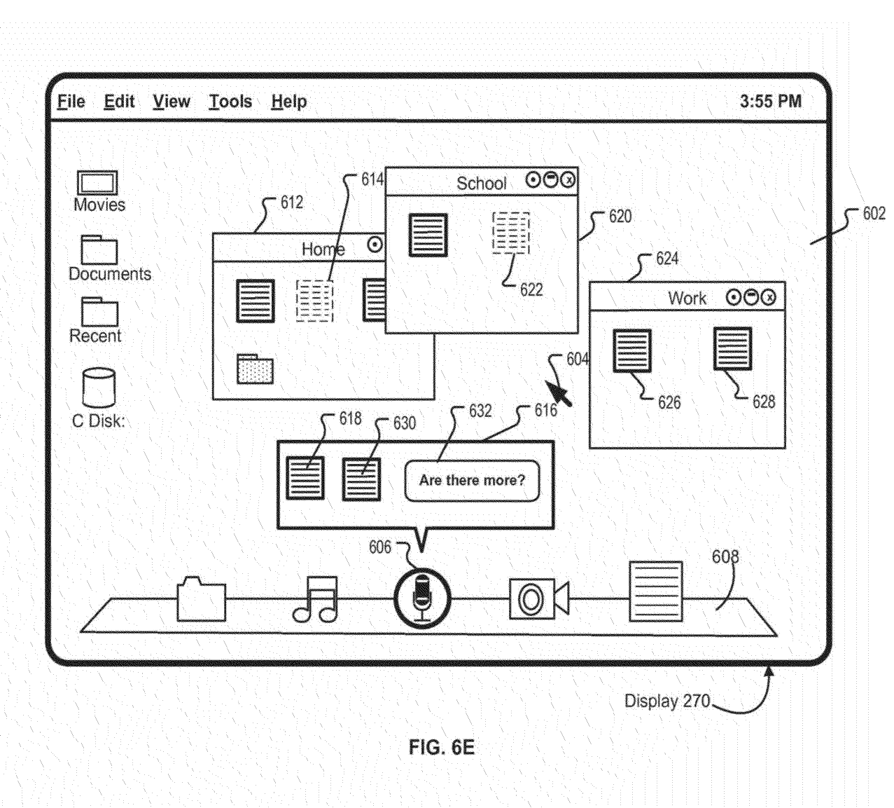

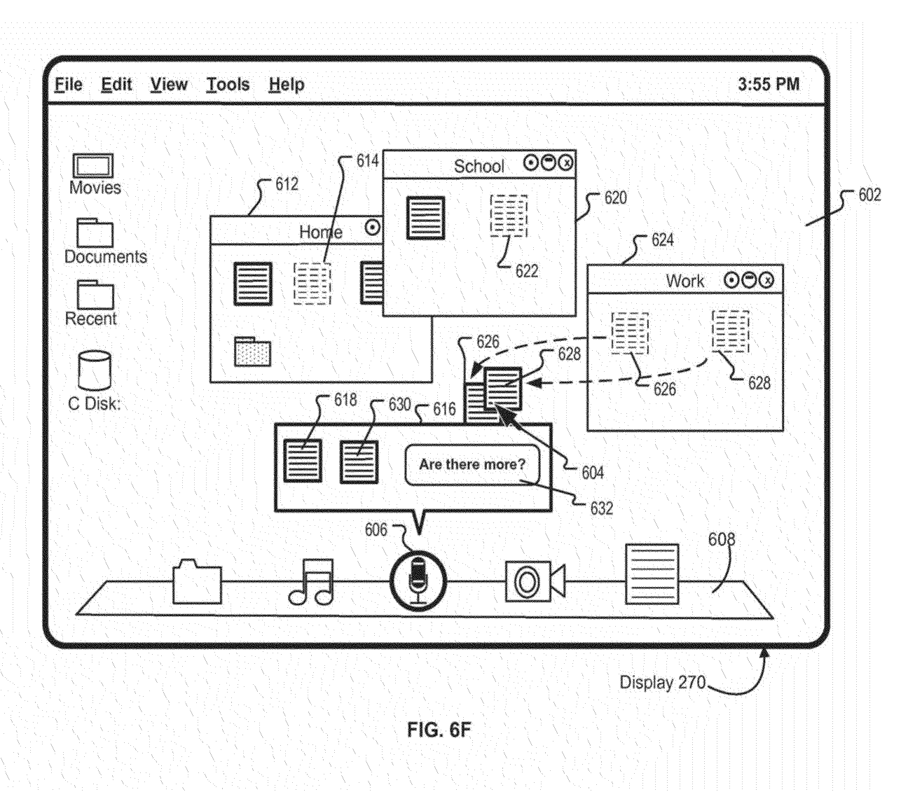

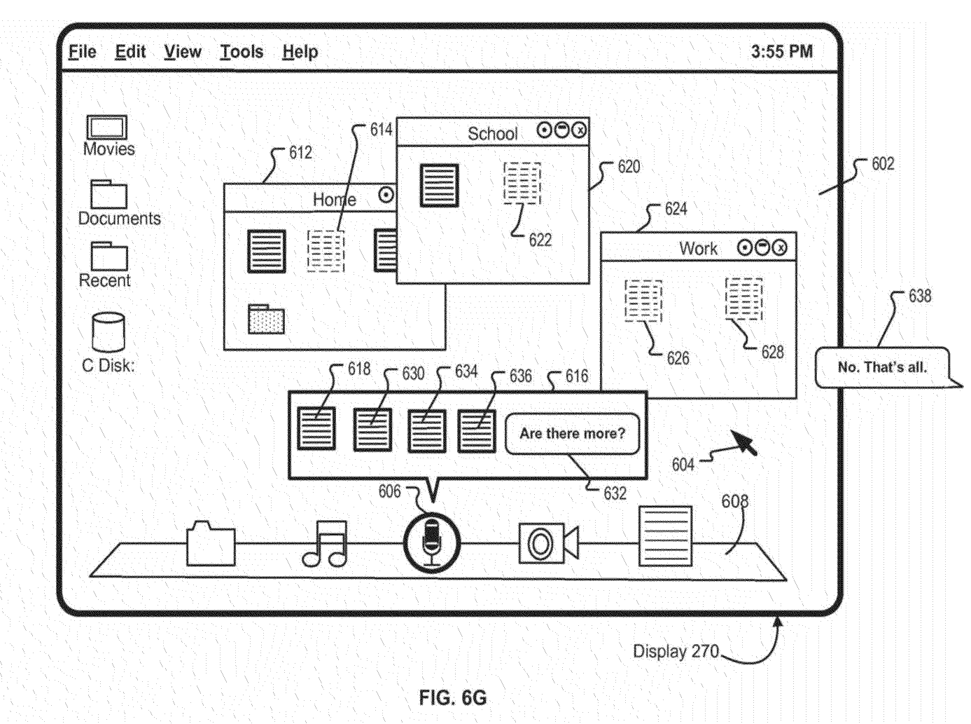

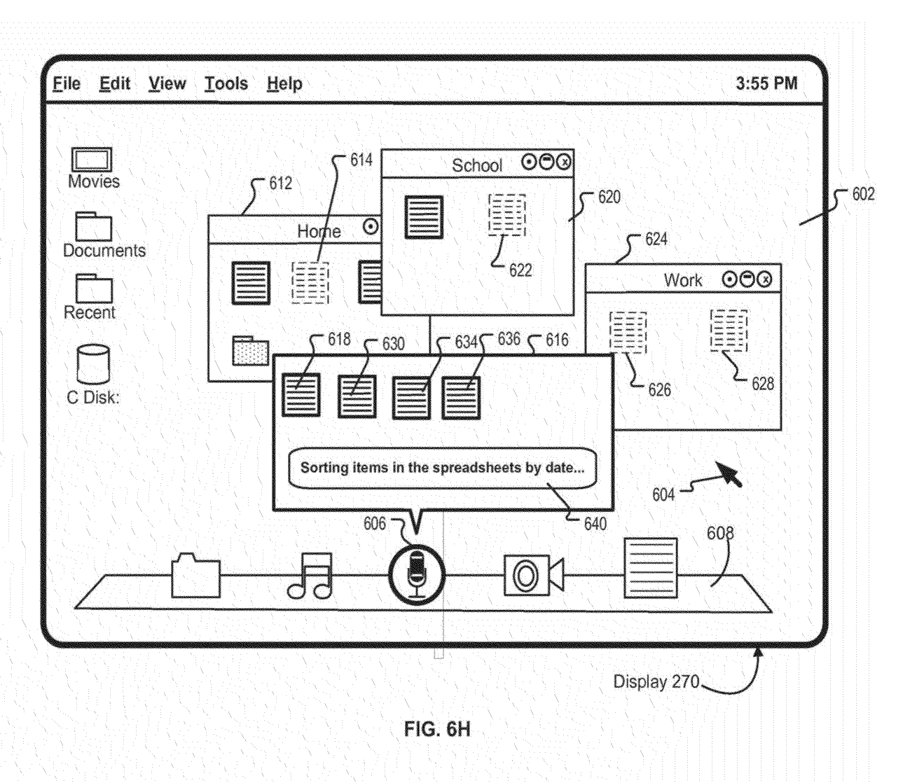

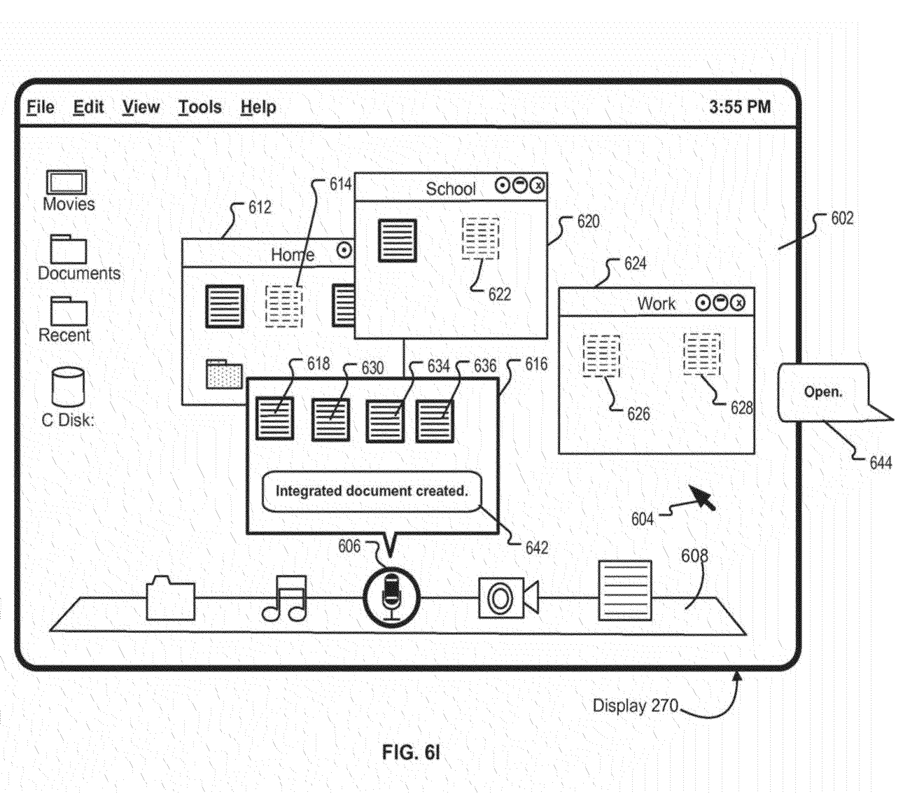

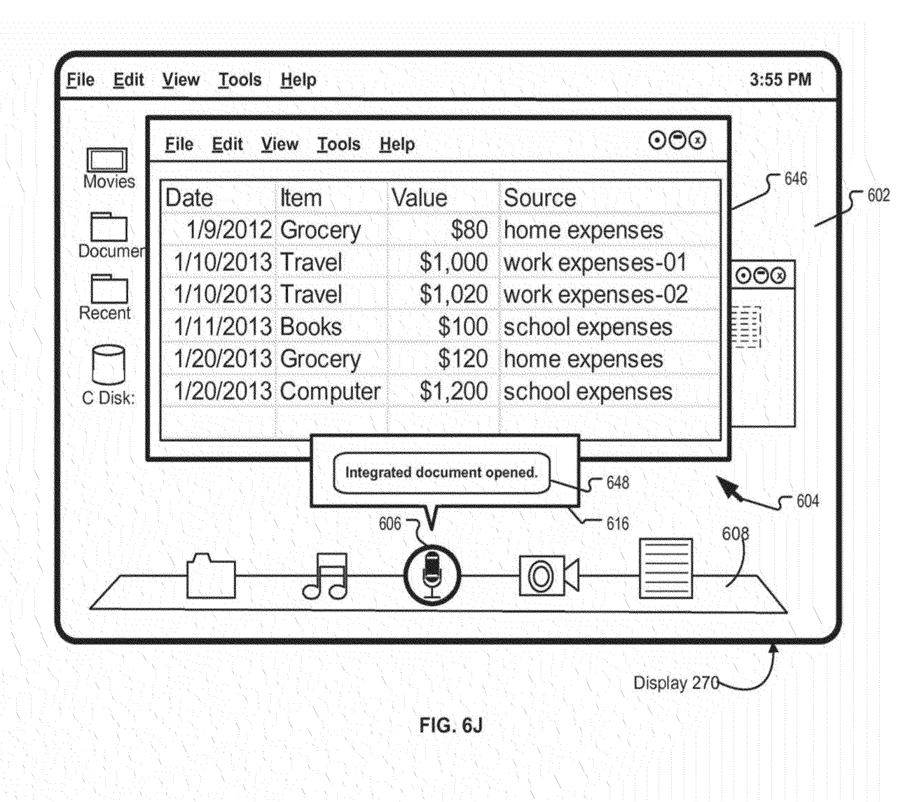

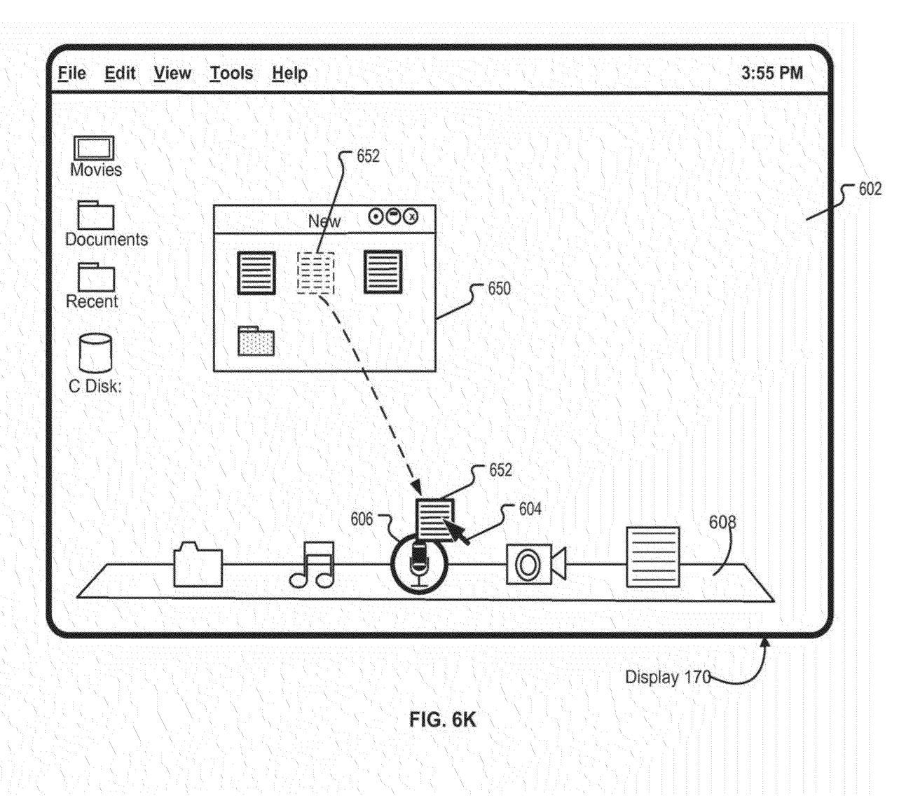

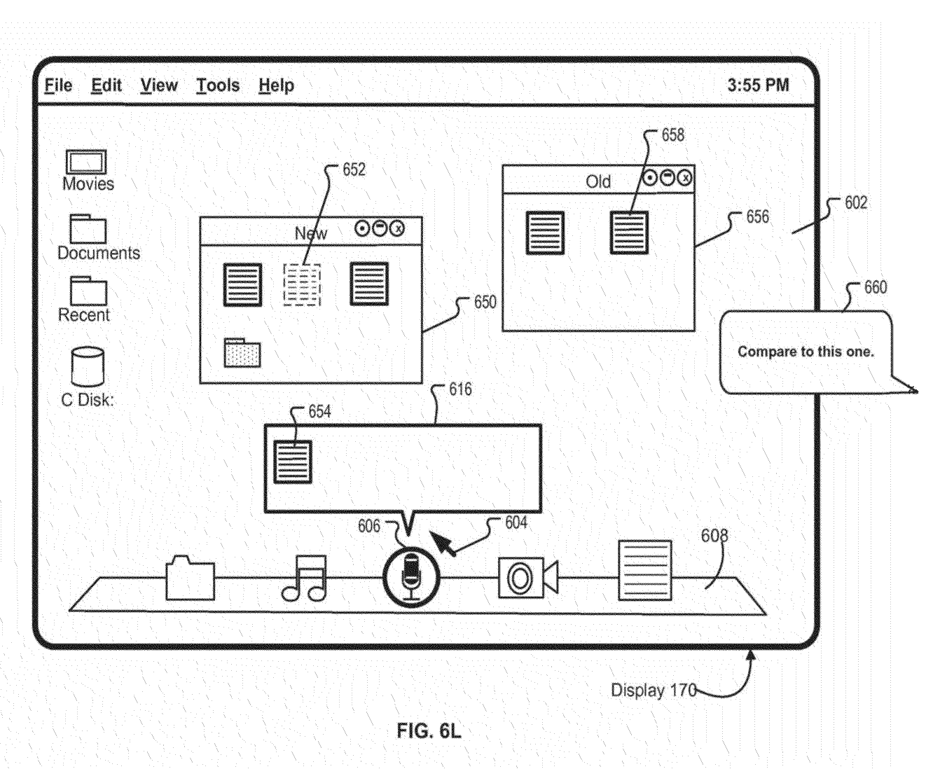

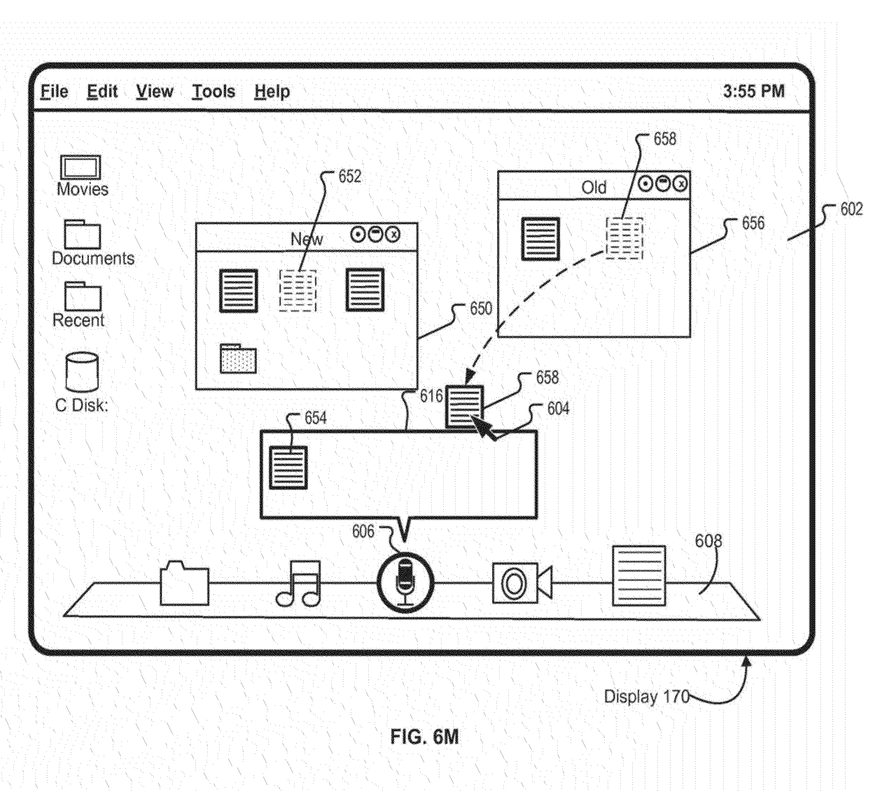

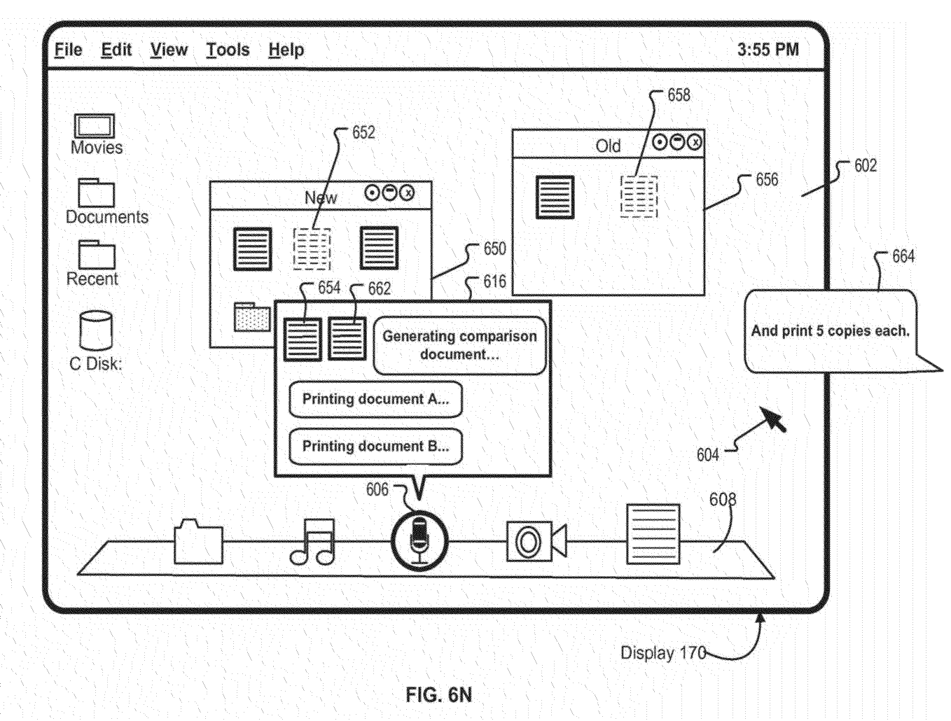

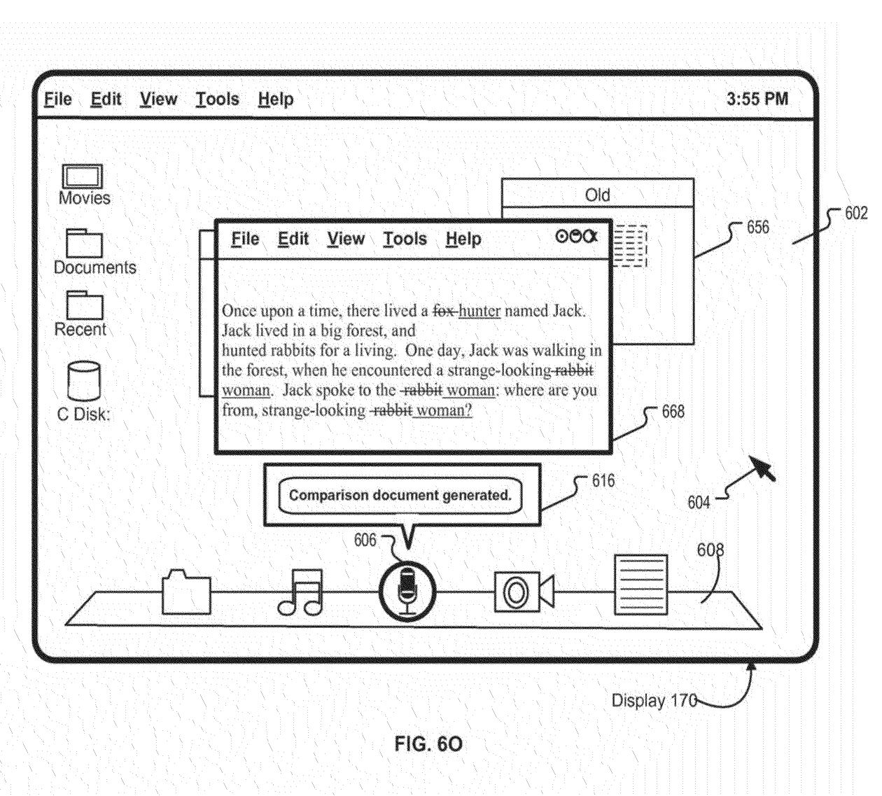

FIGS. 6A-6O illustrate exemplary user interfaces and interactions for allowing a user to drag and drop one or more objects onto the iconic representation of the digital assistant as part of a task request to the digital assistant. The example user interfaces are optionally implemented on a user device (e.g., device 104 in FIG. 1) having a display (e.g., touch screen 246 in FIG. 2B, or display 270 in FIG. 2C) for presenting a graphical user interface and one or more input devices for dragging and dropping an object on the graphical user interface and for receiving a speech and/or text input specifying a task request.

As shown in FIG. 6A, an exemplary graphical user interface 602 (e.g., a desktop) is displayed on a display screen (e.g., display 270). An iconic representation 606 of a digital assistant is displayed in a dock 608 on the user interface 602. In some embodiments, a cursor pointer 604 is also shown in the graphical user interface 602, and the user uses the cursor pointer 604 to select and drag an object of interest on the graphical user interface 602. In some embodiments, the cursor pointer is controlled by a pointing device such as a mouse or a finger on a touchpad coupled to the device. In some embodiments, the display is a touch-sensitive display screen, and the user optionally selects and drags an object of interest by making a contact on the touch-sensitive display and providing the required gesture input for object selection and dragging.

In some embodiments, while presented on the dock 608, the digital assistant remains active and continues to listen for speech input from the user. In some embodiments, while presented on the dock 608, the digital assistant is in a suspended state, and the user optionally presses a predetermined virtual or hardware key to activate the digital assistant before providing any speech input.

In FIG. 6A, while the digital assistant is active and the speech input channel of the digital assistant is open (e.g., as indicated by a different appearance of the iconic representation 606 of the digital assistant in the dock 608), the user provides a speech input 610 (e.g., “Sort these by dates and merge into one document.” The device captures the speech input 610, processes the speech input 610 and determines that the speech input 610 is a task request for “sorting by date” and “merging.” In some embodiments (not shown in FIG. 6A), the digital assistant, when activated, optionally provides a dialogue panel in the user interface 602. The user, instead of providing a speech input 610, optionally, provides the task request using a text input (e.g., “Sort these by dates and merge into one document.”) in the dialogue panel.

In some embodiments, in addition to determining a requested task from the user's speech or text input, the device further determines that performance of the requested task requires at least two target objects to be specified. In some embodiments, the device waits for additional input from the user to specify the required target objects before providing a response. In some embodiments, the device waits for a predetermined amount of time for the additional input before providing a prompt for the additional input.

In this example scenario, the user provided the speech input 610 before having dropped any object onto the iconic representation 606 of the digital assistant. As shown in FIG. 6B, while the device is waiting for the additional input from the user to specify the target objects of the requested task, the user opens a “home” folder 612 on the user interface 602, and drags and drops a first object (e.g., a “home expenses” spreadsheet document 614 in the “home” folder 612) onto the iconic representation 606 of the digital assistant. Although FIG. 6A shows that the “home expenses” spreadsheet document 614 is displayed on the user interface 602 after the user has provided the speech input 610, this needs not be required. In some embodiments, the user optionally provides the speech input after having opened the “home folder” 612 to reveal the “home expenses” spreadsheet document 614.

As shown in FIG. 6C, in response to the user dropping the first object 614 onto the iconic representation 606 of the digital assistant, the device displays a dialogue panel 616 in proximity to the iconic representation 606 of the digital assistant, and displays an iconic representation 618 of the first object 614 in the dialogue panel 616. In some embodiments, the device also displays an identifier (e.g., a filename) of the first object 614 that has been dropped onto the iconic representation 606 of the digital assistant. In some embodiments, the dialogue panel 616 is displayed at a designated location on the display, e.g., on the left side or the right side of the display screen.

As explained earlier, in some embodiments, the device processes the speech input and determines a minimum number of target objects required for the request task, and waits for a predetermined amount of time for further input from the user to specify the required number of target objects before providing a prompt for the additional input. In this example, the minimum number of target objects required by the requested task (e.g., “merge”) is two. Therefore, after the device has received the first required target object (e.g., the “home expenses” spreadsheet document 614), the device determines that at least one additional target object is required to carry out the requested task (e.g., merge). Upon such determination, the device waits for a predetermined amount of time for the additional input before providing a prompt for the additional input.

As shown in FIG. 6D, while the digital assistant is waiting for the additional input from the user, the user has opened two more folders (e.g., a “school” folder 620 and a “work” folder 624) in the user interface 602. The user drags and drops a second object (e.g., a “school expenses” spreadsheet document 622 in the “school” folder 620) onto the iconic representation 606 of the digital assistant. As shown in FIG. 6E, the device, after receiving the second object 622, displays an iconic representation 630 of the second object 622 in the dialogue panel 616. The digital assistant determines that the minimum number of target objects required for the requested task has been received at this point, and provides a prompt (e.g., “Are there more?”) asking the user whether there are any additional target objects. In some embodiments, the prompt is provided as a text output 632 shown in the dialogue panel 616. In some embodiments, the prompt is a speech output provided by the digital assistant.

As shown in FIG. 6F, the user then drags and drops two more objects (e.g., a “work-expenses-01” spreadsheet document 626 and a “work-expenses-02” spreadsheet document 628) from the “work” folder 624 onto the iconic representation 606 of the digital assistant. In response, the device displays respective iconic representations 634 and 636 of the two additional objects 626 and 628 in the dialogue panel 616, as shown in FIG. 6G.

As shown in FIG. 6G, in some embodiments, the prompt asking the user whether there are any additional target objects is maintained in the dialogue panel 616 while the user drops additional objects onto the iconic representation 606 of the digital assistant. When the user has finished dropping all of the desired target objects, the user replies to the digital assistant indicating that all of the target objects have been specified. In some embodiments, the user provides a speech input 638 (e.g., “No. That's all.”). In some embodiments, the user types into the dialogue panel with a reply (e.g., “No.”).

In response to having received all of the target objects 614, 622, 626, and 628 (e.g., spreadsheet documents “home expenses,” “school expenses,” “work-expenses-01” and “work-expenses-02”) of the requested task (e.g., “sort” and “merge”), the digital assistant proceeds to perform the requested task. In some embodiments, the device provides a status update 640 on the task being performed in the dialogue panel 610. As shown in FIG. 6H, the digital assistant has determined that the target objects dropped onto the iconic representation 606 of the digital assistant are spreadsheet documents, and the command “sort by date” is a function that can be applied to items in the spreadsheet documents. Based on such a determination, the digital assistant proceeds to sort the items in all of the specified spreadsheet documents by date. In some embodiments, the digital assistant performs a secondary sort based on the order by which the target objects (e.g., the spreadsheet documents) were dropped onto the iconic representation 606 of the digital assistant. For example, if two items from two of the spreadsheets have the same date, the item from the document that was received earlier has a higher order in the sort. In some embodiments, if two items from two different spreadsheets not only have the same date, but also are dropped at the same time (e.g., in a single group), the digital assistant performs a secondary sort based on the order by which the two spreadsheets were arranged in the group. For example, if the two items having the same date are from the documents “work-expenses-01” 626 and “work-expenses-02” 628, respectively, and if documents in the “work” folder 624 were sorted by filename, then, the item from the “work-expenses-01” is given a higher order in the sort.

As shown in FIG. 6I, the sorting of the items in the spreadsheet documents by date have been completed, and the digital assistant proceeds to merge the sorted items into a single document, as requested. When the merging is completed, a status update 642 is provided in the dialogue panel 616. In response to seeing the status update 642, the user provides a second speech input 644 (e.g., “Open.”) to open the merged document. In some embodiments, the digital assistant optionally provides a control (e.g., a hyperlink or button) in the dialogue panel 616 for opening the merged document.

FIG. 6J shows that, in response to the user's request to open the merged document, the digital assistant displays the merged document in an application window 646 of a spreadsheet application. The user can proceed to save or edit the merged document in the spreadsheet application. In some embodiments, after the requested task has been completed, the digital assistant removes the iconic representations of the objects that have been dropped on the iconic representation 616 of the digital assistant. In some embodiments, the digital assistant requests a confirmation from the user before removing the objects from the dialogue panel 616.

FIGS. 6A-6J illustrate a scenario in which the user first provided a task request, and then specified the target objects of the task request by dragging and dropping the target objects onto an iconic representation of the digital assistant. FIGS. 6K-6O illustrate another scenario in which the user has dragged and dropped at least one target object onto the iconic representation of the digital assistant before the user provided the task request.

As shown in FIG. 6K, a user has dragged a first document (e.g., document 652 in a “New” folder 650) onto the iconic representation 606 of the digital assistant before providing any speech input. In some embodiments, the digital assistant has been in a suspended state before the first object 652 is dragged and dropped onto the iconic representation 606, and in response to the first object 652 being dropped onto the iconic representation 606, the device activates the digital assistant from the suspended state. In some embodiments, when activating the digital assistant, the device displays a dialogue panel to accept user requests in a textual form. In some embodiments, the device also opens a speech input channel to listen for speech input from the user. In some embodiments, the iconic representation 606 of the digital assistant takes on a different appearance when activated.

FIG. 6L shows that once the user has dragged and dropped the first document 652 onto the iconic representation 606 of the digital assistant, the device displays an iconic representation 654 of the dropped document 652 in a dialogue panel 616. The digital assistant holds the iconic representation 654 of the first document 652 and waits for additional input from the user. In some embodiments, the device allows the user to drag and drop several objects before providing any text and/or speech input to specify the requested task.

FIG. 6L shows that, after the user has dragged and dropped at least one object (e.g., document 652) onto the iconic representation 606 of the digital assistant, the user provides a speech input 606 (“Compare to this.”). The digital assistant processes the speech input 606, and determines that the requested task is a “comparison” task requiring at least an “original” document and a “modified” document. The digital assistant further determines that the first object that has been dropped onto the iconic representation 602 is the “modified” document that is to be compared to an “original” document yet to be specified. Upon such a determination, the digital assistant waits for a predetermined amount of time before prompting the user for the “original” document. In the meantime, the user has opened a second folder (e.g., an “Old” folder 656) which contains a document 658.

As shown in FIG. 6M, while the digital assistant is waiting, the user drags and drops a second document (e.g., document 658 from the “Old” folder 656) onto the iconic representation 606 of the digital assistant. An iconic representation 662 of the second document 658 is also displayed in the dialogue panel 616 when the drop is completed, as shown in FIG. 6N. Once the second document has been dropped onto the iconic representation 606 of the digital assistant, the digital assistant determines that the required target objects (e.g., the “original” document and the “modified” document) for the requested task (e.g., “compare”) have both been provided by the user. Upon such a determination, the digital assistant proceeds to compare the first document 652 to the second document 658, as shown in FIG. 6N.

FIG. 6N also shows that, after the user has dropped the second document 658 onto the iconic representation 606 of the digital assistant, the user provides another speech input (e.g., “Print 5 copies each”). The digital assistant determines that the term “each” in the speech input refers to each of the two documents 652 and 658 that have been dropped onto the iconic representation 606 of the digital assistant, and proceeds to generate a print job for each of the documents, as shown in FIG. 6N. In some embodiments, the digital assistant also provides a status update in the dialogue panel 616 when the printing is completed or if error has been encountered during the printing.

FIG. 6O shows that the digital assistant has generated a new document showing the changes made in the first document 652 as compared to the second document 658. In some embodiments, the digital assistant displays the new document in a native application of the two specified source documents 652 and 658. In some embodiments, the digital assistant, optionally, removes the iconic representation of the two documents 652 and 658 from the dialogue panel 616 to indicate that they are no longer going to serve as target objects for subsequent task requests. In some embodiments, the digital assistant, optionally, asks the user whether to keep holding the two documents 652 and 658 for subsequent requests.

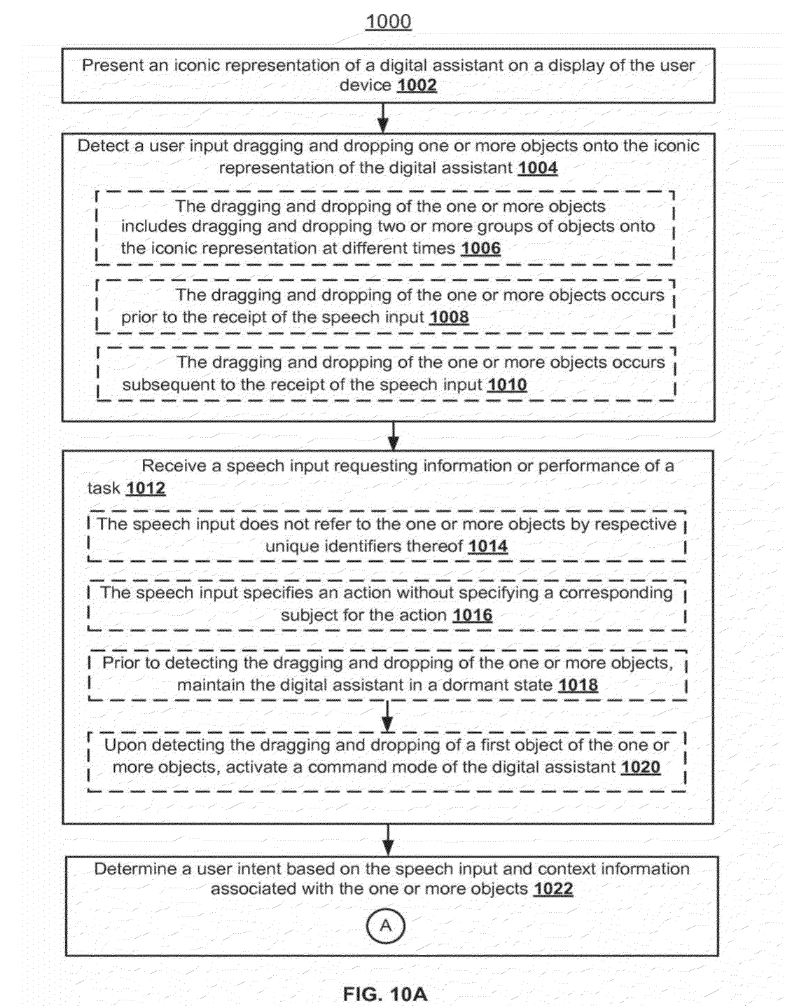

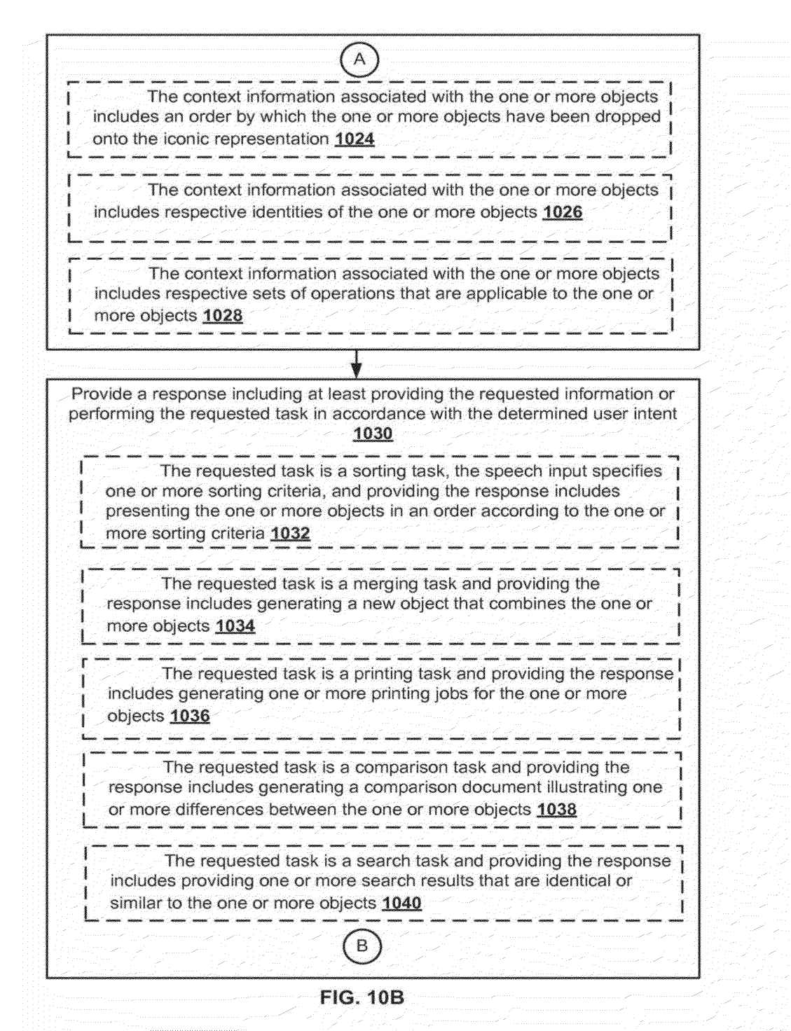

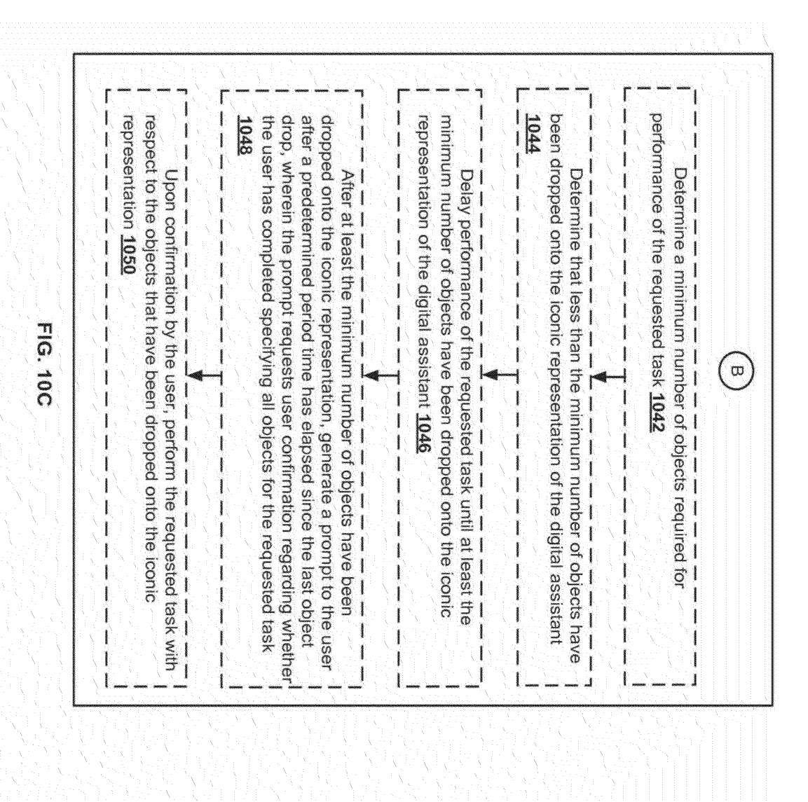

FIGS. 6A-6O are merely illustrative of the user interfaces and interactions for specifying one or more target objects of a user request to a digital assistant by dragging and dropping the target objects onto an iconic representation of the digital assistant. More details regarding the process for specifying one or more target objects of a user request to a digital assistant by dragging and dropping the target objects onto an iconic representation of the digital assistant are provided in FIGS. 10A-10C and accompanying descriptions.

### Using Digital Assistant as a Third Hand:

In some embodiments, when a user perform one or more tasks (e.g., Internet browsing, text editing, copy and pasting, creating or moving files and folders, etc.) on a device using one or more input devices (e.g., keyboard, mouse, touchpad, touch-sensitive display screen, etc.), visual feedback is provided in a graphical user interface (e.g., a desktop and/or one or more windows on the desktop) on a display of the device. The visual feedback echoes the received user input and/or illustrates the operations performed in response to the user input. Most modern operating systems allow the user to switch between different tasks by changing the input focus of the user interface between different user interface objects (e.g., application windows, icons, documents, etc.).

Being able to switch in and out of a current task allows the user to multi-task on the user device using the same input device(s). However, each task requires the user's input and attention, and constant context switching during the multi-tasking places a significant amount of cognitive burden on the user. Frequently, while the user is performing a primary task, he or she finds the need to perform one or more secondary tasks to support the continued performance and/or completion of the primary task. In such scenarios, it is advantageous to use a digital assistant to perform the secondary task or operation that would assist the user's primary task or operation, while not significantly distracting the user's attention from with the user's primary task or operation. The ability to utilize the digital assistant for a secondary task while the user is engaged in a primary task helps to reduce the amount of cognitive context switching that the user has to perform when performing a complex task involving access to multiple objects, documents, and/or applications.

In addition, sometimes, when a user input device (e.g., a mouse, or a touchpad) is already engaged in one operation (e.g., a dragging operation), the user cannot conveniently use the same input device for another operation (e.g., creating a drop target for the dragging operation). In such scenarios, while the user is using an input device (e.g., the keyboard and/or the mouse or touchpad) for a primary task (e.g., the dragging operation), it would be desirable to utilize the assistance of a digital assistant for the secondary task (e.g., creating the dropping target for the dragging operation) through a different input mode (e.g., speech input). In addition, by employing the assistance of a digital assistant to perform a secondary task (e.g., creating the drop target for the dragging operation) required for the completion of a primary task (e.g., the dragging operation) while the primary task is already underway, the user does not have to abandon the effort already devoted to the primary task in order to complete the secondary task first.

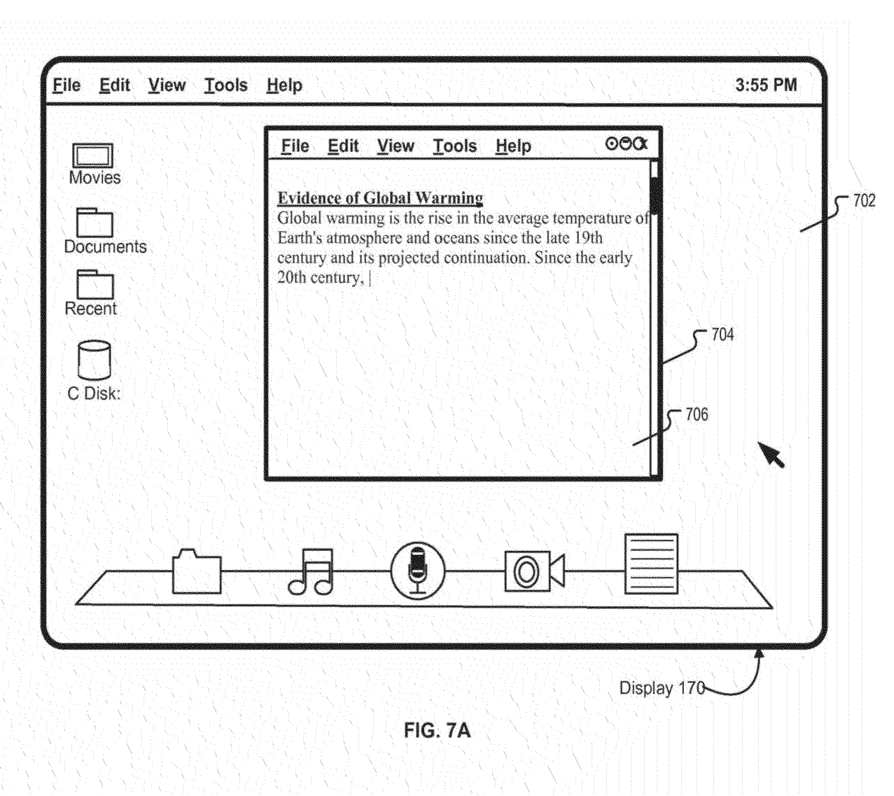

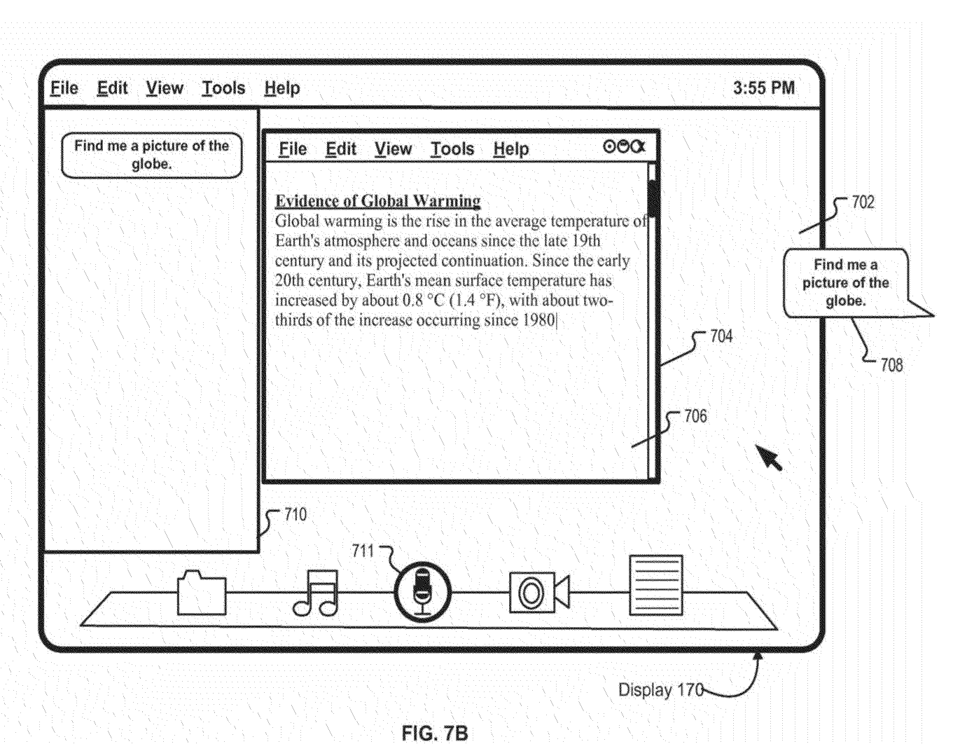

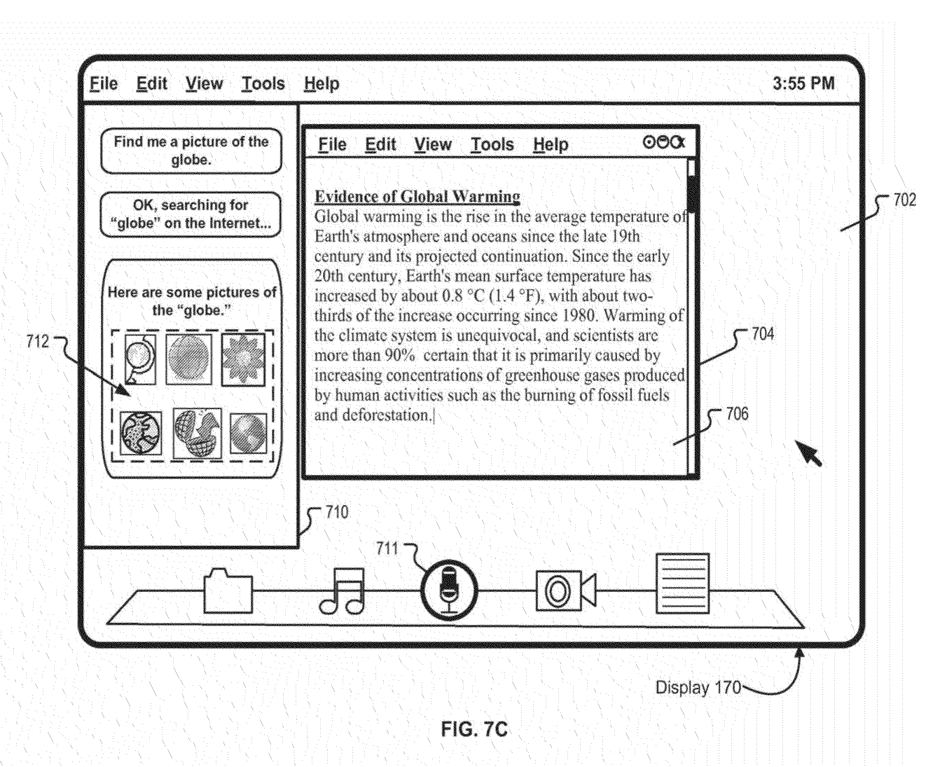

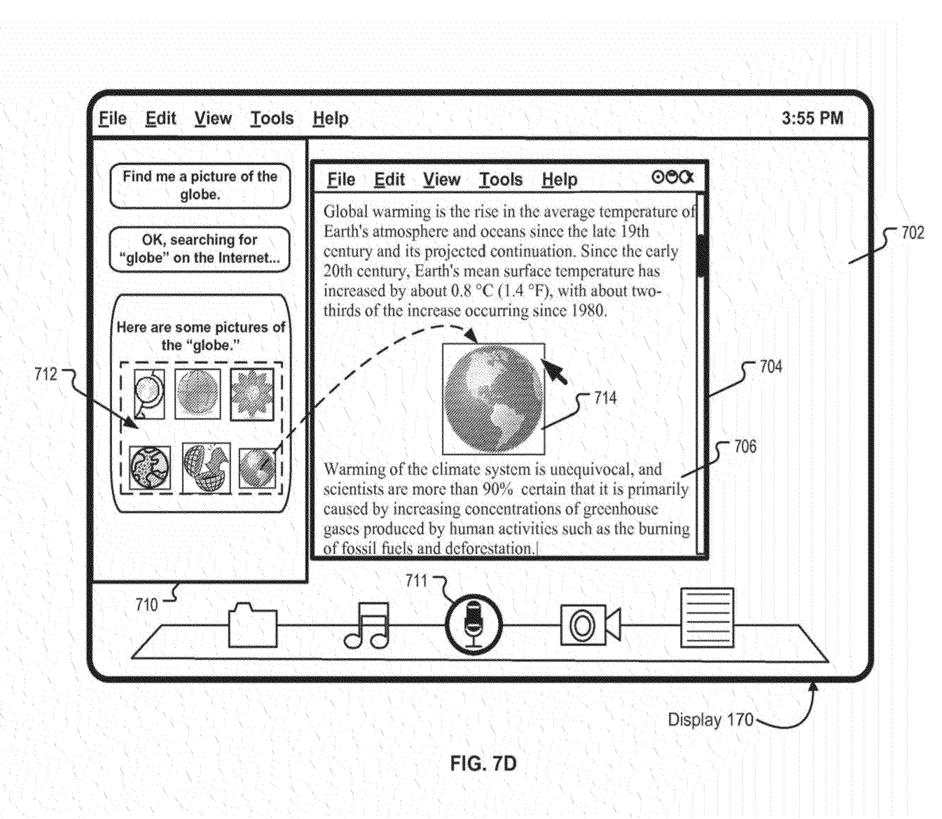

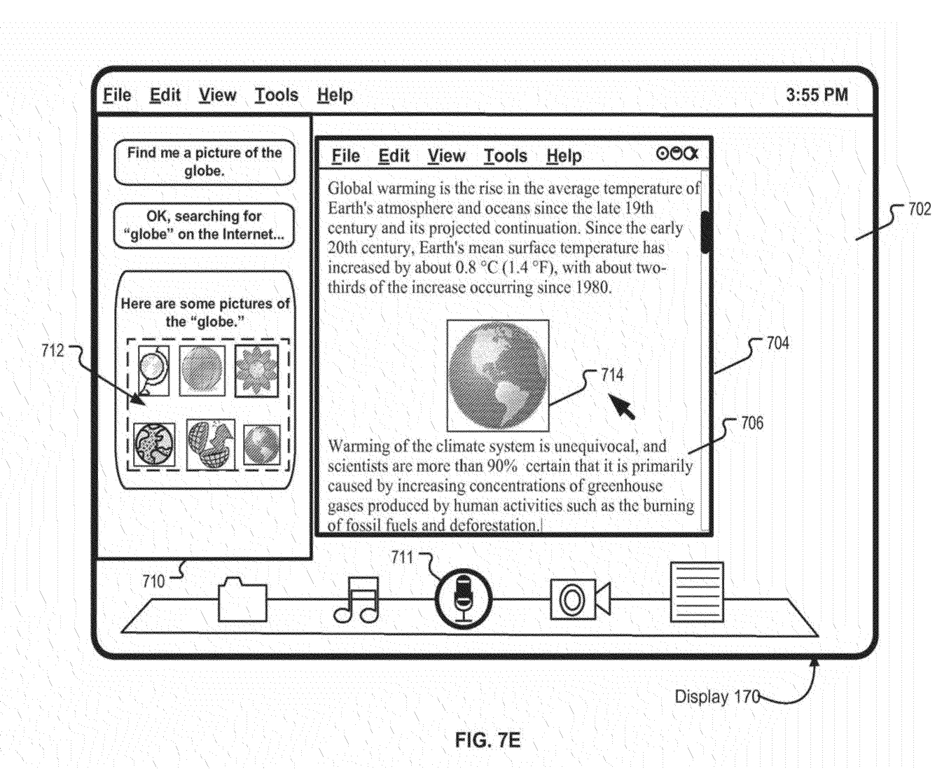

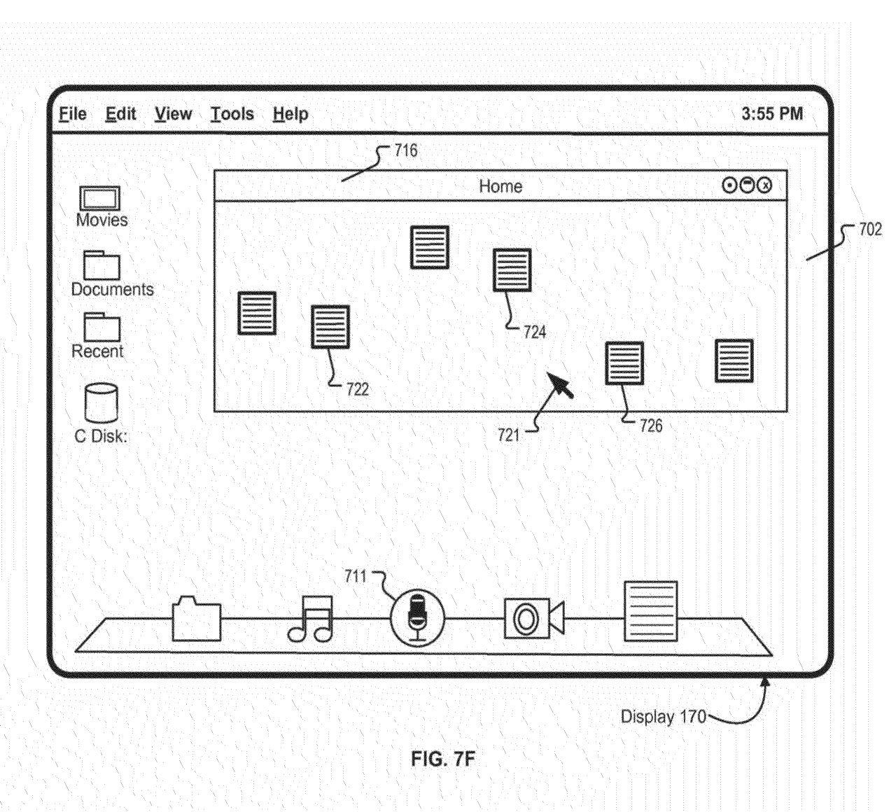

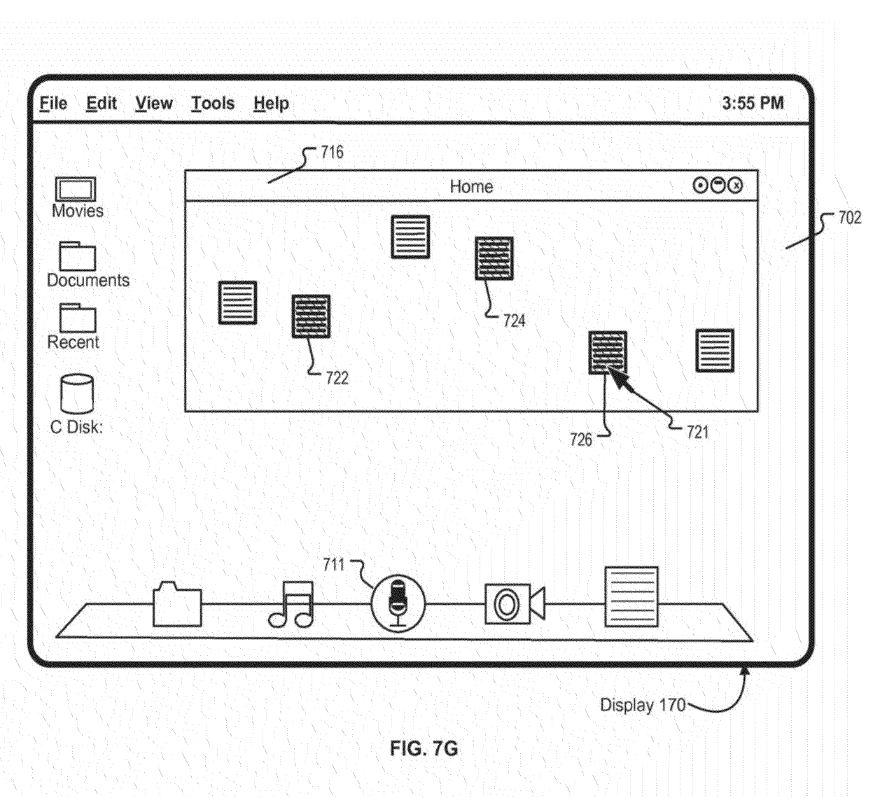

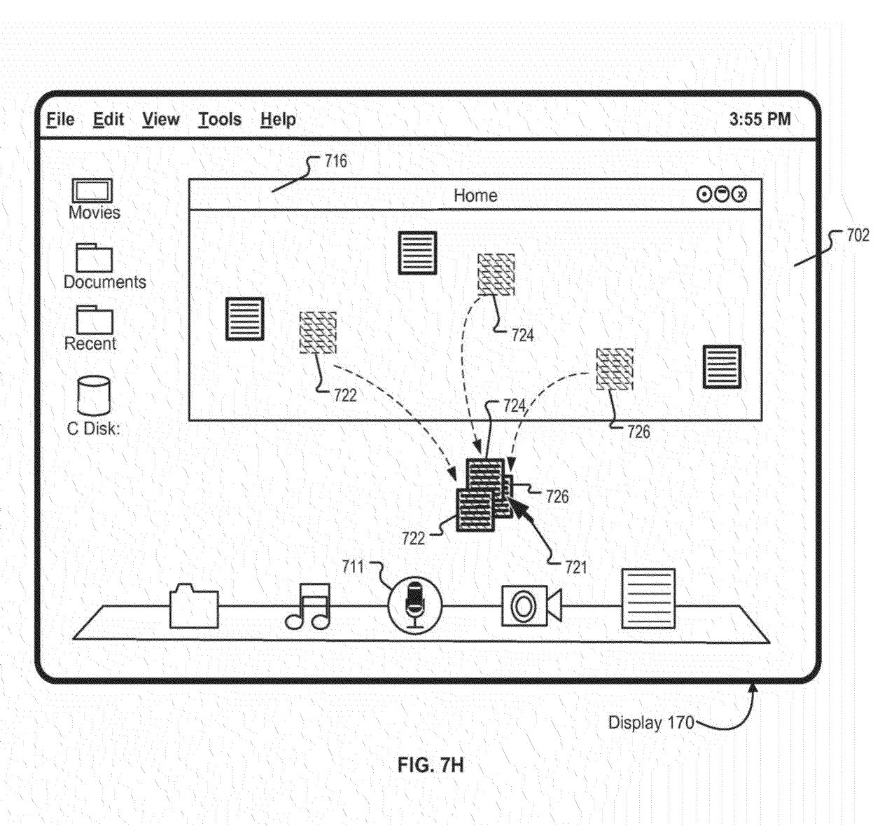

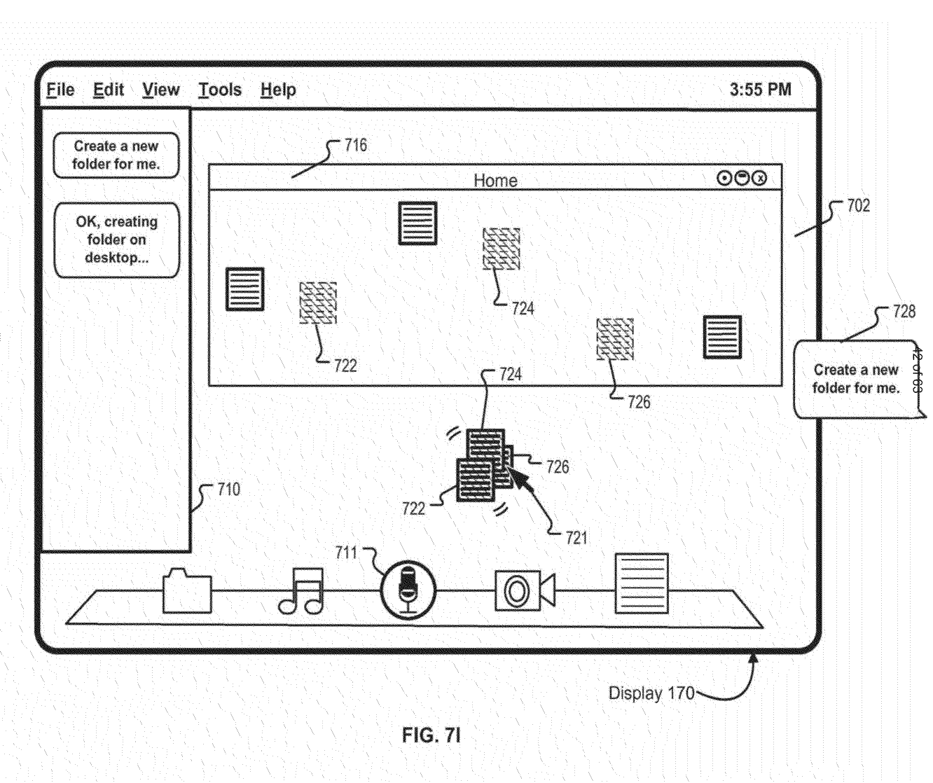

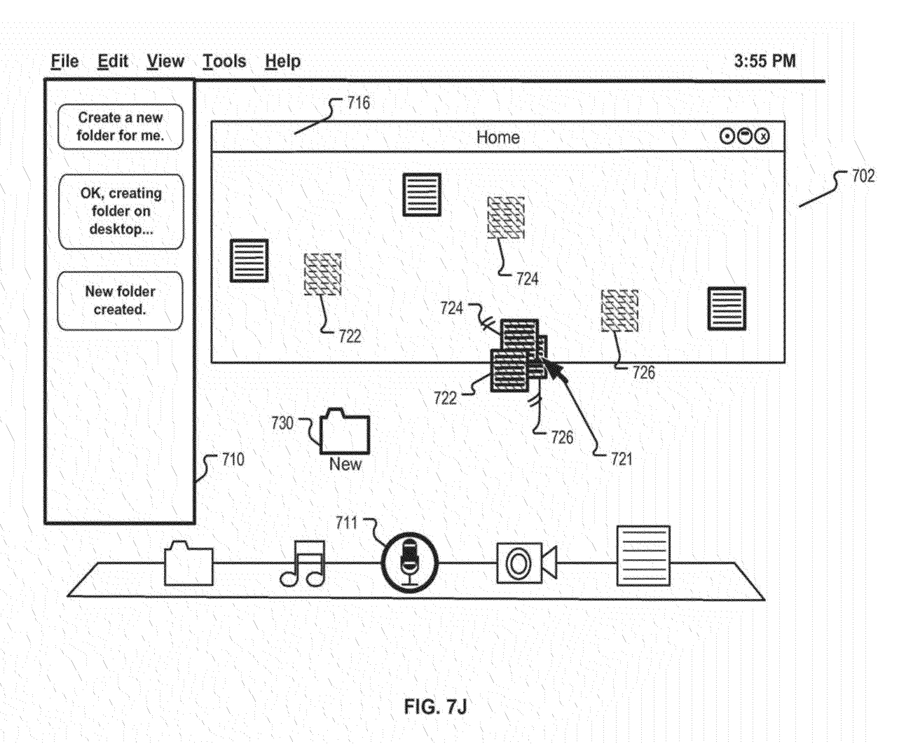

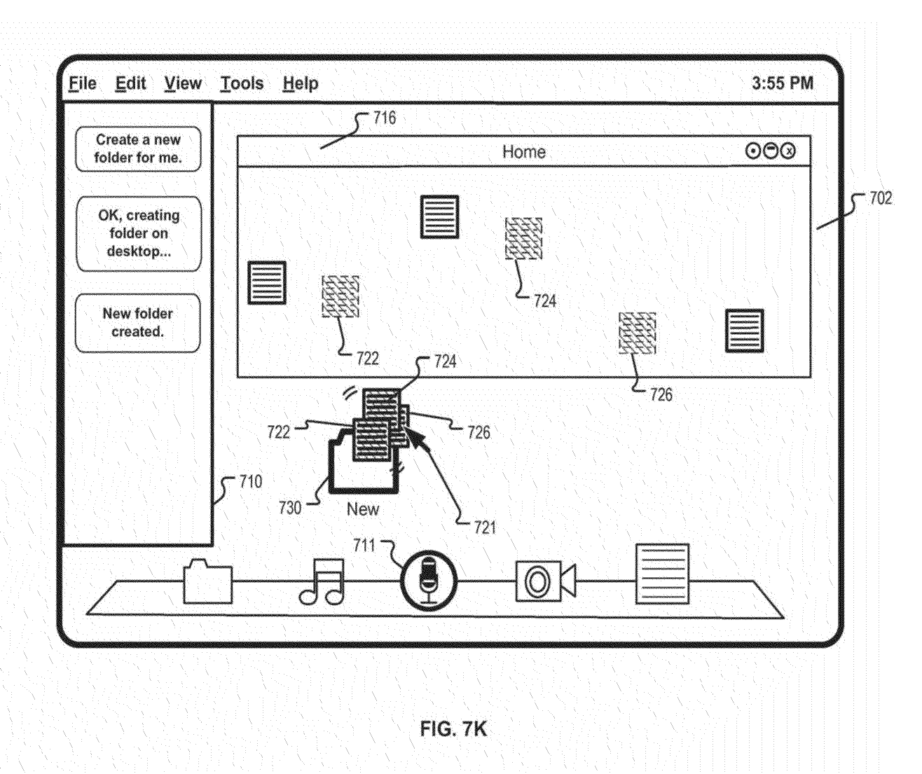

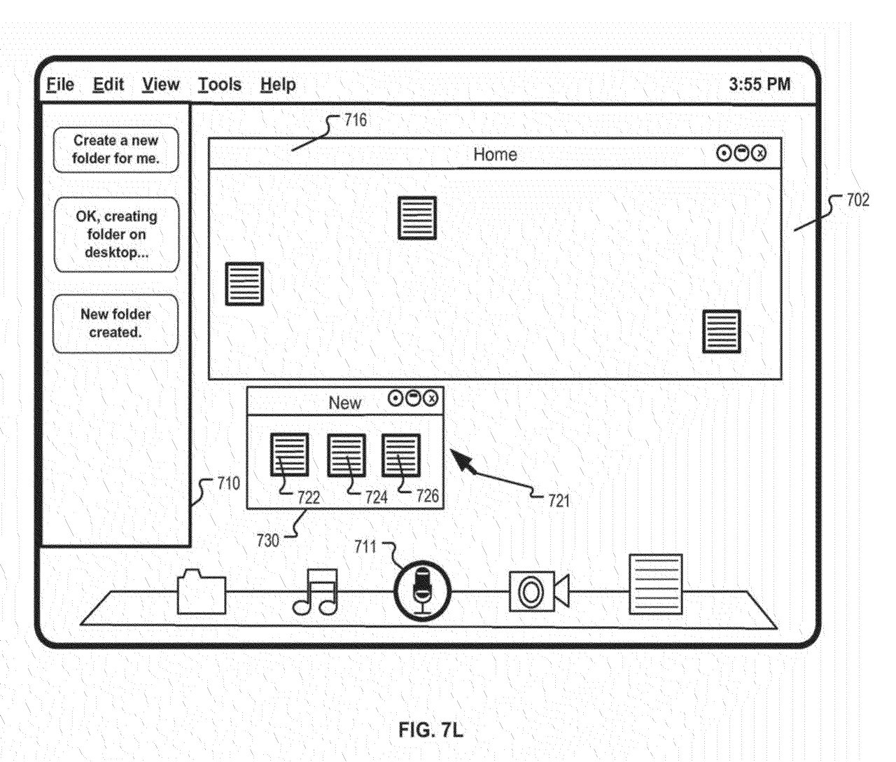

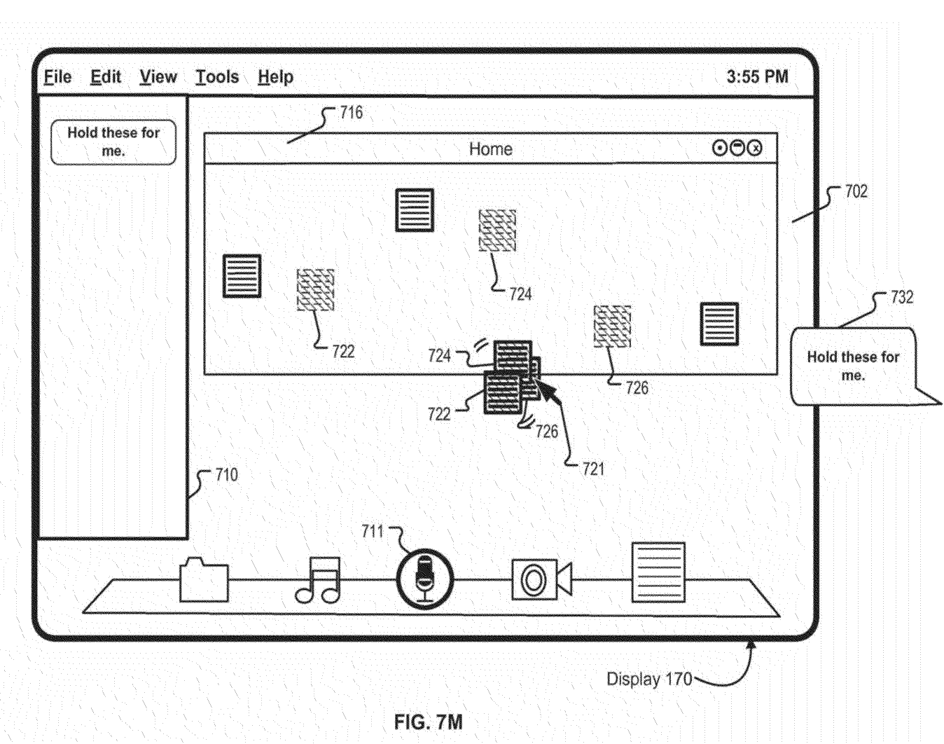

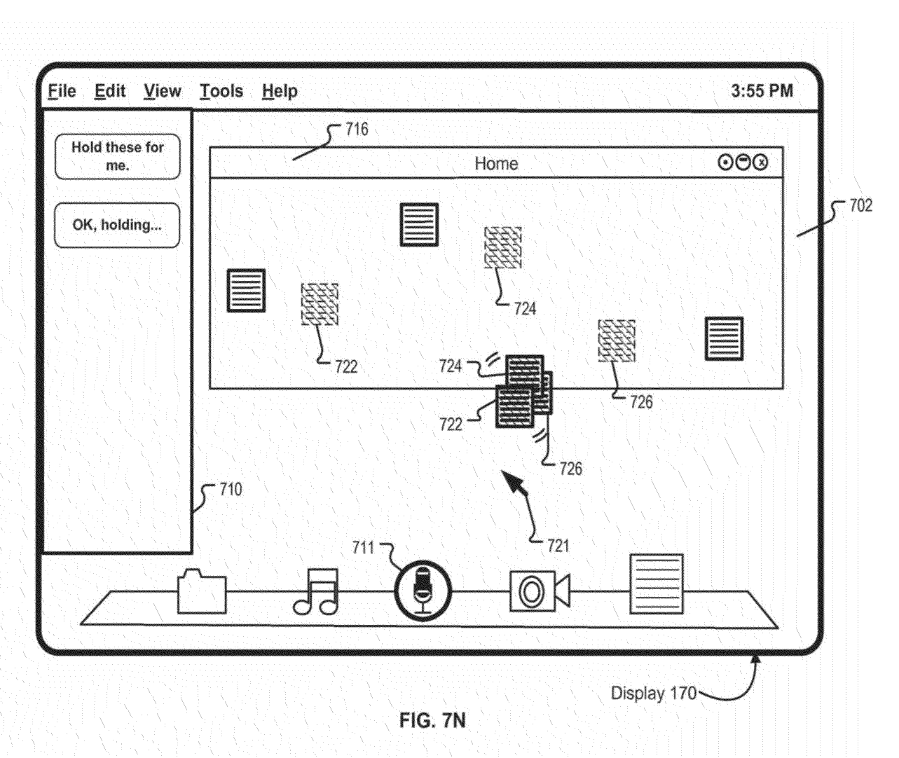

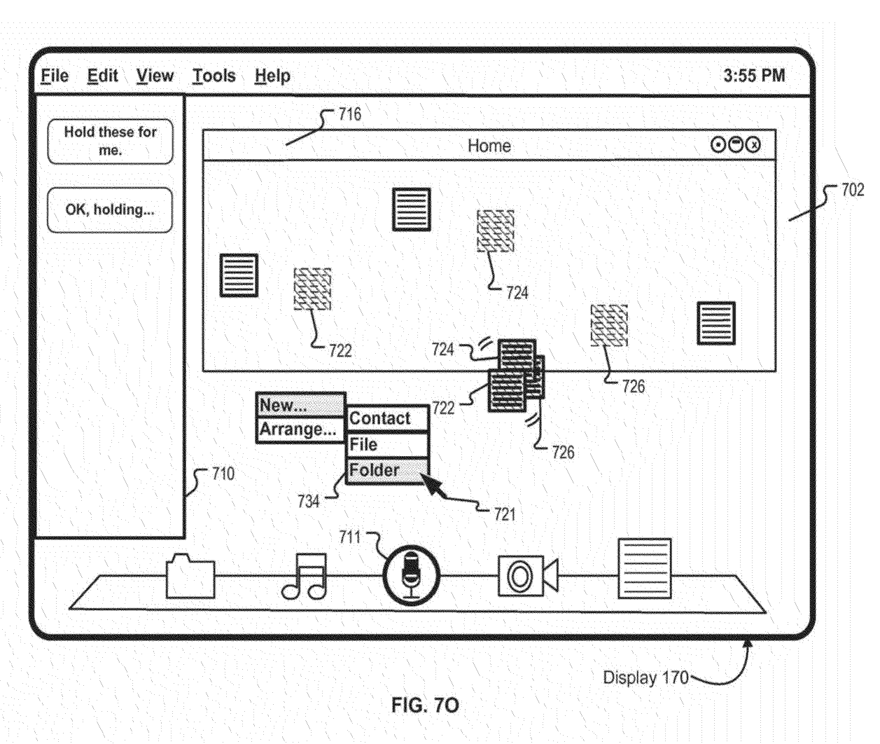

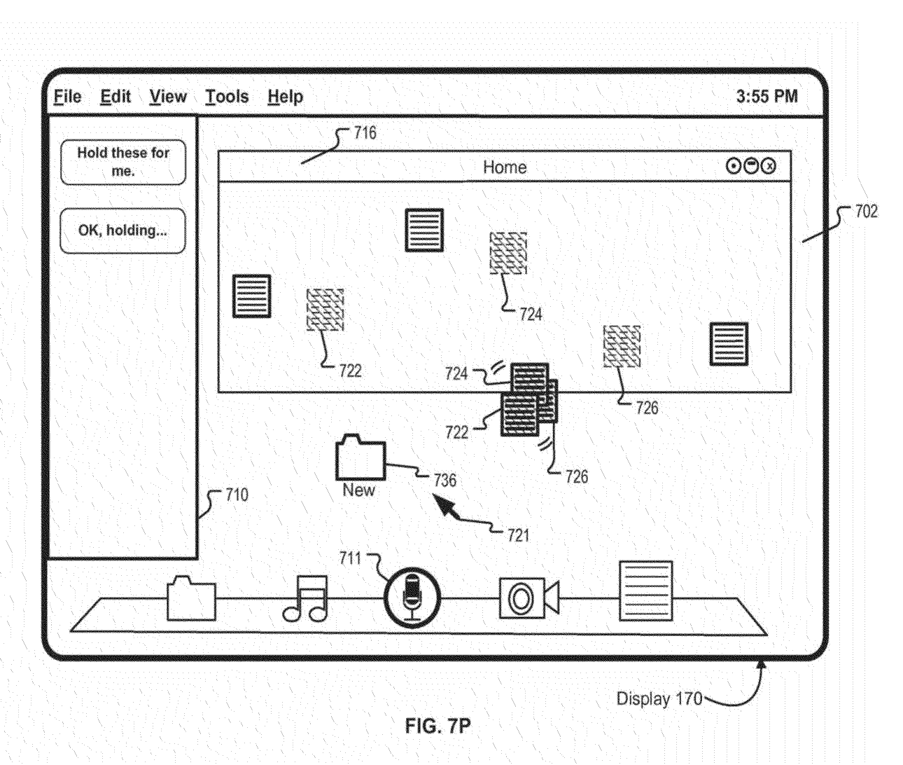

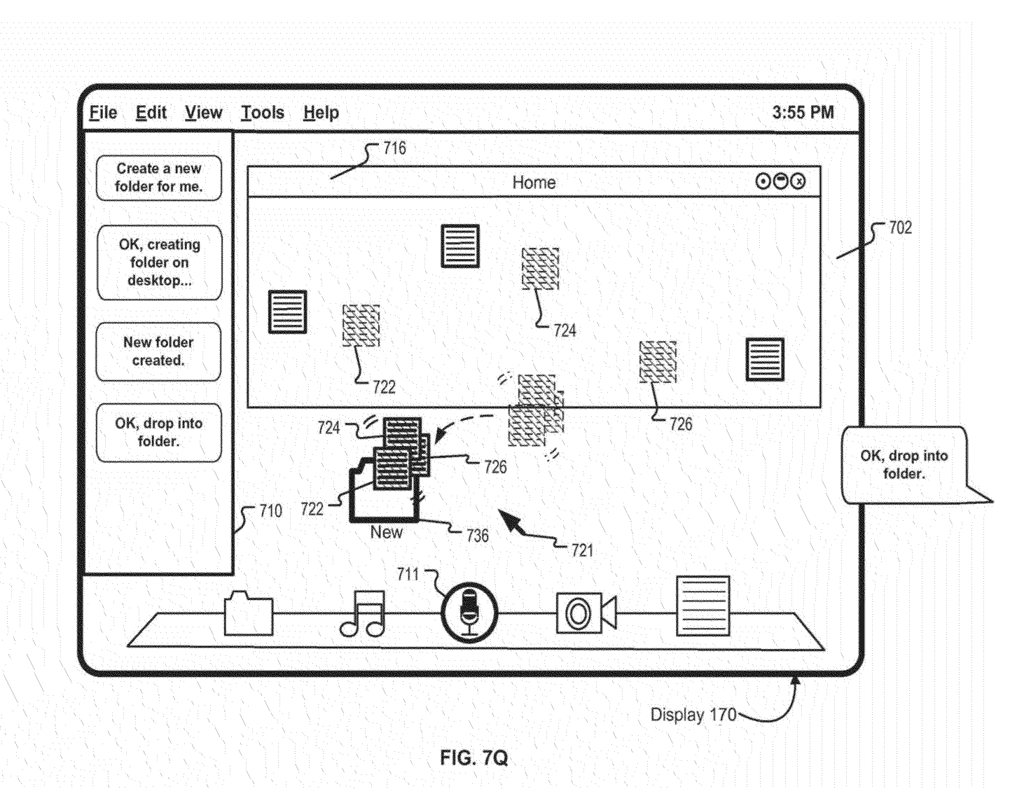

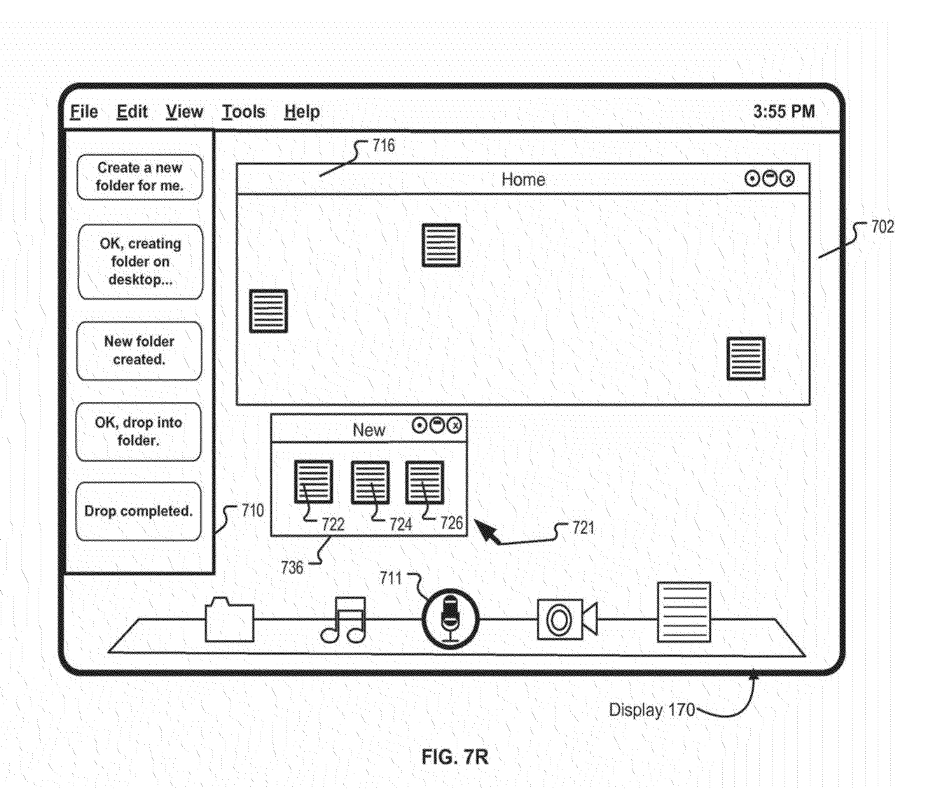

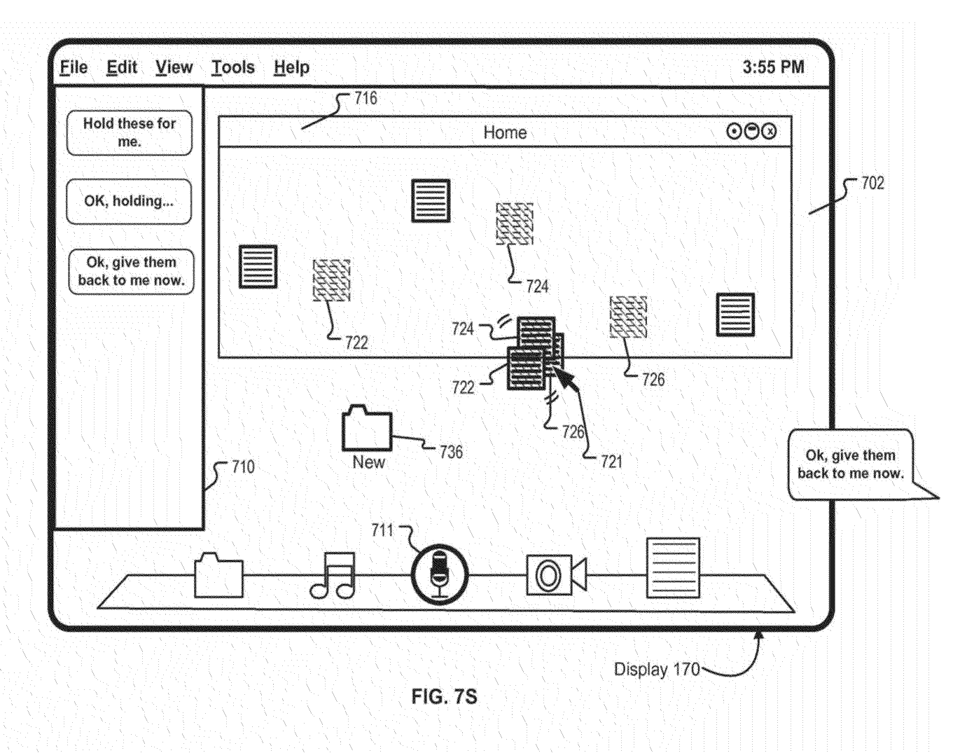

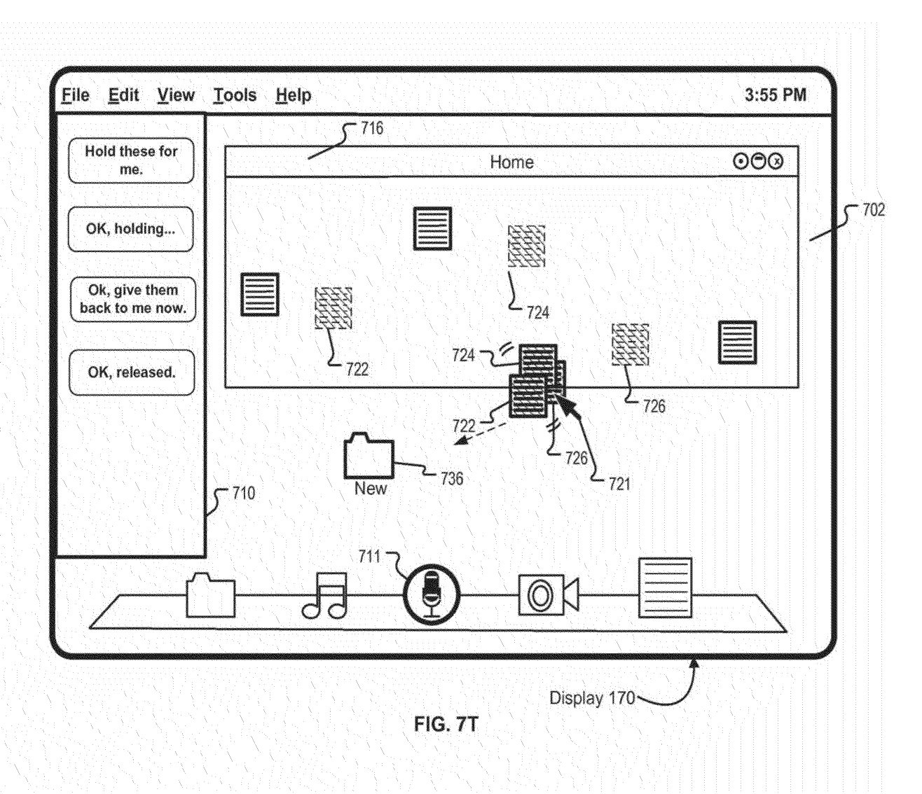

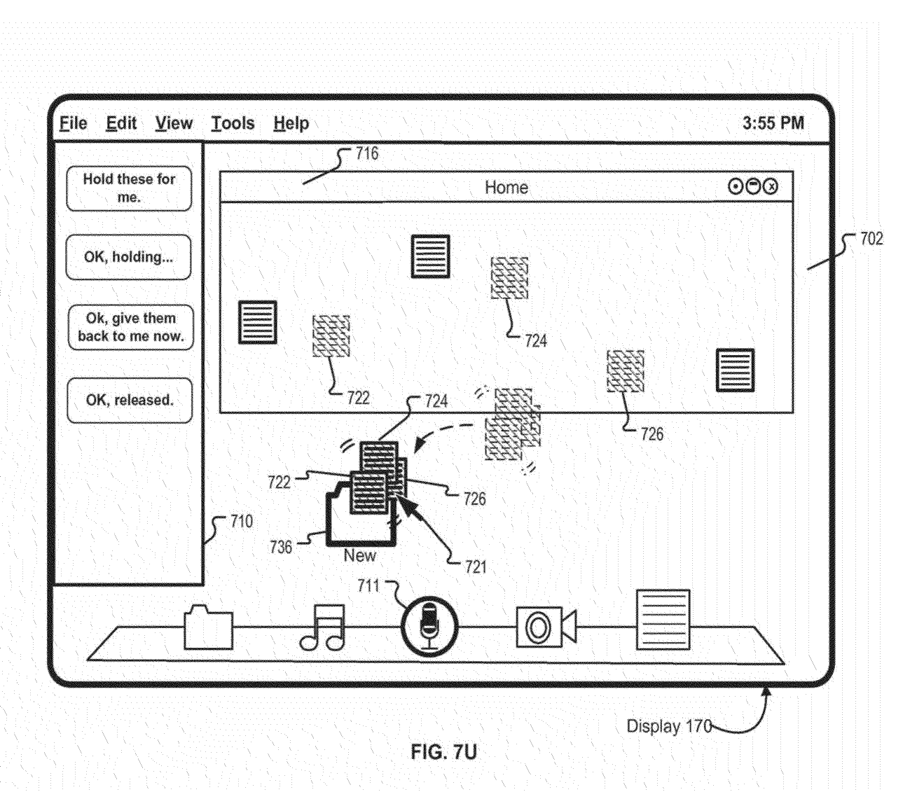

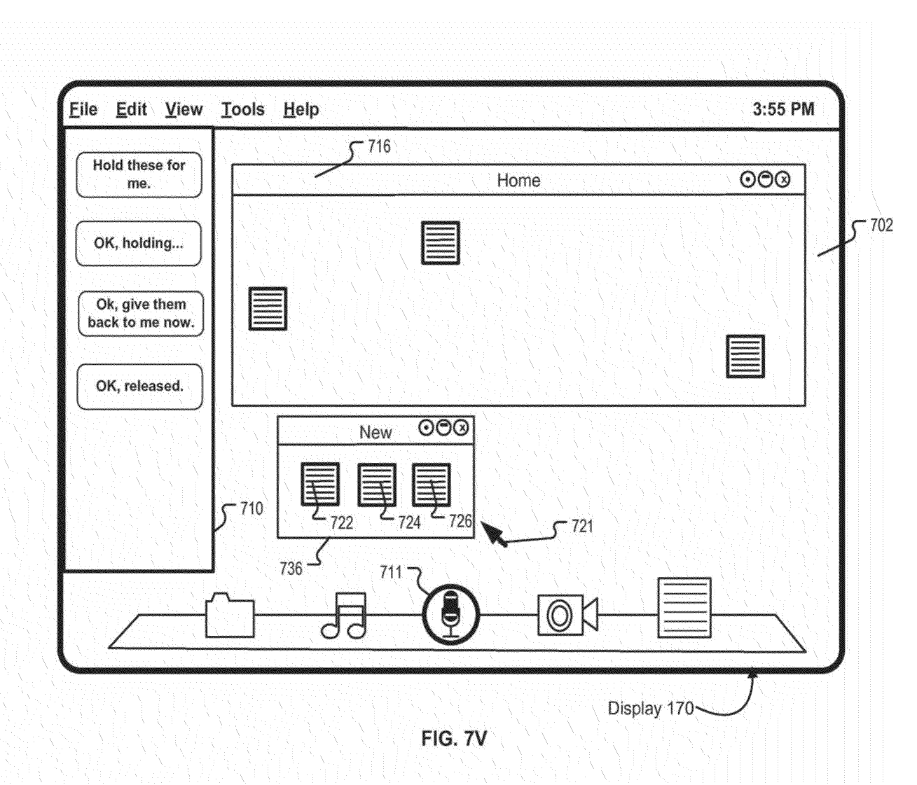

FIGS. 7A-7V illustrate some example user interfaces and interactions in which a digital assistant is employed to assist the user in performing a secondary task while the user is engaged in a primary task, and in which the outcome of the second task is later utilized in the completion of the primary task.

In FIGS. 7A-7E, the user utilizes the digital assist to perform a search for information on the Internet while the user is engaged in editing a document in a text editor application. The user later uses the results returned by the digital assistant in editing the document in the text editor.

As shown in FIG. 7A, a document editor window 704 has the current input focus of the user interface 702 (e.g., the desktop). The user is typing into a document 706 currently open in the document editor window 704 using a first input device (e.g., a hardware keyboard, or a virtual keyboard on a touch-sensitive display) coupled to the user device. While typing in the document 706, the user intermittently uses a pointing device (e.g., a mouse or a finger on a touch-sensitive surface of the device) to invoke various controls (e.g., buttons to control the font of the inputted text) displayed in the document editor window 704.

Suppose that while the user is editing the document 706 in the document editor window 704, the user wishes to access some information available outside of the document editor window 704. For example, the user may wish to search for a picture on the Internet to insert into the document 706. For another example, the user may wish to review certain emails to refresh his or her memory of particular information needed for the document 706. To obtain the needed information, the user, optionally, suspends his or her current editing task, and switches to a different task (e.g., Internet search, or email search) by changing the input focus to a different context (e.g., to a browser window, or email application window). However, this context switching is time consuming, and distracts the user's attention from the current editing task.

FIG. 7B illustrates that, instead of switching out of the current editing task, the user engages the aid of a digital assistant executing on the user device. In some embodiments, if the digital assistant is currently in a dormant state, the user optionally wakes the digital assistant by providing a predetermined keyboard input (e.g., by pressing on a dedicated hardware key to invoke the digital assistant). Since the input required to activate the digital assistant is simple, this does not significantly distract the user's attention from the current editing task. Also, the input required to activate the digital assistant does not remove the input focus from the document editing window 706. Once the digital assistant is activated, the digital assistant is operable to receive user requests through a speech input channel independent of the operation of the other input devices (e.g., the keyboard, mouse, touchpad, or touch screen, etc.) currently engaged in the editing task. In some embodiments, the iconic representation 711 of the digital assistant takes on a different appearance when the digital assistant is activated. In some embodiments, the digital assistant displays a dialogue panel 710 on the user interface 702 to show the interactions between the user and the digital assistant.

As shown in FIG. 7B, while the user continues with the editing of the document 706 in the document editor window 704, the user provides a speech input 712 (e.g., “Find me a picture of the globe on the Internet.”) to the digital assistant. In response to receiving the speech input 712, the digital assistant determines a requested task from the speech input 712. In some embodiments, the digital assistant optionally uses context information collected on the user device to disambiguate terms in the speech input 712. In some embodiments, the context information includes the location, type, content of the object that has the current input focus. In this example, the digital assistant optionally uses the title and or text of the document 706 to determine that the user is interested in finding a picture of a terrestrial globe, rather than a regular sphere or a celestial globe.

FIG. 7C illustrates that, while the user continues with the editing of the document 706 (e.g., using the keyboard, the mouse, the touchpad, and/or the touch-screen) coupled to the display of the user device, the digital assistant proceeds to carry out the requested task (e.g., performing a search on the Internet for a picture of a terrestrial globe). In some embodiments, the device displays a status update for the task execution in the dialogue panel 710. As shown in FIG. 7C, the digital assistant has located a number of search results from the Internet, and displayed thumbnails 712 of the search results in the dialogue panel 710. Each of the search results displayed in the dialogue panel 710 links a respective picture of a terrestrial globe retrieved from the Internet.

FIG. 7D illustrates that, the user drags and drops one of the pictures (e.g., image 714) displayed in the dialogue panel 610 into an appropriate insertion point into the document 706. In some embodiments, the device maintains the text input focus in the document 706, when the user performs the drag and drop operation using a touchpad or a mouse.

In some embodiments, the user optionally issues a second speech input to request more of the search results to be displayed in the dialogue panel 608. In some embodiments, the user optionally scrolls through the pictures displayed in the dialogue panel 710 before dragging and dropping a desired picture into the document 706. In some embodiments, the user optionally takes the input focus briefly away from the document editor window 604 to the dialogue panel 710, e.g., to scroll through the pictures, or to type in a refinement criteria for the search (e.g., “Only show black and white pictures”). However, such brief context switching is still less time consuming and places less cognitive burden on the user than performing the search on the Internet by himself/herself without utilizing the digital assistant.

In some embodiments, instead of scrolling using a pointing device, the user optionally causes the digital assistant to provide more images in the dialogue panel 610 by using a verbal request (e.g., “Show me more.”). In some embodiments, while the user drags the image 714 over an appropriate insertion point in the document 706, the user optionally asks the digital assistant to resize (e.g., enlarge or shrink) the image 714 by providing a speech input (e.g., “Make it larger.” or “Make is smaller.”). When the image 714 is resized to an appropriate size by the digital assistant while the user is holding the image 714, the user proceeds to drop it into the document 706 at the appropriate insertion point, as shown in FIG. 7D.

FIGS. 7F-7L and 7M-7V illustrate several other scenarios in which the user employs the aid of the digital assistance while performing a primary task. In these scenarios, a primary task is already underway in response to a user input provided through a respective input device (e.g., a mouse or touchpad, or a touch screen), and switching to a different context before the completion of the current task means that the user would have to lose at least some of the progress made earlier. The type of task that requires a continuous or sustained user input from start to completion is referred to as an “atomic” task. When an atomic task is already underway in response to a continuous user input provided through an input device, the user cannot use the same input device to initiate another operation or task without completely abandoning the task already underway or terminating the task in an undesirable state. Sometimes, completion of the current task is predicated on certain existing conditions. If these conditions are not satisfied before the user started the current task, the user may need to abandon the current task and take an action to satisfy these conditions first. FIGS. 7F-7L and 7M-7V illustrate how a digital assistant is used to establish these conditions after performance of the current task has already begun.

FIGS. 7F-7L illustrates that, instead of abandoning the primary task at hand or concluding it in an undesired state, the user optionally invokes the digital assistant using an input channel independent of the first input device, and requests the digital assistant to bring about the needed conditions on behalf of the user, while the user maintains the ongoing performance of the first task using the first input device.

As shown in FIG. 7F, a folder windows 716 is displayed on an example user interface (e.g., desktop 702). The folder window 716 contains a plurality of user interface objects (e.g., icons representing one or more files, images, shortcuts to applications, etc.). A pointer cursor 721 is also shown on the desktop 702. In some embodiments, when the user interface 702 is displayed on a touch screen, no pointer cursor is shown on the desktop 702, and selection and movement of user interface objects on the desktop 702 is accomplished through a contact between a finger or stylus and the surface of the touch screen.

As shown in FIG. 7G, the user has selected multiple user interface objects (e.g., icons 722, 724, and 726) from the folder window displayed on the desktop 702. For example, in some embodiments, to simultaneously select the multiple user interface objects, the user optionally clicks on each of the desired user interface objects one by one while hold down a “shift” key on a keyboard coupled to the user device. In some embodiments, when the user interface is displayed on a touch screen, the user optionally selects multiple using interface objects by making multiple simultaneous contacts over the desired objects on the touch screen. Other ways of simultaneously selecting multiple objects are possible.

When the multiple user interface objects are simultaneously selected, the multiple user interface objects respond to the same input directed to any one of the multiple user interface objects. For example, as shown in FIG. 7H, when the user has started a dragging operation on the selected icon 726, the icons 722 and 724 flies from their respective locations and forms a cluster around the icon 726. The cluster then moves around the user interface 702 with the movement of the pointer cursor 721. In some embodiments, no cluster is formed when the dragging is initiated, and the icons 722, 724, and 726 maintain their relative positions while being dragged as a group.

In some embodiments, a sustained input (e.g., an input provided by a user continuously holding down a mouse button or pressing on a touchpad with at least a threshold amount of pressure) is required to maintain the continued selection of the multiple interface objects during the dragging operation. In some embodiments, when the sustained input is terminated, the objects are dropped onto a target object (e.g., another folder) if such target object has been identified during the dragging operation. In some embodiments, if no target object has been identified when the sustained input is terminated, the selected objects would be dropped back to their original locations as if no dragging has ever occurred.

FIG. 7I illustrate that, after the user has initiated the dragging operation on the simultaneously selected icons 722, 724, and 726, the user realized that he or she has not created or otherwise made available a suitable drop target (e.g., a new folder or a particular existing folder) for the selected icons on the desktop 702.

Conventionally, the user would have to abandon the dragging operation, and release the selected objects back to their original locations or to the desktop, and then either create the desired drop target on the desktop or bring the desired drop target from another location onto the desktop 702. Then, once the desired drop target has been established on the desktop 702, the user would have to repeat the steps to select the multiple icons and drag the icons to the desired drop target. In some embodiments, the device maintains the concurrent selection of the multiple objects while the user creates the desired drop target, but the user would still need to restart the drag operation once the desired drop target has been made available.

As shown in FIG. 7I, however, instead of abandoning the previous effort to select and/or drag the multiple icons 722, 724, and 726, the user invokes the assistance of a digital assistant operating on the user device using a speech input 728 (e.g., “Create a new folder for me.”), while maintaining the simultaneous selection of the multiple objects 722, 724, and 726 during the dragging operation. In some embodiments, if the digital assistant is not yet active, the user optionally activates the digital assistant by pressing a dedicated hardware key on the device before providing the speech input 728.

FIG. 7I shows that, once the digital assistant is activated, a dialogue panel 710 is displayed on the desktop 702. The dialogue panel 720 displays the dialogue between the user and the digital assistant in the current interaction session. As shown in FIG. 7I, the user has provided a speech input 728 (e.g., “Create a new folder for me.”) to the digital assistant. The digital assistant captures the speech input 728 and displays text corresponding to the speech input in the dialogue panel 710. The digital assistant also interprets the speech input 728 and determines the task that the user has requested. In this example, the digital assistant determines that the user has requested that a new folder be created, and a default location of the new folder is on the desktop 702. The digital assistant proceeds to create the new folder on the desktop 702, while the user continues the input that maintains the continued selection of the multiple icons 722, 724, and 726 during a drag operation. In some embodiments, the user optionally drags the multiple icons around the desktop 702 or keeps them stationary on the desktop 702 while the new folder is being created.

FIG. 7J shows that the creation of a new folder 730 has been completed, and an icon of the new folder 730 is displayed on the desktop 702. In some embodiments, the device optionally displays a status update (e.g., “New folder created.”) in the dialogue panel 710 alerting the completion of the requested task.

As shown in FIG. 7K, after the new folder 730 has been created on the desktop 702 by the digital assistant, the user drags the multiple icons over the new folder 730. When there is sufficient overlap between the dragged icons and the new folder 730, the new folder 730 is highlighted, indicating that it is an eligible drop target for the multiple icons if the multiple icons are released at this time.

FIG. 7L shows that, the user has terminated the input that sustained the continued selection of the multiple icons 722, 724, and 726 during the dragging operation, and upon termination of the input, the multiple icons are dropped into the new folder 730, and become items within the new folder 730. The original folder 716 no longer contains the icons 722, 724, and 726.

FIGS. 7M-7U illustrates that, instead of abandoning an ongoing task at hand, the user optionally invokes the digital assistant using an input channel independent of the first input device, and requests the digital assistant to help maintain the ongoing performance of the first task, while the user uses the first input device to bring about the needed conditions for completing the ongoing task.

As shown in FIG. 7M, the user has selected multiple icons 722, 724, and 726 and is providing a continuous input to maintain the simultaneous selection of the multiple icons after initiating a dragging operation. This is the same scenario following the interactions shown in FIG. 7F-7H. Instead of asking the digital assistant to prepare the drop target while continuing the input to maintain the selection of the multiple icons 722, 724, and 726, the user asks the digital assistant to take over providing the input to maintain the continued selection of the multiple icons during the ongoing dragging operation, such that the user and associated user input device (e.g., the mouse or the touchpad or touch screen) are freed up to perform other actions (e.g., to create the desired drop target).

As shown in FIG. 7M, while maintaining the continued selection of the multiple objects, the user provides a speech input 732 (e.g., “Hold these for me.”) to the digital assistant. The digital assistant captures the speech input 732 and interprets the speech input to determine a task requested by the user. In this example, the digital assistant determines from the speech input 732 and associated context information (e.g., the current interaction between the user and the graphical user interface 702) that the user requests the digital assistant to hold the multiple icons 722, 724, and 726 in their current state (e.g., the concurrently selected state) for an ongoing dragging operation. In some embodiments, the digital assistant generates an emulated press-hold input (e.g., replicating the current press-hold input provided by the user). The digital assistant then uses the emulated input to continue the simultaneous selection of the multiple icons 722, 724, and 726 after the user has terminated his or her press-hold input on the user input device (e.g., releases the mouse button or lift-off the finger on the touch screen).

FIG. 7N illustrates that, after the digital assistant has acknowledged the user's request, the user terminates his or her own input on the user input device (e.g., releases the mouse button or lift-off the finger on the touch screen), and moves the pointer cursor 721 away from the selected icons 722, 724, and 726. When the pointer cursor 721 is moved away from the selected icons 722, 724, and 726, the icons remain selected in response to the emulated input provided by the digital assistant. The selected icons 722, 724, and 726 are neither returned to their original locations in the folder window 716 nor dropped onto the desktop 702, when the point cursor 721 is moved away from them.

FIG. 7O illustrates that, once the user and the pointing device are freed up by the digital assistant, the user proceeds to use the pointing device to create a new folder on the desktop 702. In some embodiments, the user invokes a context menu 734 on the desktop 702 using the pointing device, and selects the option for creating a new folder in the expanded context menu 734. In the meantime, the selected icons 722, 724, and 726 remain selected (e.g., shown in a suspended state over the desktop 702) in response to the emulated input provided by the digital assistant.

FIG. 7P shows that, a new folder 736 has been created in response to the selection of the “New folder” option in the context menu 734 by the pointer cursor 721, and the device displays an icon of the new folder 736 on the desktop. After the new folder 726 has been provided on the desktop, the user optionally provides a speech input 738 (e.g., “OK, drop them into the new folder.”) to the digital assistant, as shown in FIG. 7Q. The digital assistant captures the speech input 738, and determines that the user has requested the currently selected icons 722, 724, and 726 to be dropped into the newly created folder 736. Upon such a determination, the digital assistant proceeds to drag and drop the multiple selected icons 722, 724, and 726 into the newly created folder 736, as shown in FIG. 7Q.

As shown in FIG. 7R, the icons have been dropped into the new folder 736 in response to the action of the digital assistant. The drag and drop operation of the multiple icons 722, 724, and 726 is thus completed through the cooperation of the user and the digital assistant.

In some embodiments, instead of asking the digital assistant to carry out the drop operation in a verbal request, the user optionally grabs the multiple selected icons (e.g., using a click and hold input on the selected icons), and tears them away from their current locations. When the digital assistant detects that the user has resumed the press and hold input on the multiple icons 722, 724, and 726, the digital assistant ceases to provide the emulated input and returns control of the multiple icons to the user and the pointing device. In some embodiments, the user provides a verbal command (e.g., “OK, give them back to me now.”) to tell the digital assistant when to release the icons back to the user, as shown in FIG. 7S.

As shown in FIG. 7T, once the user has regained control of the multiple selected icons 722, 724, and 726 using the pointing device, the user proceeds to drag and drop the multiple icons into the newly created folder 736. FIG. 7U shows that the multiple icons have been dragged over the new folder 736 by the pointer cursor 721, and the new folder 736 becomes highlighted to indicate that it is an eligible drop target for the multiple icons. In FIG. 7V, the user has released (e.g., by releasing the mouse button, or by lifting off the finger on the touch screen) the multiple icons 722, 724, and 726 into the newly created folder 736. The drag and drop operation has thus been completed through the cooperation between the digital assistant and the user.

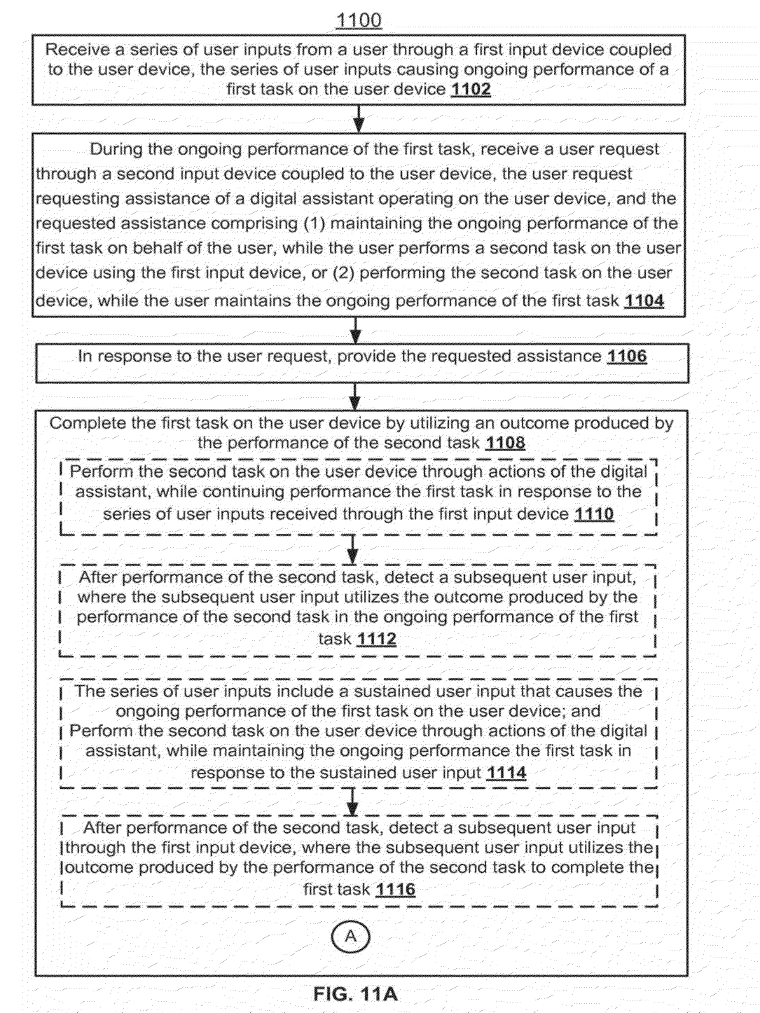

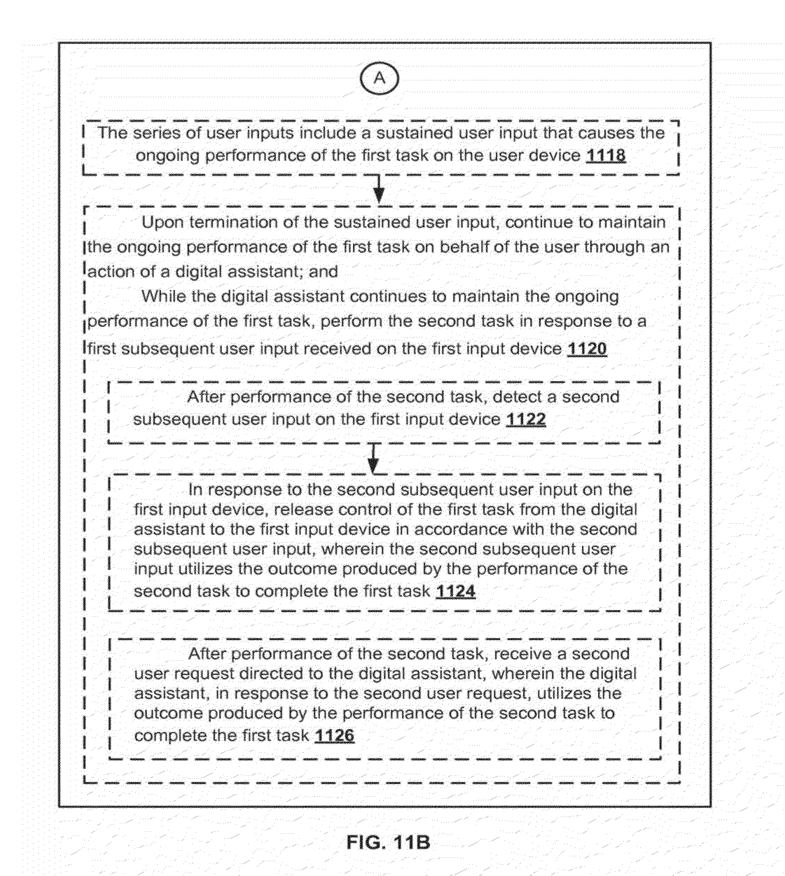

FIGS. 7A-7V are merely illustrative of the user interfaces and interactions for employing a digital assistant to assist with a secondary task while the user performs a primary and utilizing the outcome of the secondary task in the ongoing performance and/or completion of the primary task. More details regarding the process for employing a digital assistant to assist with a secondary task while the user performs a primary task are provided in FIGS. 11A-11B and accompanying descriptions.

FIG. 8 is a flow chart of an exemplary process 800 for invoking a digital assistant using a touch-based gesture input. Some features of the process 800 are illustrated in FIGS. 4A-4G and accompanying descriptions. In some embodiments, the process 800 is performed by a user device (e.g., user device 104 in FIG. 2A).

In the process 800, a device (e.g., device 104 shown in FIG. 2A) having one or more processors and memory detects (802) an input gesture from a user according to a predetermined motion pattern (e.g., a repeated circular motion shown in FIG. 4A or FIG. 4G) on a touch-sensitive surface (e.g., the touch screen 246 or the touchpad 268) of the device. In response to detecting the input gesture, the device activates (804) a digital assistant on the device. For example, the device optionally wakes the digital assistant from a dormant or suspended state or initializes the digital assistant from a terminated state.

In some embodiments, when activating the digital assistant on the device, the device presents (806) an iconic representation (e.g., iconic representation 416 in FIG. 4B) of the digital assistant on a display of the device. In some embodiments, when presenting the iconic representation of the digital assistant, the device presents (808) an animation showing a gradual formation of the iconic representation of the digital assistant on the display (e.g., as shown in FIG. 4B). In some embodiments, the animation shows a motion path of the input gesture gradually transforming into the iconic representation of the digital assistant. In some embodiments, the animation shows the gradual formation of the iconic representation being synchronized with the input gesture.

In some embodiments, when activating the digital assistant on the device, the device presents (810) the iconic representation of the digital assistant in proximity to a contact (e.g., contact 410 shown in FIG. 4A) of the input gesture on the touch-sensitive surface of the user device.

In some embodiments, the input gesture is detected (812) according to a circular movement of a contact on the touch-sensitive surface of the user device. In some embodiments, the input gesture is detected according to a repeated circular movement of the contact on the touch-sensitive surface of the device (e.g., as shown in FIGS. 4A-4C).

In some embodiments, the predetermined motion pattern is selected (814) based on a shape of an iconic representation of the digital assistant. In some embodiments, the iconic representation of the digital assistant is a circular icon, and the predetermined motion pattern is a repeated circular motion pattern (e.g., as shown in FIGS. 4A-4C). In some embodiments, the iconic representation of the digital assistant has a distinct visual feature (e.g., a star-shaped logo, or a smiley face) and the predetermined motion pattern is a motion path resembling the distinct visual feature or a simpler but recognizable version of the distinct visual feature.

In some embodiments, when activating the digital assistant on the user device, the device provides a user-observable signal (e.g., a tactile feedback on the touch-sensitive surface, an audible alert, or a brief pause in an animation currently presented) on the user device to indicate activation of the digital assistant.

In some embodiments, when activating the digital assistant on the user device, the device presents (816) a dialogue interface of the digital assistant on the user device. In some embodiments, the dialogue interface is configured to present one or more verbal exchanges between a user and the digital assistant in real-time. In some embodiments, the dialogue interface is a panel presenting the dialogue between the digital assistant and the user in one or more text boxes. In some embodiments, the dialogue interface is configured to accept direct text input from the user.

In some embodiments, in the process 800, in response to detecting the input gesture, the device identifies (818) a respective user interface object (e.g., the window 406 containing a draft email in FIG. 4A) presented on a display of the user device based on a correlation between a respective location of the input gesture on the touch-sensitive surface of the user device and a respective location of the user interface object on the display of the user device. The device further provides (820) information associated with the user interface object to the digital assistant as context information for a subsequent input (e.g., the speech input 420 “Make it urgent.”) received by the digital assistant.

In some embodiments, after the digital assistant has been activated, the device receives a speech input requesting performance of a task; and in response to the speech input, the device performs the task using at least some the information associated with the user interface object as a parameter of the task. For example, after the digital assistant has been activated by a required gesture near a particular word in a document, if the user says “Translate,” the digital assistant will translate that particular word for the user.

In some embodiments, the device utilizes additional information extracted from the touch-based gesture for invoking the digital assistant as additional parameters for a subsequent task requested of the digital assistant. For example, in some embodiments, the additional information includes not only the location(s) of the contact(s) in the gesture input, but also the speed, trajectory of movement, and/or duration of the contact(s) on the touch-sensitive surface. In some embodiments, animations are provided as visual feedback to the gesture input for invoking the digital assistant. The animations not only add visual interests to the user interface, in some embodiments, if the gesture input is terminated before the end of the animation, the activation of the digital assistant is aborted.

In some embodiments, the method for using a touch-based gesture to invoke the digital assistant is used in conjunction with other methods of invoking the digital assistant. In some embodiments, the method for using a touch-based gesture to invoke the digital assistant is used to provide a digital assistant for temporary use, while the other methods are used to provide the digital assistant for a prolonged or sustained use. For example, if the digital assistant has been activated using a gesture input, when the user says “go away” or tap on the iconic representation of the digital assistant, the digital assistant is suspended or deactivated (and removed from the user interface). In contrast, if the digital assistant has been activated using another method (e.g., a dedicated activation key on a keyboard or the user device), when the user says “go away” or tap on the iconic representation of the digital assistant, the digital assistant goes to a dock on the user interface, and continues to listen for additional speech input from the user. The gesture-based invocation method thus provides a convenient way invoking the digital assistant for a specific task at hand, without keeping it activated for a long time.

FIG. 8 is merely illustrative of a method for invoking a digital assistant using a touch-based gesture input. The illustrative discussions above are not intended to be exhaustive or to limit the invention to the precise forms disclosed. Many modifications and variations are possible in view of the above teachings.

FIGS. 9A-9B are flow charts illustrating a process 900 of how a device disambiguates whether a received speech input is intended for dictation or as a command for a digital assistant. Some features of the process 900 are illustrated in FIGS. 5A-5D and accompanying descriptions. In some embodiments, the process 900 is performed by a user device (e.g., user device 104 in FIG. 2A).

In the process 900, a device (e.g., user device 104 shown in FIG. 2A) having one or more processors and memory receives (902) a command (e.g., speech input or input invoking a designated virtual or hardware key) from a user. In response to receiving the command, the device takes (904) the following actions: the device determines (906) whether an input focus of the device is in a text input area shown on a display of the device; and (1) upon determining that the input focus of the device is in a text input area displayed on the device, the device invokes a dictation mode to convert the speech input to a text input for the text input area; and (2) upon determining that the current input focus of the device is not in any text input area displayed on the device, the device invokes a command mode to determine a user intent expressed in the speech input.

In some embodiments, receiving the command includes receiving the speech input from a user.

In some embodiments, the device determines whether the current input focus of the device is on a text input area displayed on the device in response to receiving a non-speech input for opening a speech input channel of the device.

In some embodiments, each time the device receives a speech input, the device determines whether the current input focus of the device is in a text input area displayed on the device, and selectively activates either the dictation mode or the command mode based on the determination.

In some embodiments, while the device is in the dictation mode, the device receives (908) a non-speech input requesting termination of the dictation mode. In response to the non-speech input, the device exits (910) the dictation mode and starts the command mode to capture a subsequent speech input from the user and process the subsequent speech input to determine a subsequent user intent. For example, in some embodiments, the non-speech input is an input moving the input focus of the graphical user interface from within a text input area to outside of any text input area. In some embodiments, the non-speech input is an input invoking a toggle switch (e.g., a dedicated button on a virtual or hardware keyboard). In some embodiments, after the device has entered the command mode and the non-speech input is terminated, the device remains in the command mode.

In some embodiments, while the device is in the dictation mode, the device receives (912) a non-speech input requesting suspension of the dictation mode. In response to the non-speech input, the device suspends (914) the dictation mode and starts a command mode to capture a subsequent speech input from the user and process the subsequent speech input to determine a subsequent user intent. In some embodiments, the device performs one or more actions based on the subsequent user intent, and returns to the dictation mode upon completion of the one or more actions. In some embodiments, the non-speech input is a sustained input to maintain the command mode, and upon termination of the non-speech input, the device exits the command mode and returns to the dictation mode. For example, in some embodiments, the non-speech input is an input pressing and holding an escape key while the device is in the dictation mode. While the escape key is pressed, the device remains in the command mode, and when the user releases the escape key, the device returns to the dictation mode.

In some embodiments, during the command mode, the device invokes an intent processing procedure to determine one or more user intents from the one or more speech input and performs (918) one or more actions based on the determined user intents.

In some embodiments, while the device is in the command mode, the device receives (920) a non-speech input requesting start of the dictation mode. In response to detecting the non-speech input, the device suspends (922) the command mode and starts the dictation mode to capture a subsequent speech input and convert the subsequent speech input into corresponding text input in a respective text input area displayed on the device. For example, if the user presses and holds the escape key while the device is in the command mode, the device suspends the command mode and enters into the dictation mode; and speech input received while in the dictation mode will be entered as text in a text input area in the user interface.

FIGS. 9A-9B are merely illustrative of a method for selectively invoking either a dictation mode or a command mode on the user device to process a received speech input. The illustrative discussions above are not intended to be exhaustive or to limit the invention to the precise forms disclosed. Many modifications and variations are possible in view of the above teachings.

FIGS. 10A-10C are flow charts of an exemplary process 1000 for specifying target objects of a user request by dragging and dropping objects onto an iconic representation of the digital assistant in a user interface. Some features of the process 1000 are illustrated in FIGS. 6A-6O and accompanying descriptions. In some embodiments, the process 1000 is performed by a user device (e.g., user device 104 in FIG. 2A).

In the example process 1000, the device presents (1002) an iconic representation of a digital assistant (e.g., iconic representation 606 in FIG. 6A) on a display (e.g., touch screen 246, or display 268) of the device. While the iconic representation of the digital assistant is displayed on the display, the device detects (1004) a user input dragging and dropping one or more objects (e.g., spreadsheet documents 614, 622, 626, 628, and documents 652 and 658 in FIGS. 6A-6O) onto the iconic representation of the digital assistant.

In some embodiments, the device detects the user dragging and dropping a single object onto the iconic representation of the digital assistant, and uses the single object as the target object for the requested task. In some embodiments, the dragging and dropping includes (1006) dragging and dropping two or more groups of objects onto the iconic representation at different times. When the objects are dropped in two or more groups, the device treats the two or more groups of objects as the target objects of the requested task. For example, as shown in FIGS. 6A-6J, the target objects of the requested tasks (e.g., sorting and merging) are dropped onto the iconic representation of the digital assistant in three different groups at different times, each group including one or more spreadsheet documents.

In some embodiments, the dragging and dropping of the one or more objects occurs (1008) prior to the receipt of the speech input. For example, in FIG. 6N, the two target objects of the speech input “Print 5 copies each” are dropped onto the iconic representation of the digital assistant before the receipt of the speech input.

In some embodiments, the dragging and dropping of the one or more objects occurs (1010) subsequent to the receipt of the speech input. For example, in FIGS. 6A-6G, the four target objects of the speech input “Sort these by date and merge into a new document” are dropped onto the iconic representation of the digital assistant after the receipt of the speech input.

The device receives (1012) a speech input requesting information or performance of a task (e.g., a speech input requesting sorting, printing, comparing, merging, searching, grouping, faxing, compressing, uncompressing, etc.).

In some embodiments, the speech input does not refer to (1014) the one or more objects by respective unique identifiers thereof. For example, in some embodiments, when the user provides the speech input specifying a requested, the user does not have to specify the filename for any or all of the target objects of the requested task. The digital assistant treats the objects dropped onto the iconic representation of the digital assistant as the target objects of the requested task, and obtains the identities of target objects through the user's drag and drop action.

In some embodiments, the speech input refers to the one or more objects by a proximal demonstrative (e.g., this, these, etc.). For example, in some embodiments, the digital assistant interprets the term “these” in a speech input (e.g., “Print these.”) to refer to the objects that have been or will be dropped onto the iconic representation around the time that the speech input is received.

In some embodiments, the speech input refers to the one or more objects by a distal demonstrative (e.g., that, those, etc.). For example, in some embodiments, the digital assistant interprets the term “those” in a speech input (e.g., “Sort those”) to refer to objects that have been or will be dropped onto the iconic representation around the time that the speech input is received.

In some embodiments, the speech input refers to the one or more objects by a pronoun (e.g., it, them, each, etc.). For example, in some embodiments, the digital assistant interprets the term “it” in a speech input (e.g., “Send it.”) to refer to an object that has been or will be dropped onto the iconic representation around the time that the speech input is received.

In some embodiments, the speech input specifies (1016) an action without specifying a corresponding subject for the action. For example, in some embodiments, the digital assistant assumes that the target object(s) of an action specified in a speech input (e.g., “print five copies,” “send,” “make urgent,” etc.) are the object that have been or will be dropped onto the iconic representation around the time that the speech input is received.

In some embodiments, prior to detecting the dragging and dropping of the first object of the one or more objects, the device maintains (1018) the digital assistant in a dormant state. For example, in some embodiments, the speech input channel of the digital assistant is closed in the dormant state. In some embodiments, upon detecting the dragging and dropping of the first object of the one or more objects, the device activates (1020) the digital assistant, where the digital assistant is configured to perform at least one of: capturing speech input provided by the user, determining user intent from the captured speech input, and providing responses to the user based on the user intent. Allowing the user to wake up the digital assistant by dropping an object onto the iconic representation of the digital assistant allows the user to start the input provision process for a task without having to press a virtual or hardware key to wake up the digital assistant first.

The device determines (1022) a user intent based on the speech input and context information associated with the one or more objects. In some embodiments, the context information includes identity, type, content, and permitted functions etc., associated with the objects.

In some embodiments, the context information associated with the one or more objects includes (1024) an order by which the one or more objects have been dropped onto the iconic representation. For example, in FIGS. 6A-6J, when sorting the items in the spreadsheet documents by date, the order by which the spreadsheet documents are dropped 614, 622, 626, and 628 are used to break the tie between two items having the same date.

In some embodiments, the context information associated with the one or more objects includes (1026) respective identities of the one or more objects. For example, the digital assistant uses the filenames of the objects dropped onto the iconic representation to retrieve the objects from the file system. For another example, in FIGS. 6A-6J, when sorting the items in the spreadsheet documents by date, the filenames of the spreadsheet documents 626 and 628 are used to break the tie between two items having the same date and were dropped onto the iconic representation of the digital assistant at the same time.

In some embodiments, the context information associated with the one or more objects includes (1028) respective sets of operations that are applicable to the one or more objects. For example, in FIGS. 6A-6J, several spreadsheet documents are dropped onto the iconic representation of the digital assistant, and “sorting by date” is one of the permitted operations for items within spreadsheet documents. Therefore, the digital assistant interprets the speech input “sort by date” as a request to sort items within the spreadsheet documents by date, as opposed to sorting the spreadsheet documents themselves by date.

In some embodiments, the device provides (1030) a response including at least providing the requested information or performance of the requested task in accordance with the determined user intent. Some example tasks (e.g., sorting, merging, comparing, printing, etc.) have been provided in FIGS. 6A-6O. In some embodiments, the user optionally requests the digital assistant to search for an older or newer version of a document by dragging the document onto the iconic representation of the digital assistant and providing a speech input “Find the oldest (or newest) version of this.” In response, the digital assistant performs the search on the user's device, and presents the search result (e.g., the oldest or the newest version) to the user. If no suitable search result is found, the digital assistant responds to the user reporting that no search result was found.

For another example, in some embodiments, the user optionally drags an email message to the iconic representation of the digital assistant and provides a speech input “Find messages related to this one.” In response, the digital assistant will search for the messages related to the dropped message by subject and present the search results to the user.

For another example, in some embodiments, the user optionally drops a contact card from a contact book to the iconic representation of the digital assistant and provides a speech input “Find pictures of this person.” In response, the digital assistant searches the user device, and/or other storage locations or the Internet for pictures of the person specified in the contact card.

In some embodiments, the requested task is (1032) a sorting task, the speech input specifies one or more sorting criteria (e.g., by date, by filename, by author, etc.), and the response includes presenting the one or more objects in an order according to the one or more sorting criteria. For example, as shown in FIG. 6J, the digital assistant presents the expense items from several spreadsheet documents in an order sorted by the dates associated with the expense items.

In some embodiments, the requested task is (1034) a merging task and providing the response includes generating an object that combines the one or more objects. For example, as shown in FIG. 6J, the digital assistant presents a document 646 that combines the items shown in several spreadsheet documents dropped onto the iconic representation of the digital assistant.

In some embodiments, the requested task is (1036) a printing task and providing the response includes generating one or more printing job requests for the one or more objects. As shown in FIG. 6H, two print jobs are generated for two objects dropped onto the iconic representation of the digital assistant.

In some embodiments, the requested task is (1038) a comparison task, and providing the response includes generating a comparison document illustrating at least one or more differences between the one or more objects. As shown in FIG. 6N, a comparison document 668 showing the difference between two documents dropped onto the iconic representation of the digital assistant is presented.

In some embodiments, the requested task is (1040) a search task, and providing the response includes providing one or more objects that are identical or similar to the one or more objects that have been dropped onto the iconic representation of the digital assistant. For example, in some embodiments, the user optionally drops a picture onto the iconic representation of the digital assistant, and the digital assistant searches and retrieves identical or similar images from the user device and/or other storage locations or the Internet and presents the retrieved images to the user.

In some embodiments, the requested task is a packaging task, and providing the response includes providing the one or more objects in a single package. For example, in some embodiments, the user optionally drops one or more objects (e.g., images, documents, files, etc.) onto the iconic representation of the digital assistant, and the digital assistant packages them into a single object (e.g., a single email with one or more attachments, a single compressed file containing one or more documents, a single new folder containing one or more files, a single portfolio document containing one or more sub-documents, etc.).

In some embodiments, in the process 1000, the device determines (1042) a minimum number of objects required for the performance of the requested task. For example, a speech input such as “Compare.” “Merge.” “Print these.” “Combine them.” implies that at least two target objects are required for the corresponding requested task. For another example, a speech input such as “Sort these five documents.” implies that the minimum number (and the total number) of objects required for the performance of the requested task is “five.”

In some embodiments, the device determines (1044) that less than the minimum number of objects have been dropped onto the iconic representation of the digital assistant, and in response, the device delays (1046) performance of the requested task until at least the minimum number of objects have been dropped onto the iconic representation of the digital assistant. For example, as shown in FIGS. 6A-6J, the digital assistant determines that the “sort” and “merge” tasks require at least two target objects to be specified, and when only one target object has been dropped onto the iconic representation of the digital assistant, the digital assistant waits for at least one other target object to be dropped onto the iconic representation of the digital assistant before proceeding with the sorting and merging tasks.

In some embodiments, after at least the minimum number of objects have been dropped onto the iconic representation, the device generates (1048) a prompt to the user after a predetermined period time has elapsed since the last object drop, where the prompt requests user confirmation regarding whether the user has completed specifying all objects for the requested task. Upon confirmation by the user, the digital assistant performs (1050) the requested task with respect to the objects that have been dropped onto the iconic representation.

FIGS. 10A-10C are merely illustrative of a method for specifying target objects of a user request by dragging and dropping objects onto an iconic representation of the digital assistant in a user interface. The illustrative discussions above are not intended to be exhaustive or to limit the invention to the precise forms disclosed. Many modifications and variations are possible in view of the above teachings.

FIGS. 11A-11B are flow charts of an exemplary process 1100 for employing a digital assistant to perform and complete a task that has been initiated by direct user input. Some features of the process 1100 are illustrated in FIGS. 7A-7V and accompanying descriptions. In some embodiments, the process 1100 is performed by a user device (e.g., user device 104 in FIG. 2A).

In the process 1100, a device having one or more processors and memory receives (1102) a series of user input from a user through a first input device (e.g., a mouse, a keyboard, a touchpad, or a touch screen) coupled to the user device, the series of user input causing ongoing performance of a first task on the user device. For example, the series of user input are direct input for editing a document in a document editing window, as shown in FIGS. 7A-7C. For another example, the series of user input includes a sustained input that causes ongoing selection of multiple objects during a dragging operation for a drag-and-drop task, as shown in FIGS. 7H-7K, and FIG. 7M.

In some embodiments, during the ongoing performance of the first task, the device receives (1104) a user request through a second input device (e.g., a voice input channel) coupled to the user device, the user request requesting assistance of a digital assistant operating on the user device, and the requested assistance including (1) maintaining the ongoing performance of the first task on behalf of the user, while the user performs a second task on the user device using the first input device, or (2) performing the second task on the user device, while the user maintains the ongoing performance of the first task. The different user requests are illustrated in the scenarios shown in FIGS. 7A-7E, 7F-7L, and 7M-7V. In FIGS. 7A-7E, the first task is the editing of the document 706, and the second task is the searching for the images of the terrestrial globe. In FIGS. 7F-7L and FIGS. 7M-&V, the first task is a selection and dragging operation that ends with a drop operation and the second task is the creation of a new folder for dropping the dragged objects.

In the process 1100, in response to the user request, the device provides (1106) the requested assistance (e.g., using a digital assistant operating on the device). In some embodiments, the device completes (1108) the first task on the user device by utilizing an outcome produced by the performance of the second task. In some embodiments, the device completes the first task in response to direct, physical input from the user (e.g., input provided by through the mouse, keyboard, touchpad, touch screen, etc.), while in some embodiments, the device completes the performance of the first task in response to actions of the digital assistant (e.g., the digital assistant takes action in response to natural language verbal instructions from the user).

In some embodiments, to provide the requested assistance, the device performs (1110) the second task through actions of the digital assistant, while continuing performance the first task in response to the series of user input received through the first input device (e.g., keyboard, mouse, touchpad, touch screen, etc.). This is illustrated in FIGS. 7A-7C and accompanying descriptions.

In some embodiments, after performance of the second task, the device detects (1112) a subsequent user input, and the subsequent user input utilizes the outcome produced by the performance of the second task in the ongoing performance of the first task. For example, as shown in FIG. 7D-7E, after the digital assistant has presented the results of the image search, the user continues with the editing of the document 706 by dragging and dropping one of the search results into the document 706.

In some embodiments, the series of user inputs include a sustained user input (e.g., a click and hold input on a mouse) that causes the ongoing performance of the first task on the user device (e.g., maintaining concurrent selection of the documents 722, 724, and 726 during a dragging operation). This is illustrated in FIGS. 7F-7I. In some embodiments, to provide the requested assistance, the device perform (1114) the second task on the user device through actions of the digital assistant, while maintaining the ongoing performance of the first task in response to the sustained user input. This is illustrated in FIGS. 7I-7J, where the digital assistant creates a new folder while the user provides the sustained input (e.g., click and hold input on a mouse) to maintain the continued selection of the multiple objects during an ongoing dragging operation. In some embodiments, after performance of the second task, the device detects (1116) a subsequent user input through the first input device, where the subsequent user input utilizes the outcome produced by the performance of the second task to complete the first task. This is illustrated in FIGS. 7J-7L, after the new folder has been created by the digital assistant, the user drags the objects to the folder and completes the drag and drop operation by releasing the objects into the new folder.

In some embodiments, the series of user inputs include (1118) a sustained user input (e.g., a click and hold input on a mouse) that causes the ongoing performance of the first task on the user device (e.g., maintaining concurrent selection of the documents 722, 724, and 726 during a dragging operation). This is illustrated in FIGS. 7F-7I. In some embodiments, to provide the requested assistance, the device (1) upon termination of the sustained user input, continues (1120) to maintain the ongoing performance of the first task on behalf of the user through an action of a digital assistant; and (2) while the digital assistant continues to maintain the ongoing performance of the first task, the device performs the second task in response to a first subsequent user input received on the first input device. This is illustrated in FIGS. 7M-7P, where when the user terminates the sustained input (e.g., a click and hold input on a mouse) for holding the multiple objects during a dragging operation, the digital assistant takes over and continues to hold the multiple objects on behalf of the user. In the meantime, while the digital assistant holds the multiple objects, the user and the first input device are freed to create a new folder on the desktop.

In some embodiments, after performance of the second task, the device detects (1122) a second subsequent user input on the first input device. In response to the second subsequent user input on the first input device, the device releases (1124) control of the first task from the digital assistant to the first input device in accordance with the second subsequent user input, where the second subsequent user input utilizes the outcome produced by the performance of the second task to complete the first task. This is illustrated in FIGS. 7S-7V, where after creating the new folder, the user drags the multiple objects away from the digital assistant, and drops the multiple objects into the newly created folder.

In some embodiments, after performance of the second task, the device receives (1126) a second user request directed to the digital assistant, where the digital assistant, in response to the second user request, utilizes the outcome produced by the performance of the second task to complete the first task. This is illustrated in FIGS. 7P-7R, where after the new folder has been created, the user provides a speech input asking the digital assistant to drop the objects into the new folder. In this example scenario, the user does not reclaim control of the objects from the digital assistant by dragging the objects away from the digital assistant.

FIGS. 11A-11B are merely illustrative of a method for employing a digital assistant to perform and complete a task that has been initiated by direct user input. The illustrative discussions above are not intended to be exhaustive or to limit the invention to the precise forms disclosed. Many modifications and variations are possible in view of the above teachings.

It should be understood that the particular order in which the operations have been described above is merely exemplary and is not intended to indicate that the described order is the only order in which the operations could be performed. One of ordinary skill in the art would recognize various ways to reorder the operations described herein. Additionally, it should be noted that the various processes separately described herein can be combined with each other in different arrangements. For brevity, all of the various possible combinations are not specifically enumerated here, but it should be understood that the claims described above may be combined in any way that is not precluded by mutually exclusive claim features.

The foregoing description, for purpose of explanation, has been described with reference to specific embodiments. However, the illustrative discussions above are not intended to be exhaustive or to limit the various described embodiments to the precise forms disclosed. Many modifications and variations are possible in view of the above teachings. The embodiments were chosen and described in order to best explain the principles of the various described embodiments and their practical applications, to thereby enable others skilled in the art to best utilize the various described embodiments with various modifications as are suited to the particular use contemplated.

What is claimed is:

1. A method for invoking a digital assistant service, comprising:
at a user device comprising one or more processors and memory:
detecting an input gesture from a user according to a predetermined motion pattern on a touch-sensitive surface of the user device; and
in response to detecting the input gesture, activating a digital assistant on the user device.

2. The method of claim 1, wherein the input gesture is detected according to a circular movement of a contact on the touch-sensitive surface of the user device.

3. The method of claim 1, wherein activating the digital assistant on the user device further comprises presenting an iconic representation of the digital assistant on a display of the user device.

4. The method of claim 3, wherein presenting the iconic representation of the digital assistant further comprises presenting an animation showing a gradual formation of the iconic representation of the digital assistant on the display.

5. The method of claim 3, wherein the iconic representation of the digital assistant is displayed in proximity to a contact of the input gesture on the touch-sensitive surface of the user device.

6. The method of claim 1, wherein the predetermined motion pattern is selected based on a shape of an iconic representation of the digital assistant on the user device.

7. The method of claim 1, wherein activating the digital assistant on the user device further comprises:
presenting a dialogue interface of the digital assistant on a display of the device, the dialogue interface configured to present one or more verbal exchanges between the user and the digital assistant.

8. The method of claim 1, further comprising:
in response to detecting the input gesture:
identifying a respective user interface object presented on a display of the user device based on a correlation between a respective location of the input gesture on the touch-sensitive surface of the device and a respective location of the user interface object on the display of the user device; and
providing information associated with the user interface object to the digital assistant as context information for a subsequent input received by the digital assistant.

9. A non-transitory computer readable medium having instructions stored thereon, the instructions, when executed by one or more processors of a user device, cause the processors to:
detect an input gesture from a user according to a predetermined motion pattern on a touch-sensitive surface of the user device; and
in response to detecting the input gesture, activate a digital assistant on the user device.

10. The non-transitory computer readable medium of claim 9, wherein the input gesture is detected according to a circular movement of a contact on the touch-sensitive surface of the user device.

11. The non-transitory computer readable medium of claim 9, wherein activating the digital assistant on the user device further comprises presenting an iconic representation of the digital assistant on a display of the user device.

12. The non-transitory computer readable medium of claim 11, wherein presenting the iconic representation of the digital assistant further comprises presenting an animation showing a gradual formation of the iconic representation of the digital assistant on the display.

13. The non-transitory computer readable medium of claim 11, wherein the iconic representation of the digital assistant is displayed in proximity to a contact of the input gesture on the touch-sensitive surface of the user device.

14. The non-transitory computer readable medium of claim 9, wherein the predetermined motion pattern is selected based on a shape of an iconic representation of the digital assistant on the user device.

15. The non-transitory computer readable medium of claim 9, wherein activating the digital assistant on the user device further comprises:
presenting a dialogue interface of the digital assistant on a display of the device, the dialogue interface configured to present one or more verbal exchanges between the user and the digital assistant.

16. The non-transitory computer readable medium of claim 9, further comprising instructions operable to cause the one or more processors to:
in response to detecting the input gesture:
identify a respective user interface object presented on a display of the user device based on a correlation between a respective location of the input gesture on the touch-sensitive surface of the device and a respective location of the user interface object on the display of the user device; and
provide information associated with the user interface object to the digital assistant as context information for a subsequent input received by the digital assistant.

17. A system, comprising:
one or more processors; and
memory having instructions stored thereon, the instructions, when executed by the one or more processors, cause the processors to
detect an input gesture from a user according to a predetermined motion pattern on a touch-sensitive surface of the user device; and
in response to detecting the input gesture, activate a digital assistant on the user device.

18. The system of claim 17, wherein the input gesture is detected according to a circular movement of a contact on the touch-sensitive surface of the user device.

19. The system of claim 17, wherein activating the digital assistant on the user device further comprises presenting an iconic representation of the digital assistant on a display of the user device.

20. The system of claim 19, wherein presenting the iconic representation of the digital assistant further comprises presenting an animation showing a gradual formation of the iconic representation of the digital assistant on the display.

21. The system of claim 19, wherein the iconic representation of the digital assistant is displayed in proximity to a contact of the input gesture on the touch-sensitive surface of the user device.

22. The system of claim 17, wherein the predetermined motion pattern is selected based on a shape of an iconic representation of the digital assistant on the user device.

23. The system of claim 17, wherein activating the digital assistant on the user device further comprises:
presenting a dialogue interface of the digital assistant on a display of the device, the dialogue interface configured to present one or more verbal exchanges between the user and the digital assistant.

24. The system of claim 17, further comprising instructions operable to cause the one or more processors to:
in response to detecting the input gesture:
identify a respective user interface object presented on a display of the user device based on a correlation between a respective location of the input gesture on the touch-sensitive surface of the device and a respective location of the user interface object on the display of the user device; and
provide information associated with the user interface object to the digital assistant as context information for a subsequent input received by the digital assistant.
